(19) United States
(12) Patent Application Publication
(10) Pub. No.: US 2025/0147318 A1
(43) Pub. Date: May 8, 2025

(54) METHOD AND SYSTEM FOR EYEPIECE WAVEGUIDE DISPLAYS UTILIZING MULTI-DIRECTIONAL LAUNCH ARCHITECTURES

(71) Applicant: Magic Leap, Inc., Plantation, FL (US)

(72) Inventors: Chinmay Khandekar, Sunnyvale, CA (US); Robert D. Tekolste, Fort Lauderdale, FL (US); Vikramjit Singh, Pflugerville, TX (US); Victor Kai Liu, Mountain View, CA (US); Ryan Ong, Austin, TX (US); Kristina Uhlendorf, Jena (DE)

(73) Assignee: Magic Leap, Inc., Plantation, FL (US)

(21) Appl. No.: 19/012,007

(22) Filed: Jan. 7, 2025

Related U.S. Application Data
(63) Continuation of application No. PCT/US2022/043721, filed on Sep. 15, 2022.
(60) Provisional application No. 63/359,561, filed on Jul. 8, 2022.

(51) Int. Cl. G02B 27/01; G02B 27/00; G02B 27/42

(52) U.S. Cl. CPC G02B 27/0172; G02B 27/0081; G02B 27/4272; G02B 2027/0125

(57) ABSTRACT

An eyepiece waveguide for augmented reality applications includes a substrate and a set of incoupling diffractive optical elements coupled to the substrate. A first subset of the set of incoupling diffractive optical elements is operable to diffract light into the substrate along a first range of propagation angles and a second subset of the set of incoupling diffractive optical elements is operable to diffract light into the substrate along a second range of propagation angles. The eyepiece waveguide also includes a combined pupil expander diffractive optical element coupled to the substrate.

### CROSS-REFERENCES TO RELATED APPLICATIONS

This application is a continuation of International Patent Application No. PCT/US2022/043721, filed Sep. 15, 2022, entitled “METHOD AND SYSTEM FOR EYEPIECE WAVEGUIDE DISPLAYS UTILIZING MULTI-DIRECTIONAL LAUNCH ARCHITECTURES,” which claims the benefit of and priority to U.S. Provisional Patent Application No. 63/359,561, filed on Jul. 8, 2022, entitled “MULTI-LAUNCH AND MULTI-COMBINER EP ARCHITECTURE,” the disclosures of which are hereby incorporated by reference in their entirety for all purposes.

### BACKGROUND OF THE INVENTION

Modern computing and display technologies have facilitated the development of systems for so called “virtual reality” (VR) or “augmented reality” (AR) experiences, wherein digitally reproduced images or portions thereof are presented to a viewer in a manner wherein they seem to be, or may be perceived as, real. A scenario typically involves presentation of digital or virtual image information without transparency to other actual real-world visual input; an AR scenario typically involves presentation of digital or virtual image information as an augmentation to visualization of the actual world around the viewer.

Despite the progress made in these display technologies, there is a need in the art for improved methods and systems related to augmented reality systems, particularly, display systems.

### SUMMARY OF THE INVENTION

Embodiments of the present invention are related generally to AR/MR products using single active layer diffractive waveguides. For example, some embodiments maximize the augmented reality display field of view in eyepieces based on a single-layer diffractive optical waveguide using multi-directional launch, spread, and outcoupling.

The field of view of the AR display using a diffractive optical waveguide is largely determined by the refractive index of the waveguide material and the underlying gratings architecture to incouple, spread, and outcouple the light. The embodiments described herein utilize unique architectures based on multi-directional launch of the light into the waveguide in which spreading and outcoupling diffractive element arrangements in tandem enable a larger field of view than is fundamentally possible with uni-directional incoupling and launch architectures.

According to an embodiment of the present invention, an AR headset is provided. The AR headset includes a projector and an eyepiece waveguide supporting multi-directional launch. The eyepiece waveguide has a world side and a user side and includes a first set of one or more incoupling diffractive optical elements coupled to the world side of the eyepiece waveguide. A first subset of the first set of one or more incoupling diffractive optical elements is operable to diffract first light into the eyepiece waveguide, wherein the diffracted first light is characterized by a first angular range. A second subset of the first set of one or more incoupling diffractive optical elements is operable to diffract second light into the eyepiece waveguide, wherein the diffracted second light is characterized by a second angular range different than the first angular range. The eyepiece waveguide also includes a second set of one or more incoupling diffractive optical elements coupled to the user side of the eyepiece waveguide. A third subset of the second set of one or more incoupling diffractive optical elements is operable to diffract light in the first angular range. The AR headset also includes a combined pupil expander.

A fourth subset of the second set of one or more incoupling diffractive optical elements can be operable to diffract light in the second angular range. The AR headset can utilize a single waveguide. The eyepiece waveguide can support propagation of multiple wavelengths of light. The combined pupil expander can be operable to spread light laterally in the eyepiece waveguide and outcouple light through the user side of the eyepiece waveguide. At least one of the first set of one or more incoupling diffractive optical elements or the second set of one or more incoupling diffractive optical elements can overlap.

According to another embodiment of the present invention, an eyepiece waveguide for augmented reality applications is provided. The eyepiece waveguide includes a substrate and a set of incoupling diffractive optical elements coupled to the substrate. A first subset of the set of incoupling diffractive optical elements is operable to diffract light into the substrate along a first range of propagation angles and a second subset of the set of incoupling diffractive optical elements is operable to diffract light into the substrate along a second range of propagation angles. The eyepiece waveguide also includes a combined pupil expander diffractive optical element coupled to the substrate.

The first subset of the set of incoupling diffractive optical elements can be characterized by a first grating periodicity and the second subset of the set of incoupling diffractive optical elements is characterized by a second grating periodicity greater than the first grating periodicity. The combined pupil expander diffractive optical element can include a first region characterized by a first grating orientation and a second region characterized by a second grating orientation different from the first grating orientation. The eyepiece waveguide can further include a second set of incoupling diffractive optical elements coupled to the substrate, wherein a first subset of the second set of incoupling diffractive optical elements is operable to diffract light into the substrate along the first range of propagation angles. The set of incoupling diffractive optical elements can be coupled to the substrate on a world side surface and the second set of incoupling diffractive optical elements can be coupled to the substrate on a user side surface opposing the world side surface. The eyepiece waveguide can further include a second combined pupil expander diffractive optical element coupled to the substrate. The combined pupil expander diffractive optical element is coupled to the substrate on a world side surface and the second combined pupil expander diffractive optical element is coupled to the substrate on a user side surface opposing the world side surface. The eyepiece waveguide is optically coupled to a projector operable to output red wavelengths, green wavelengths, and blue wavelengths, wherein the eyepiece waveguide is operable to support light propagation at the red wavelengths, the green wavelengths, and the blue wavelengths.

According to a specific embodiment of the present invention, an eyepiece waveguide for augmented reality applications is provided. The eyepiece waveguide includes a substrate and a set of incoupling diffractive optical elements coupled to the substrate. The set of incoupling diffractive optical elements includes a first incoupling diffractive optical element and a second incoupling diffractive optical element that can be operable to diffract light into the substrate along a first range of propagation angle and a third incoupling diffractive optical element that is operable to diffract light into the substrate along a second range of propagation angles. The eyepiece waveguide also includes a combined pupil expander diffractive optical element coupled to the substrate. The combined pupil expander includes a first portion facing a world side surface and including a first region characterized by a first grating vector and a second region characterized by a second grating vector and a second portion facing a user side surface and including a third region characterized by the first grating vector and a fourth region characterized by a third grating vector.

The first incoupling diffractive optical element and the second incoupling diffractive optical element are characterized by a first grating periodicity and the third incoupling diffractive optical element is characterized by a second grating periodicity smaller than the first grating periodicity. The first region is characterized by a first grating orientation and the second region is characterized by the first grating orientation. The third region is characterized by a first grating orientation and the second region is characterized by a second grating orientation different from the first grating orientation. The set of incoupling diffractive optical elements can further include a fourth incoupling diffractive optical element and a fifth incoupling diffractive optical element operable to diffract light into the substrate along the first range of propagation angles and a sixth incoupling diffractive optical element operable to diffract light into the substrate along the second range of propagation angles. The first incoupling diffractive optical element, the second incoupling diffractive optical element, and the third incoupling diffractive optical element can be coupled to the substrate on a world side surface and the fourth incoupling diffractive optical element, the fifth incoupling diffractive optical element, and the sixth incoupling diffractive optical element can be coupled to the substrate on the user-side surface opposing the world side surface. The fourth incoupling diffractive optical element and the fifth incoupling diffractive optical element can be characterized by a first grating periodicity and the sixth incoupling diffractive optical element can be characterized by a second grating periodicity smaller than the first grating periodicity. The eyepiece waveguide can be optically coupled to a projector operable to output red wavelengths, green wavelengths, and blue wavelengths, wherein the eyepiece waveguide can be operable to support light propagation at the red wavelengths, the green wavelengths, and the blue wavelengths. The first region can be positioned on the world side opposite the third region positioned on the user side. The second region can be positioned on the world side opposite the fourth region positioned on the user side. The first incoupling diffractive optical element and the second incoupling diffractive optical element can be characterized by a grating vector k_{L}, the third incoupling diffractive optical element can be characterized by a grating vector k_{H}, the first region and the third region can be characterized by a grating vector k₁, the second region can be characterized by a grating vector k₃, and the fourth region can be characterized by a grating vector k₂. A diffraction pathway for red wavelengths and green wavelengths can be k_{L}→k₂→k₃ and a diffraction pathway for blue wavelengths can be k_{H}→k₁→k₂.

These and other embodiments of the disclosure, along with many of its advantages and features, are described in more detail in conjunction with the text below and corresponding figures.

### BRIEF DESCRIPTION OF THE DRAWINGS

FIG. 1A is a simplified cross-sectional diagram illustrating elements of an eyepiece waveguide according to an embodiment of the present invention.

FIG. 1B is a simplified k-space diagram illustrating the field of view and grating vectors for an eyepiece waveguide according to an embodiment of the present invention.

FIG. 1C is a simplified plan view of the world side of a combined pupil expander (CPE) of an eyepiece waveguide according to an embodiment of the present invention.

FIG. 1D is a simplified plan view of the user side of the CPE shown in FIG. 1C.

FIG. 2A is a simplified k-space diagram illustrating the field of view and grating vectors for an eyepiece waveguide operated at multiple wavelengths according to an embodiment of the present invention.

FIG. 2B shows an enlarged portion of the k-space diagram illustrated in FIG. 2A.

FIG. 2C is a plot illustrating the number of bounces light experiences with 2 mm of propagation as a function of angle.

FIG. 3A is a simplified k-space diagram illustrating the field of view and ICG grating vectors for an eyepiece waveguide with multi-directional launch according to an embodiment of the present invention.

FIG. 3B is a simplified plan view of the world side of an eyepiece waveguide with multi-directional launch according to an embodiment of the present invention.

FIG. 3C is a simplified plan view of the user side of the eyepiece waveguide with multi-directional launch illustrated in FIG. 3B.

FIG. 3D is a simplified plan view of a single-sided eyepiece waveguide with multi-directional launch according to an embodiment of the present invention.

FIG. 4A is a simplified k-space diagram illustrating the field of view and CPE grating vectors for an eyepiece waveguide with multi-directional launch according to an embodiment of the present invention.

FIG. 4B is a simplified plan view of the world side of an eyepiece waveguide with multi-directional launch according to an embodiment of the present invention.

FIG. 4C is a simplified plan view of the user side of the eyepiece waveguide with multi-directional launch illustrated in FIG. 4B.

FIG. 4D is a simplified plan view of the world side of an eyepiece waveguide including a two dimensional grating with multi-directional launch according to an embodiment of the present invention.

FIG. 4E is a simplified plan view of the user side of the eyepiece waveguide including a two dimensional grating with multi-directional launch illustrated in FIG. 4D.

FIG. 4F is a simplified k-space diagram illustrating the field of view and CPE grating vectors for the eyepiece waveguide with multi-directional launch illustrated in FIGS. 4D and 4E according to an embodiment of the present invention.

FIG. 4G is a simplified k-space diagram illustrating the field of view and CPE grating vectors for the eyepiece waveguide with multi-directional launch illustrated in FIGS. 4D and 4E according to another embodiment of the present invention.

FIGS. 5A-5C illustrate normalized efficiency distributions for red, green, and blue wavelengths, respectively, for a uni-directional launch design according to embodiments of the present invention.

FIGS. 5D-5F illustrate normalized efficiency distributions for red, green, and blue wavelengths, respectively, for a multi-directional launch design according to embodiments of the present invention.

FIG. 6A is a simplified k-space diagram illustrating the field of view and ICG grating vectors for a first eyepiece waveguide with multi-directional launch according to an embodiment of the present invention.

FIG. 6B is a simplified k-space diagram illustrating the field of view and CPE grating vectors for the first eyepiece waveguide with multi-directional launch according to an embodiment of the present invention.

FIG. 6C is a simplified plan view of the world side of the first eyepiece waveguide with multi-directional launch according to an embodiment of the present invention.

FIG. 6D is a simplified plan view of the user side of the first eyepiece waveguide with multi-directional launch illustrated in FIG. 6C.

FIG. 7A is a simplified k-space diagram illustrating the field of view and ICG grating vectors for a second eyepiece waveguide with multi-directional launch according to an embodiment of the present invention.

FIG. 7B is a simplified k-space diagram illustrating the field of view and CPE grating vectors for the second eyepiece waveguide with multi-directional launch according to an embodiment of the present invention.

FIG. 7C is a simplified plan view of the world side of the second eyepiece waveguide with multi-directional launch according to an embodiment of the present invention.

FIG. 7D is a simplified plan view of the user side of the second eyepiece waveguide with multi-directional launch illustrated in FIG. 7C.

FIG. 8A is a simplified k-space diagram illustrating the field of view and ICG grating vectors for a third eyepiece waveguide with multi-directional launch according to an embodiment of the present invention.

FIG. 8B is a simplified k-space diagram illustrating the field of view and CPE grating vectors for the third eyepiece waveguide with multi-directional launch according to an embodiment of the present invention.

FIG. 8C is a simplified plan view of the world side of the third eyepiece waveguide with multi-directional launch according to an embodiment of the present invention.

FIG. 8D is a simplified plan view of the user side of the third eyepiece waveguide with multi-directional launch illustrated in FIG. 8C.

FIG. 9A is a simplified k-space diagram illustrating the field of view and ICG grating vectors for a fourth eyepiece waveguide with multi-directional launch according to an embodiment of the present invention.

FIG. 9B is a simplified k-space diagram illustrating the field of view and CPE grating vectors for the fourth eyepiece waveguide with multi-directional launch according to an embodiment of the present invention.

FIG. 9C is a simplified plan view of the world side of the fourth eyepiece waveguide with multi-directional launch according to an embodiment of the present invention.

FIG. 9D is a simplified plan view of the user side of the fourth eyepiece waveguide with multi-directional launch illustrated in FIG. 9C.

FIG. 10A is a simplified k-space diagram illustrating the field of view and ICG grating vectors for a fifth eyepiece waveguide with multi-directional launch according to an embodiment of the present invention.

FIG. 10B is a simplified k-space diagram illustrating the field of view and CPE grating vectors for the fifth eyepiece waveguide with multi-directional launch according to an embodiment of the present invention.

FIG. 10C is a simplified plan view of the world side of the fifth eyepiece waveguide with multi-directional launch according to an embodiment of the present invention.

FIG. 10D is a simplified plan view of the user side of the fifth eyepiece waveguide with multi-directional launch illustrated in FIG. 10C.

FIG. 11A is a simplified k-space diagram illustrating the field of view and ICG grating vectors for a sixth eyepiece waveguide with multi-directional launch according to an embodiment of the present invention.

FIG. 11B is a simplified k-space diagram illustrating the field of view and CPE grating vectors for the sixth eyepiece waveguide with multi-directional launch according to an embodiment of the present invention.

FIG. 11C is a simplified plan view of the world side of the sixth eyepiece waveguide with multi-directional launch according to an embodiment of the present invention.

FIG. 11D is a simplified plan view of the user side of the sixth eyepiece waveguide with multi-directional launch illustrated in FIG. 11C.

FIG. 12A is a simplified k-space diagram illustrating the field of view and ICG grating vectors for a seventh eyepiece waveguide with multi-directional launch according to an embodiment of the present invention.

FIG. 12B is a simplified k-space diagram illustrating the field of view and CPE grating vectors for the seventh eyepiece waveguide with multi-directional launch according to an embodiment of the present invention.

FIG. 12C is a simplified plan view of the world side of the seventh eyepiece waveguide with multi-directional launch according to an embodiment of the present invention.

FIG. 12D is a simplified plan view of the user side of the seventh eyepiece waveguide with multi-directional launch illustrated in FIG. 12C.

FIG. 13A is a simplified k-space diagram illustrating the field of view and ICG grating vectors for an eighth eyepiece waveguide with multi-directional launch according to an embodiment of the present invention.

FIG. 13B is a simplified k-space diagram illustrating the field of view and CPE grating vectors for the eighth eyepiece waveguide with multi-directional launch according to an embodiment of the present invention.

FIG. 13C is a simplified plan view of the world side of the eighth eyepiece waveguide with multi-directional launch according to an embodiment of the present invention.

FIG. 13D is a simplified plan view of the user side of the eighth eyepiece waveguide with multi-directional launch illustrated in FIG. 13C.

FIG. 14A is a simplified k-space diagram illustrating the field of view and ICG grating vectors for a first eyepiece waveguide including a two dimensional grating with multi-directional launch according to an embodiment of the present invention.

FIG. 14B is a simplified k-space diagram illustrating the field of view and CPE grating vectors for the first eyepiece waveguide including a two dimensional grating with multi-directional launch according to an embodiment of the present invention.

FIG. 14C is a simplified plan view of the world side of the first eyepiece waveguide including a two dimensional grating with multi-directional launch according to an embodiment of the present invention.

FIG. 14D is a simplified plan view of the user side of the first eyepiece waveguide including a two dimensional grating with multi-directional launch illustrated in FIG. 14C.

FIG. 15A is a simplified k-space diagram illustrating the field of view and ICG grating vectors for a second eyepiece waveguide including a two dimensional grating with multi-directional launch according to an embodiment of the present invention.

FIG. 15B is a simplified k-space diagram illustrating the field of view and CPE grating vectors for the second eyepiece waveguide including a two dimensional grating with multi-directional launch according to an embodiment of the present invention.

FIG. 15C is a simplified plan view of the world side of the second eyepiece waveguide including a two dimensional grating with multi-directional launch according to an embodiment of the present invention.

FIG. 15D is a simplified plan view of the user side of the second eyepiece waveguide including a two dimensional grating with multi-directional launch illustrated in FIG. 15C.

FIG. 16A is a simplified k-space diagram illustrating the field of view and ICG grating vectors for a wide field of view eyepiece waveguide with multi-directional launch according to an embodiment of the present invention.

FIG. 16B is a simplified k-space diagram illustrating the field of view and CPE grating vectors for the wide field of view eyepiece waveguide with multi-directional launch according to an embodiment of the present invention.

FIG. 16C is a simplified plan view of the world side of the wide field of view eyepiece waveguide with multi-directional launch according to an embodiment of the present invention.

FIG. 16D is a simplified plan view of the user side of the wide field of view eyepiece waveguide with multi-directional launch illustrated in FIG. 16C.

FIG. 17A is a simplified cross-sectional diagram illustrating an eyepiece waveguide with double-sided ICGs according to an embodiment of the present invention.

FIG. 17B is an exploded plan view diagram illustrating the double-sided ICGs shown in FIG. 14A.

FIG. 17C is a simplified cross-sectional diagram illustrating a metallized blazed grating according to an embodiment of the present invention.

FIG. 17D is a simplified cross-sectional diagram illustrating a coated blazed grating according to an embodiment of the present invention.

FIG. 17E is a simplified cross-sectional diagram illustrating a coated slanted grating according to an embodiment of the present invention.

FIG. 17F is a simplified cross-sectional diagram illustrating a coated blazed grating according to an embodiment of the present invention.

FIG. 18A is a perspective view of a two dimensional ICG according to an embodiment of the present invention.

FIG. 18B is a perspective view of a two dimensional ICG according to another embodiment of the present invention.

FIG. 18C is a perspective view of a two dimensional ICG according to a third embodiment of the present invention.

FIG. 18D is a perspective view of a two dimensional ICG according to a fourth embodiment of the present invention.

FIG. 19A is a simplified k-space diagram illustrating the field of view and ICG grating vectors for an eyepiece waveguide with multi-directional launch and two ICGs according to an embodiment of the present invention.

FIG. 19B is a simplified plan view of the world side of the eyepiece waveguide with multi-directional launch and two ICGs according to an embodiment of the present invention.

FIG. 19C is a simplified plan view of the user side of the eyepiece waveguide with multi-directional launch and two ICGs illustrated in FIG. 19B.

FIG. 20A is a simplified k-space diagram illustrating the field of view and an ICG grating vector for an eyepiece waveguide according to an embodiment of the present invention.

FIG. 20B is a simplified k-space diagram illustrating the field of view and an ICG grating vector for another eyepiece waveguide according to an embodiment of the present invention.

FIG. 20C is a simplified k-space diagram illustrating the field of view and ICG grating vectors for an eyepiece waveguide with multi-directional launch according to an embodiment of the present invention.

FIG. 21A is a simplified plan view of the world side of an eyepiece waveguide with multi-directional launch with blue light launched in a first direction according to an embodiment of the present invention.

FIG. 21B is a simplified plan view of the user side of the eyepiece waveguide with multi-directional launch with blue light launched in the first direction illustrated in FIG. 21A.

FIG. 21C is a simplified plan view of the world side of an eyepiece waveguide with multi-directional launch with blue light launched in a second direction according to an embodiment of the present invention.

FIG. 21D is a simplified plan view of the user side of the eyepiece waveguide with multi-directional launch with blue light launched in the second direction illustrated in FIG. 21C.

FIG. 22A is a simplified k-space diagram illustrating the field of view, ICG grating vectors, an OPE grating vector, and CPE grating vectors for an eyepiece waveguide with multi-directional launch according to another embodiment of the present invention.

FIG. 22B is a simplified plan view of the world side of the eyepiece waveguide with multi-directional launch according to another embodiment of the present invention.

FIG. 23 illustrates overlap of images in k-space and corresponding eyepiece designs according to various embodiments of the present invention.

FIG. 24 shows a perspective view of a wearable device according to an embodiment of the present invention.

### DETAILED DESCRIPTION OF THE INVENTION

Multi-directional launch in the context of diffractive waveguide combiners has been relatively little explored, primarily focusing on architectures where the light is launched from the projector along two opposite and parallel directions. Most of the optical waveguides available in the market usually rely on uni-directional launch of light because of its simplicity and waveguide efficiency. In contrast to such prior art, the architectures described herein (with many illustrated examples below) launch light from the projector into distinct non-parallel directions. The embodiments described herein are useful in the context of augmented reality (AR) systems, including AR headsets. Additional description related to AR headsets is provided in U.S. Patent Application Publication No. 2019/0179149, the disclosure of which is hereby incorporated by reference in its entirety for all purposes.

In the embodiments described herein, the proposed multi-directional launch waveguide designs uniquely address some of the fundamental constraints on diffractive optics AR displays. For example, the field of view that can be achieved using a single waveguide layer for red, green, blue wavelengths is limited and determined, in part, by the refractive index of the material. Moreover, the uniformity of the display suffers significantly because of the frequency/wavelength dependence of light propagation inside the waveguide. The multi-directional launch and multi-combiner designs discussed herein enable a field of view larger than the fundamental limit and achieve a better uniformity profile. In other words, the complexity of multi-directional launch is suitable to overcome specific fundamental limitations of waveguide designs based on uni-directional launch.

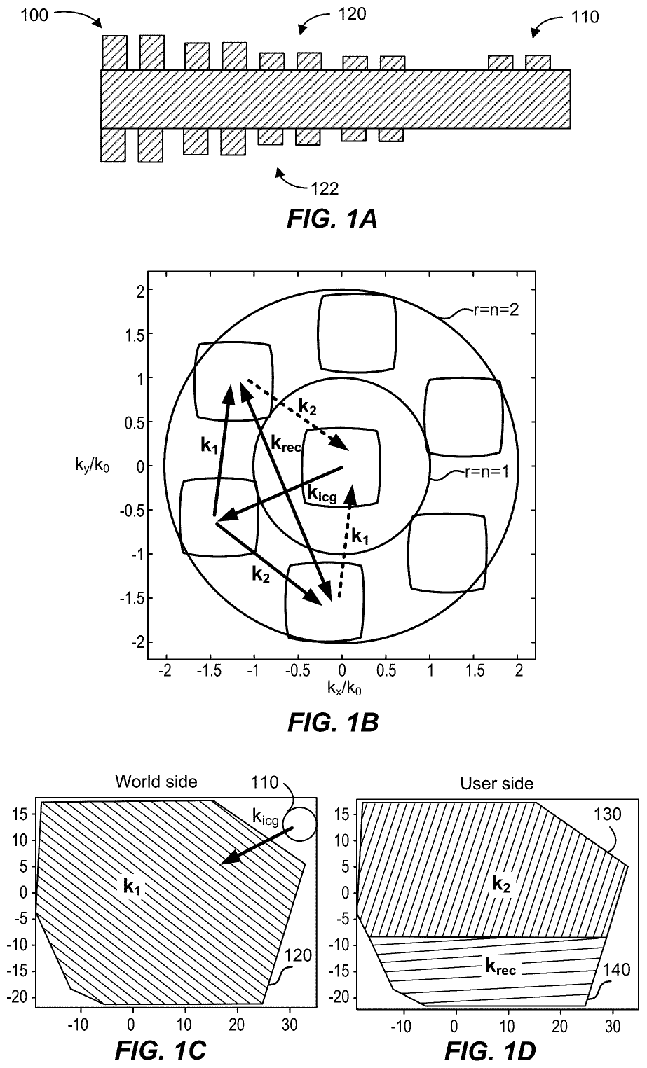

FIGS. 1A-1D illustrate the basic functioning of an eyepiece waveguide based on uni-directional launch whereby the input coupling grating (ICG) couples the light from the projector into the high refractive index medium (e.g., glass) of the eyepiece waveguide.

FIG. 1A is a simplified cross-sectional diagram illustrating elements of an eyepiece waveguide according to an embodiment of the present invention. As illustrated in FIG. 1A, eyepiece waveguide 100 includes an input coupling grating (ICG) 110 formed on a first portion of the eyepiece waveguide and a combined pupil expander (CPE) including grating structure 120 formed on a second portion of the world side of the eyepiece waveguide and grating structure 122 formed on a second portion of the user side of the eyepiece waveguide. Light is incoupled into the eyepiece waveguide 100 using ICG 110 and outcoupled toward the user using CPE including grating structure 120 and grating structure 122.

In the illustrated embodiment, the grating depth in the CPE varies as a function of lateral position, increasing as the distance from ICG 110 increases, and thereby increasing the grating coupling efficiency as a function of lateral position. In other embodiments, the grating depth or other grating parameters related to grating strength is constant as a function of lateral position. Thus, both varying grating parameters and constant grating parameters are included within the scope of the present invention. Moreover, although figures herein do not represent varying grating parameters, e.g., varying grating depth, it will be understood that the grating parameters can vary in the embodiments described herein.

FIG. 1B is a simplified k-space diagram illustrating the field of view and grating vectors for an eyepiece waveguide according to an embodiment of the present invention. Referring to FIG. 1B, the k-space diagram can be used to understand the flow of light using this momentum space representation. As shown in FIG. 1B, the inner circle with radius=1 indicates momentum of light at all physically possible angles of incidence in free space or vacuum. The outer circle of radius=refractive index of glass (in this case, n=2), indicates all physically possible angles of incidence inside the eyepiece waveguide medium (e.g., glass). The field of view (FOV) corresponding to the projector is described by the extent of the barrel-shaped boxes shown in FIG. 1B. Thus, the coupled or launched light into the glass has momentum that lies in the annular region in momentum space (i.e., between the inner r=n=1 circle and the outer r=n=2 circle) and, due to total internal reflection, this light will not escape from the eyepiece waveguide unless and until the light interacts with a diffraction grating that changes the momentum. For light incoupled into the waveguide via ICG 110, the FOV corresponding to the projector (e.g., an FOV of 53°×53°) will be shifted in k-space as represented by vector k_{ICG}.

The grating vectors in the k-space representation shown in FIG. 1B indicate not only the direction, but also the pitch or grating periodicity for a given design wavelength. For instance, for an eyepiece waveguide designed specifically for the green wavelength of 525 nm, the k-space representation shown in FIG. 1B has a launch vector of k_{ICG}=1.5, which corresponds to one-dimensional gratings of pitch=525 nm/1.5=350 nm.

For a CPE with 1D, binary, square-ridge gratings, the diffraction vectors k₁ and k₂ are defined by momentum translations of k₁ and k₂. The diffraction of light propagating in the eyepiece waveguide by these diffraction gratings allows one to spread the launched light over a larger area, e.g., for exit pupil expansion. At the same time, these gratings also outcouple the spreading light, which corresponds to momentum translation shown by the dashed vectors in FIG. 1B. This outcoupled light is seen by the user's eye and subsequently, the digital content can be observed. Because the eyepiece waveguide can have two sided patterns (i.e., facing both the user and the outside world), implementations can use either 2D gratings on one side of the eyepiece waveguide, with these 2D gratings defined by momentum translations k₁ and k₂, or 1D gratings, each formed on one side of the two sides of the eyepiece waveguide can be utilized.

It should be noted that, referring to the k-space diagram illustrated in FIG. 1B, light corresponding to the FOV that is not overlapping with the annular region between r=n=1 and r=n=2 will not propagate by TIR. Accordingly, only the portion of the FOV overlapping with the annular region will be accessible to the user.

FIG. 1C is a simplified plan view of the world side of an eyepiece waveguide according to an embodiment of the present invention. Referring to FIG. 1C, light incoupled by ICG 110 propagates as illustrated by vector k_{ICG} toward CPE including grating structure 120 and grating structure 122. In this embodiment, the grating depth can increase from a first value in the upper right corner of the eyepiece waveguide to a larger value in the lower left corner of the eyepiece waveguide. The grating variation can be continuous, stepped, or the like. The world side of the CPE includes gratings defined by grating vector k₁, which diffracts the light toward the upper left portion of the CPE.

FIG. 1D is a simplified plan view of the user side of the eyepiece waveguide shown in FIG. 1C. As discussed in relation to FIG. 1C, the grating depth in region 130 can increase from a first value on the right side of the eyepiece waveguide to a larger value on the left side of the eyepiece waveguide. The user side of the CPE includes gratings defined by grating vector k₂ in region 130, which diffracts the light toward the lower side of the CPE and k_{rec} in region 140, which diffracts light back toward region 130 to provide a light recycling function. The grating vector k_{rec} associated with this “recycling” grating is illustrated in FIG. 1B.

Referring to FIGS. 1C and 1D concurrently, light propagating in the eyepiece waveguide can be diffracted as represented by grating vectors k₁ and k₂ in order to spread in the eyepiece waveguide as illustrated by the solid vectors k₁ and k₂ in FIG. 1B. Additionally, light can also be diffracted as represented by grating vectors k₁ and k₂ in order to outcouple toward the user as illustrated by the dashed vectors k₁ and k₂ in FIG. 1B. The periodicity for the CPE gratings coupled to the world side and the user side can be equal, with different orientations although this is not required. One of ordinary skill in the art would recognize many variations, modifications, and alternatives.

An eyepiece waveguide designed to provide good image quality for an AR display at green wavelengths will not typically provide similar image quality for an AR display at red and blue wavelengths because of grating pitch mismatch.

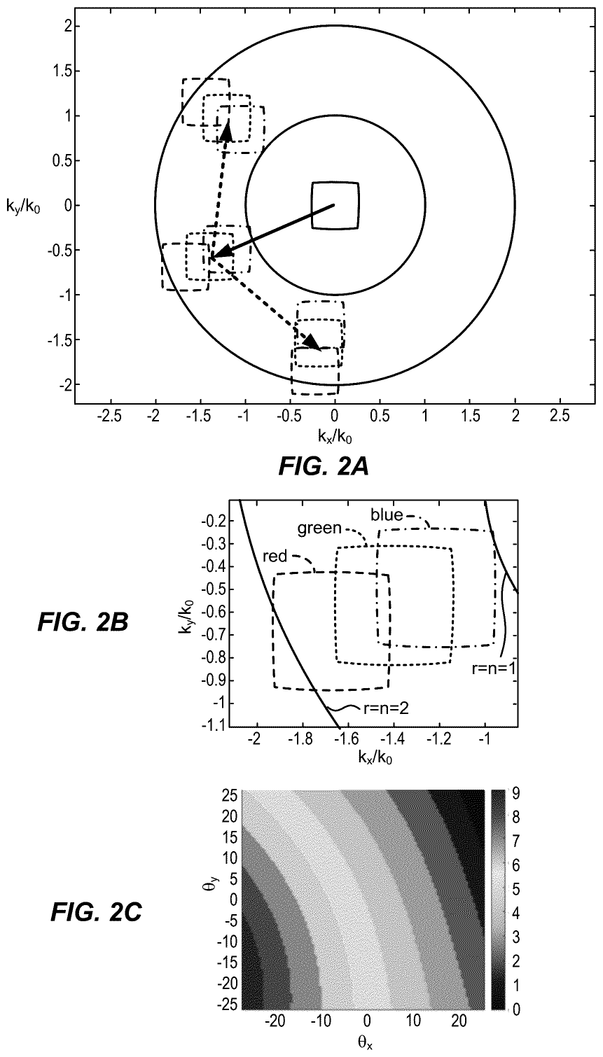

FIG. 2A is a simplified k-space diagram illustrating the field of view and grating vectors for an eyepiece waveguide operated at multiple wavelengths according to an embodiment of the present invention. In this k-space representation, the eyepiece waveguide utilizes a uni-directional launch architecture and has been designed for green wavelength operation with a 30°×30° FOV for all three wavelengths namely, red (628 nm), green (525 nm) and blue (455 nm).

FIG. 2B shows an enlarged portion of the k-space diagram illustrated in FIG. 2A. As illustrated in FIG. 2B, a significant portion of the red FOV lies outside the outer circle of r=n=2, resulting in light in this non-overlapping region not propagating in the waveguide and, as a result, not being present at the corresponding angles of incidence. For an eyepiece waveguide fabricated using glass with a refractive index of n=2, the maximum square-shaped FOV that can be achieved is around 24°×24°.

Besides this fundamental limitation, another issue is that within the glass waveguide, the three different wavelengths interact quite differently with the gratings, not only because of grating vector mismatch and wavelength-dependence of diffraction, but also because of the different number of times the propagating light hits the gratings. In other words, the number of bounces between the two faces of the waveguide differs as a function of wavelength. In general, the TIR light with momentum values close to the inner r=n=1 circle (e.g., the blue FOV in FIG. 2A) bounces more frequently compared to the TIR light with momentum values close to the outer r=n=2 circle (e.g., the red FOV in FIG. 2A).

FIG. 2C is a plot illustrating the number of bounces light experiences with 2 mm of propagation as a function of angle. For light with a FOV of 55°×55°, light launched inside a 0.35 mm thick, n=2.0 eyepiece waveguide, FIG. 2C shows the number of bounces experienced within a 2 mm propagation distance represented by angle. The top-right corner of FIG. 2C indicates momenta lying close to the outer r=n=2 circle in k-space and the bottom-left corner indicates momenta lying close to the inner r=n=1 circle in k-space. A large difference in bounce frequency for these opposite scenarios causes a large discrepancy in the interaction with the diffraction gratings and between red and blue light propagation specific to a single layer design. As a result, these constraints generally lead to non-uniformity issues in the display. Therefore, embodiments of the present invention utilize new types of architectures that can avoid these underlying discrepancies and provide improved performance.

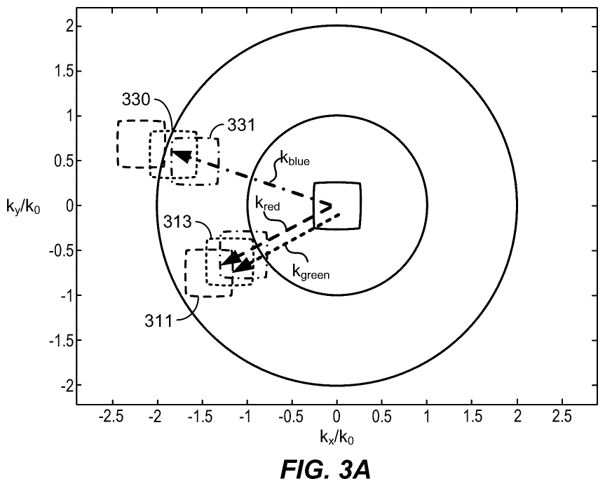

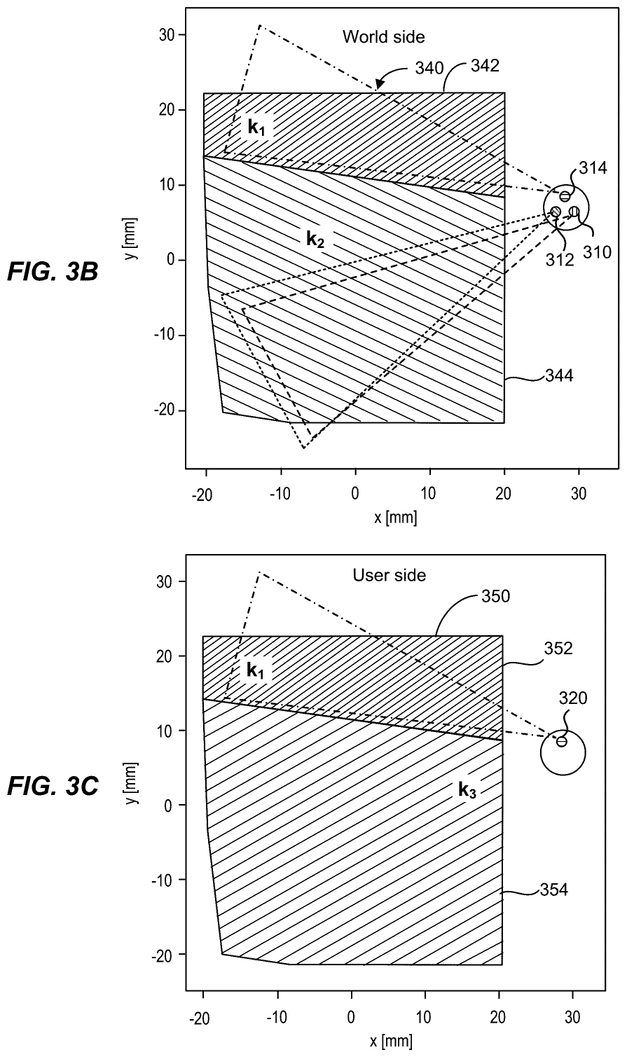

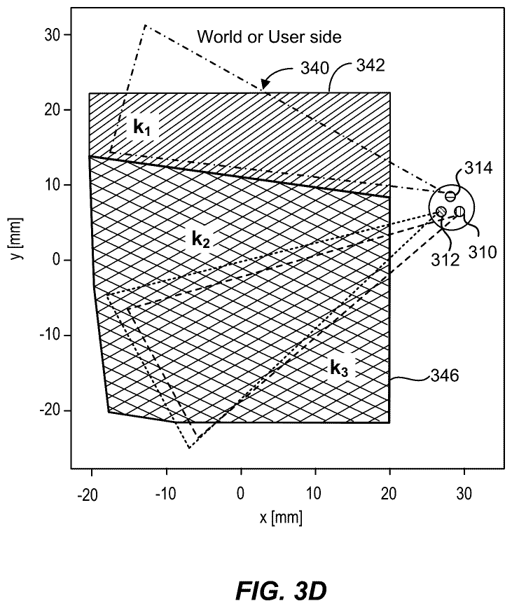

FIG. 3A is a simplified k-space diagram illustrating the field of view and ICG grating vectors for an eyepiece waveguide with multi-directional launch according to an embodiment of the present invention. FIG. 3B is a simplified plan view of the world side of an eyepiece waveguide with multi-directional launch according to an embodiment of the present invention. FIG. 3C is a simplified plan view of the user side of the eyepiece waveguide with multi-directional launch illustrated in FIG. 3B. In addition to the ICG and CPE regions of the eyepiece waveguide, FIGS. 3B and 3C show the fan angles of light that is launched into the eyepiece waveguide using the ICGs.

Although an exemplary eyepiece waveguide with multi-directional launch is illustrated in relation to FIGS. 3A-3C, it will be appreciated that multiple multi-directional launch architectures are included within the scope of the present invention. For this illustration, a 30°×30° FOV is utilized.

Referring to FIGS. 3B and 3C, this exemplary embodiment utilizes a multi-directional launch eyepiece waveguide design in which separate ICG pupils disposed on the world side of the eyepiece waveguide, illustrated as red ICG 310, green ICG 312, and blue ICG 314 in FIG. 3B, are utilized in conjunction with blue ICG 320 disposed on the user side of the eyepiece waveguide as shown in FIG. 3C. Thus, light from the projector is coupled into the eyepiece waveguide using these four ICGs. However, as discussed more fully below, the grating periodicity for the various ICGs and the corresponding grating vectors, which are designed with respect to a green wavelength, are different for blue light (and the blue ICGs) as compared to red and green light (and the red and green ICGs). Although the embodiment illustrated in FIG. 3C includes blue ICG 320 disposed on the user side of the eyepiece waveguide, this is not required and, in some embodiments, blue ICG 320 is optional.

As shown in FIG. 3A, gratings corresponding to grating vector k_{red} and grating vector k_{green} are characterized by a same grating dimension (i.e., the same grating periodicity, for example 525 nm/˜1.5≈350 nm) while the grating corresponding to grating vector k_{blue} is characterized by a larger grating dimension (i.e., a smaller grating periodicity, for example 525 nm/˜1.9≈276 nm). Thus, for red ICG 310 and green ICG 312, light at the center of the FOV is diffracted into the eyepiece waveguide to produce red FOV 311 for red wavelengths and green FOV 313 for green wavelengths. Both of these FOVs are within the annular region defined by r=n=1 and r=n=2. Light diffracted into the eyepiece waveguide using blue ICG 314 coupled to the world side of the eyepiece waveguide or blue ICG 320 coupled to the user side of the eyepiece waveguide diffracts as represented by k_{blue}. Thus, for blue ICG 314 and blue ICG 320, light at the center of the FOV is diffracted into the eyepiece waveguide to produce blue FOV 331. This FOV is within the annular region defined by r=n=1 and r=n=2.

Referring to FIG. 3B, the orientation of the gratings in red ICG 310 and green ICG 312 are oriented such that red and green light is launched into the eyepiece waveguide toward region 344 of the CPE 340 and is directed to the lower left portion of the CPE. The orientation of the gratings in blue ICG 314 and blue ICG 320 are oriented such that blue light is launched into the eyepiece waveguide toward region 342 of the CPE 340 on the world side and toward region 352 of the CPE 350 on the user side and is directed to the upper left portion of the CPE.

Referring to diffraction from the blue ICGs, since the eyepiece waveguide is designed with respect to a green wavelength, green light at the center of the FOV that would be diffracted by the blue ICG is diffracted into green FOV 330, which is partially overlapping with the region outside the r=n=2 circle. However, light at blue wavelengths will be diffracted into blue FOV 331, which is within the annular region. Accordingly, this wavelength-specific, multi-directional launch architecture enables a full 30°×30° FOV because the respective barrel-shaped boxes corresponding to red FOV 311, green FOV 313, and blue FOV 331, which correspond to TIR light, lie entirely within the annular region.

The grating vectors in the CPE, including grating vector k₂ in region 344 of CPE 340 and grating vector k₃ in region 354 of CPE 350, are designed such that the light spreads within the waveguide and comes out from the central region of the eyepiece.

Although FIG. 3C illustrates blue light being incoupled by blue ICG 320 coupled to the user side of the CPE 350 and diffracting into CPE 350, this is not required and blue ICG 320 is optional in some embodiments.

It should be noted that, although particular diffractive structures are illustrated as being fabricated on both the world side and the user side in FIGS. 3B and 3C, this is merely exemplary. In other embodiments, the diffractive structures that are illustrated as being coupled to the world side can be fabricated so that they are coupled to the user side and the diffractive structures that are illustrated as being coupled to the user side can be fabricated so that they are coupled to the world side. Accordingly, the diffractive structures can be implemented on either side as appropriate to the particular application. Moreover, as described more fully below, the diffractive structures can be fabricated so that they are coupled to a single side of the eyepiece waveguide.

FIG. 3D is a simplified plan view of a single-sided eyepiece waveguide with multi-directional launch according to an embodiment of the present invention. The single-sided eyepiece waveguide illustrated in FIG. 3D shares common elements with the eyepiece waveguides illustrated in FIGS. 3B and 3C. In the embodiment illustrated in FIG. 3D, region 346 includes gratings corresponding to both grating vector k₂ and grating vector k₃. Accordingly, the functionality discussed in relation to FIGS. 3B and 3C is implemented in the embodiment illustrated in FIG. 3D using a single-sided design.

It should be noted that the eyepiece waveguide can be fabricated using a substrate of a certain refractive index with diffractive structures of a single index of refraction or diffractive structures in which different regions are characterized by different indices of refraction. This can be accomplished by drop on demand inkjetting of UV/Heat curable resin of varying index before patterning with a template or do it in a region by region patterning method, such as using J-FIL™ Nanoimprinting Technology. Different indices can also be accommodated in different regions by doing a deposition of inorganic high index material such as Si₃N₄, ZrO₂, TiO₂, etc. with stencil masks, where the deposition can be done using Physical or Chemical Vapor Deposition process such as Evaporation, Sputter, PECVD, ALD, etc. As an example, in FIG. 3D, CPE 340 could be fabricated so that region 342 has a first index of refraction and region 346 has a second index of refraction that is different from the first index of refraction. Accordingly, the gratings corresponding to the various grating vectors can be defined with respect to different indices of refraction in the different regions.

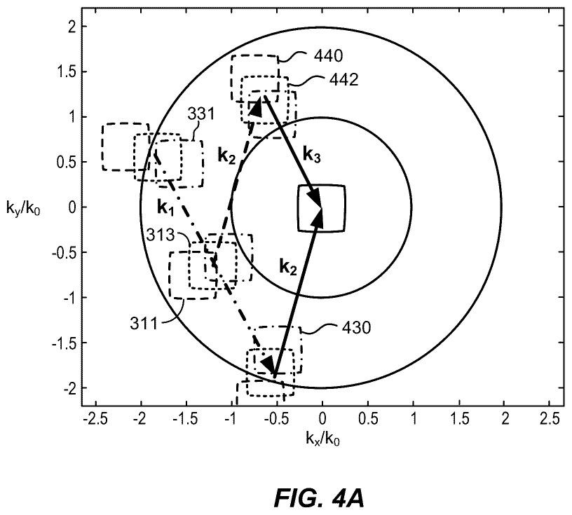

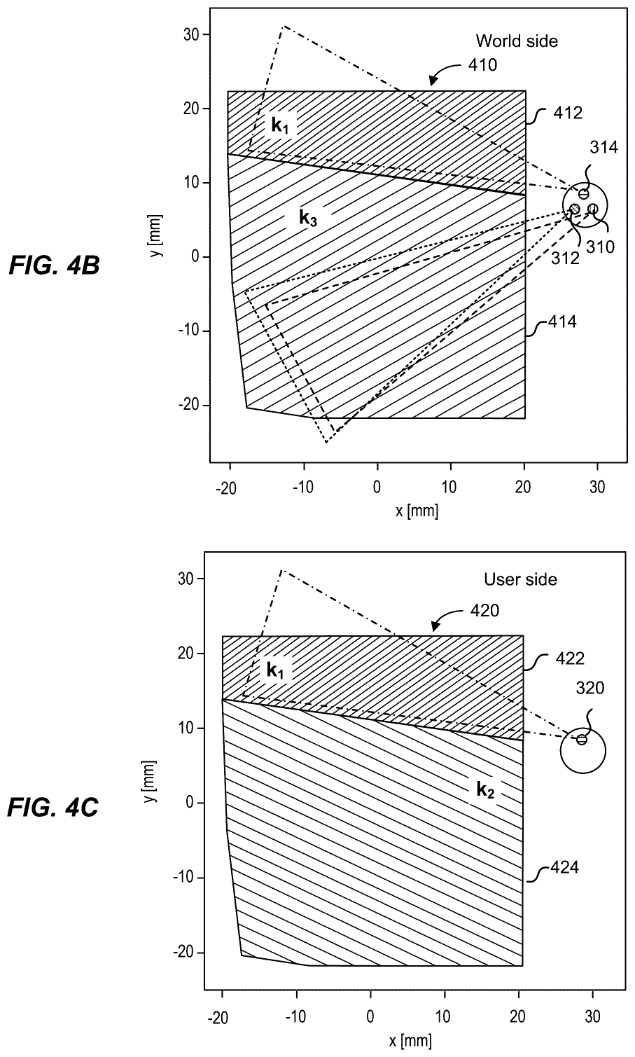

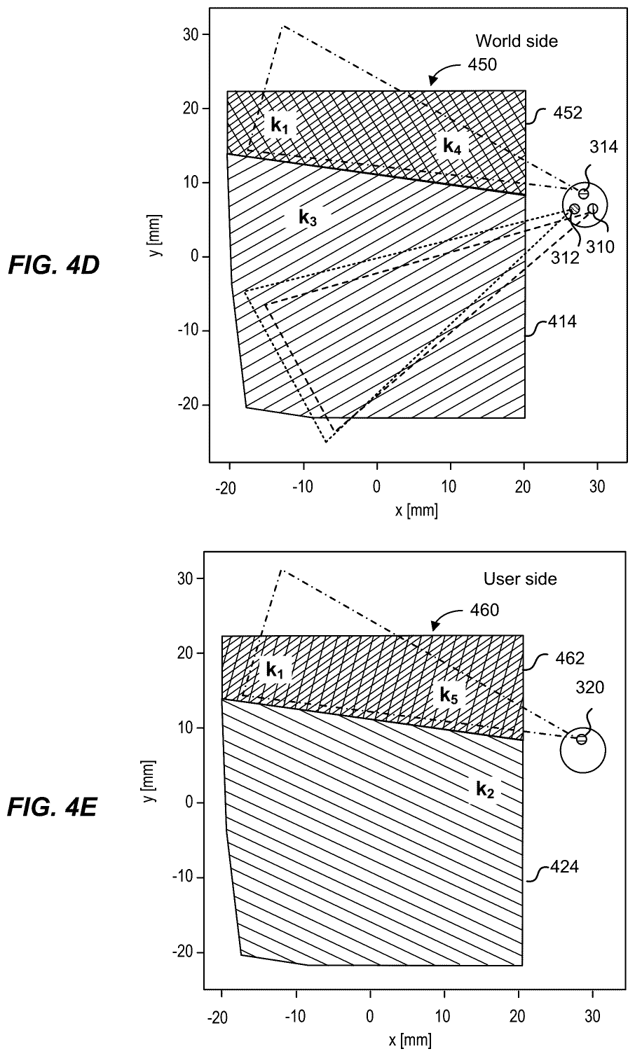

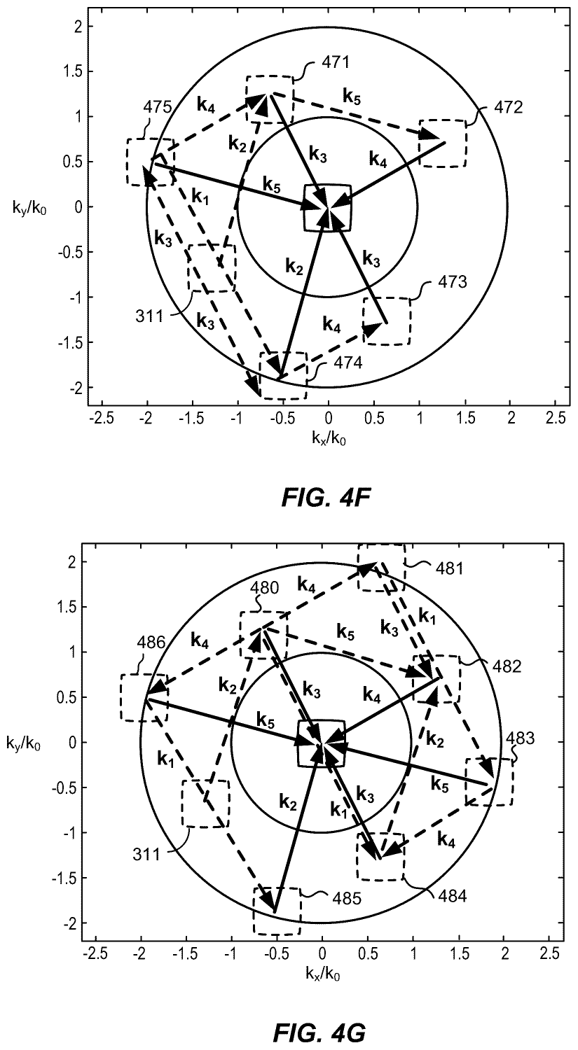

FIG. 4A is a simplified k-space diagram illustrating the field of view and CPE grating vectors for an eyepiece waveguide with multi-directional launch according to an embodiment of the present invention. FIG. 4B is a simplified plan view of the world side of an eyepiece waveguide with multi-directional launch according to an embodiment of the present invention. FIG. 4C is a simplified plan view of the user side of the eyepiece waveguide with multi-directional launch illustrated in FIG. 4B. In addition to the ICG and CPE regions of the eyepiece waveguide, FIGS. 4B and 4C show the fan angles of light that is launched into the eyepiece waveguide using the ICGs. For comparison, FIG. 4A illustrates grating vectors corresponding to the CPE, whereas FIG. 3A illustrates grating vectors (i.e., the launch vectors) for the ICGs.

Referring to the k-space representation of the CPE gratings illustrated in FIG. 4A and the plan views of the eyepiece waveguide illustrated in FIGS. 4B and 4C, blue light that is launched toward the upper left portion of CPE 410 and impinges on gratings in region 412 as illustrated in FIG. 4B, diffracts as illustrated by grating vector k₁ and propagates towards the central portion of the eyepiece waveguide, where it interacts with gratings coupled to the user side of the CPE 420 (i.e., region 424) and is outcoupled as illustrated by grating vector k₂. As illustrated in FIG. 4B, the grating periodicity in region 412 is characterized by a smaller grating periodicity, for example 525 nm/˜1.9≈276 nm, compared to the grating periodicity in region 414, for example, 525 nm/˜1.5≈350 nm. Although the differing grating periodicity is not illustrated in other figures, including FIG. 4C, for purposes of clarity, it will be appreciated that the grating periodicity associated with different grating vectors will vary as appropriate to the particular application.

Green light and red light that are launched toward the lower left portion of CPE 410 and impinge on gratings in region 424 coupled to the user side of the CPE 420 as illustrated in FIG. 4C, diffract as illustrated by grating vector k₂ and are outcoupled as they interact with gratings coupled to the world side of the CPE 410 (i.e., region 414) as illustrated by grating vector k₃. Thus, this embodiment utilizes gratings that are disposed on both the world side and the user side of the eyepiece waveguide as illustrated in FIGS. 4B and 4C. It should be noted that the grating height does not need to be constant, but can increase, for example, incrementally across the CPE in a continuous or discrete manner including gradation zones.

Since the eyepiece waveguide is designed with respect to a green wavelength, blue light in blue FOV 331 diffracts in region 412 along grating vector k₁ such that blue FOV 430 is positioned within the annular region. Accordingly, outcoupling, as indicated by grating vector k₂, will result in blue FOV 430 being outcoupled to the user without clipping of the FOV. Red light in red FOV 311 and green light in green FOV 313 diffract in region 424 coupled to the user side of the eyepiece waveguide along grating vector k₂ to form red FOV 440 and green FOV 442, both of which are positioned within the annular region. Upon interaction with gratings in region 414 coupled to the world side of the eyepiece waveguide, outcoupling occurs as represented by grating vector k₃, resulting in outcoupling of red FOV 440 and green FOV 442 without clipping of the FOVs. It will be noted that the k-space diagrams are referenced to the green wavelength and, as a result, the grating vectors originate and terminate at the center of the green FOVs.

Although FIG. 4C illustrates blue light being incoupled by blue ICG 320 coupled to the user side of the CPE 420 and diffracting into region 422, this is not required and blue ICG 320 is optional in some embodiments.

One benefit provided by embodiments of the present invention utilizing multi-directional launch designs is to equalize the number of bounces for red and blue wavelengths. As illustrated in FIG. 2C, the light rays within the annulus having momentum close to the inner circle interact strongly with the gratings because of multiple bounces. The light rays with momentum lying close to the outer circle interact more weakly with the gratings because of their grazing incidence angle. For a uni-directional launch design, the red FOV lies close to the outer circle while the blue FOV lies close to the inner circle, thereby causing a large discrepancy in their interaction with the CPE gratings, eventually resulting in display nonuniformity.

For the multi-directional launch design in FIG. 4A, both red FOV 440 and blue FOV 331 are positioned close to the outer r=n=2 circle, which considerably reduces this discrepancy based on the number of bounces within the waveguide.

In addition to implementation of the illustrated diffractive structures on the other side of the eyepiece waveguide that is illustrated, it is also possible to implement the diffractive structures on both sides of the eyepiece waveguide. As an example, the diffractive structures illustrated in FIG. 3D could be implemented on both the world side and the user side of the eyepiece waveguide. Moreover, the diffractive structures illustrated in FIG. 4B could be implemented on a first side (e.g., either the world side or the user side) of the eyepiece waveguide and the diffractive structure illustrated in FIG. 3D could be implemented on the second side (e.g., either the user side or the world side) of the eyepiece waveguide. Additionally, the diffractive structures illustrated in FIG. 3D could be implemented on a first side (e.g., either the world side or the user side) of the eyepiece waveguide and the diffractive structure illustrated in FIG. 4C could be implemented on the second side (e.g., either the user side or the world side) of the eyepiece waveguide. One of ordinary skill in the art would recognize many variations, modifications, and alternatives.

FIG. 4D is a simplified plan view of the world side of an eyepiece waveguide including a two dimensional grating with multi-directional launch according to an embodiment of the present invention. FIG. 4E is a simplified plan view of the user side of the eyepiece waveguide including a two dimensional grating with multi-directional launch illustrated in FIG. 4D. The eyepiece waveguide illustrated in FIG. 4D shares common elements with the eyepiece waveguide illustrated in FIG. 4B and the eyepiece waveguide illustrated in FIG. 4E shares common elements with the eyepiece waveguide illustrated in FIG. 4C. In addition to the elements discussed in relation to FIGS. 4B and 4C, region 452 of CPE 450 includes gratings corresponding to grating vector k₄ and region 462 of CPE 460 includes gratings corresponding to grating vector k₅. As discussed in relation to FIGS. 4F and 4G, the addition of gratings corresponding to grating vectors k₄ and k₅ introduce additional diffraction pathways that facilitate diffraction in the plane of the eyepiece waveguide as well as outcoupling from the eyepiece waveguide.

FIG. 4F is a simplified k-space diagram illustrating the field of view and CPE grating vectors for the eyepiece waveguide with multi-directional launch illustrated in FIGS. 4D and 4E according to an embodiment of the present invention.

Referring to FIG. 4F, light incoupled by red ICG 310 is diffracted into the eyepiece waveguide to produce red FOV 311. Diffraction by gratings corresponding to grating vector k₂ results in red FOV 311 shifting to FOV 471, which can be outcoupled as a result of diffraction from gratings corresponding to grating vector k₃. If the light is not outcoupled by grating vector k₃, then diffraction from gratings corresponding to grating vector k₅ results in shifting of FOV 471 to FOV 472, which can be outcoupled as a result of diffraction from gratings corresponding to grating vector k₄.

Diffraction by gratings corresponding to grating vector k₃ results in red FOV 311 shifting to FOV 474 or FOV 475, which can be outcoupled as a result of diffraction from gratings corresponding to grating vector k₂ and grating vector k₅, respectively. If the light is not outcoupled by grating vectors k₂ or grating vector k₅, then diffraction from gratings corresponding to grating vector k₄ results in shifting of FOV 474 to FOV 473 and FOV 475 to FOV 471, which can be outcoupled as a result of diffraction from gratings corresponding to grating vector k₃. Similar diffraction pathways can be described for green FOV 313 and blue FOV 331. These diffraction pathways are merely exemplary and are not exhaustive of the different diffraction pathways provided by embodiments of the present invention.

FIG. 4G is a simplified k-space diagram illustrating the field of view and CPE grating vectors for the eyepiece waveguide with multi-directional launch illustrated in FIGS. 4D and 4E according to another embodiment of the present invention.

Referring to FIG. 4G, light incoupled by red ICG 310 is diffracted into the eyepiece waveguide to produce red FOV 311. Diffraction by gratings corresponding to grating vector k₂ results in red FOV 311 shifting to FOV 480, which can be outcoupled as a result of diffraction from gratings corresponding to grating vector k₃. If the light is not outcoupled by grating vector k₃, then diffraction from gratings corresponding to grating vector k₄ results in shifting of FOV 480 to FOV 486, which can be outcoupled as a result of diffraction from gratings corresponding to grating vector k₅ or shifting of FOV 480 to FOV 481. Diffraction from gratings corresponding to grating vector k₃ will result in shifting of FOV 481 to FOV 482, which can be outcoupled as a result of diffraction from gratings corresponding to grating vector k₄. Alternatively, diffraction from gratings corresponding to grating vector k₁ will result in shifting of FOV 481 to FOV 483, which can be outcoupled as a result of diffraction from gratings corresponding to grating vector k₅. If the light is not outcoupled by grating vector k₅, then diffraction from gratings corresponding to grating vector k₄ results in shifting of FOV 483 to FOV 484, which can be outcoupled as a result of diffraction from gratings corresponding to grating vector k₃.

Returning to FOV 480, diffraction by gratings corresponding to grating vector k₅ results in FOV 480 shifting to FOV 482, which can be outcoupled as a result of diffraction from gratings corresponding to grating vector k₄. If the light is not outcoupled by grating vector k₄, then diffraction from gratings corresponding to grating vector k₂ results in shifting of FOV 482 to FOV 484, which can be outcoupled as a result of diffraction from gratings corresponding to grating vector k₃. Returning to FOV 486, diffraction by gratings corresponding to grating vector k₁ results in FOV 486 shifting to FOV 485, which can be outcoupled as a result of diffraction from gratings corresponding to grating vector k₂. Similarly, diffraction by gratings corresponding to grating vector k₁ results in FOV 480 shifting to FOV 484, which can be outcoupled as a result of diffraction from gratings corresponding to grating vector k₃. If the light is not outcoupled by grating vector k₃, then diffraction from gratings corresponding to grating vector k₂ results in shifting of FOV 484 to FOV 482, which can be outcoupled as a result of diffraction from gratings corresponding to grating vector k₄ or diffraction from gratings corresponding to grating vector k₄ results in shifting of FOV 484 to FOV 483, which can be outcoupled as a result of diffraction from gratings corresponding to grating vector k₅. Similar diffraction pathways can be described for green FOV 313 and blue FOV 331. Moreover, these diffraction pathways are merely exemplary and are not exhaustive of the different diffraction pathways provided by embodiments of the present invention.

Referring once again to FIG. 3D, gratings corresponding to grating vector k₄ and grating vector k₅ can be added to region 342 of CPE 350 in a single-sided design. In a double-sided design, gratings corresponding to grating vector k₄ can be added to region 342 of CPE 340 on either the world side or the user side and gratings corresponding to grating vector k₅ can be added to region 342 of CPE 340 on either the user side or the world side to implement two dimensional gratings in both region 342 and region 346. The addition of gratings corresponding to grating vectors k₄ and k₅ introduce additional diffraction pathways that facilitate diffraction in the plane of the eyepiece waveguide as well as outcoupling from the eyepiece waveguide in both single-sided and double-sided designs.

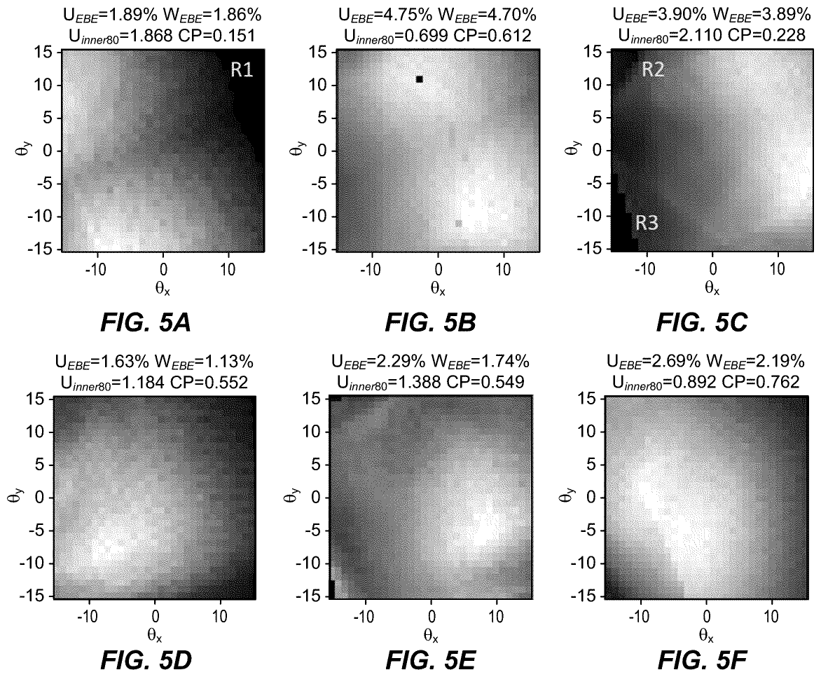

FIGS. 5A-5C illustrate normalized efficiency distributions for red, green, and blue wavelengths, respectively, for a uni-directional launch design according to embodiments of the present invention. In these figures, the optical performance of the waveguide architecture is characterized for an eyepiece waveguide similar to that illustrated in FIG. 1C. FIGS. 5A-5C show the efficiency distribution over the 30°×30° field of view for a uni-directional launch design for red, green, and blue wavelengths, respectively.

Referring to FIG. 5A, the user side eyebox efficiency (UEBE) and world side eyebox efficiency (WEBE) for red wavelengths are shown. UEBE and WEBE indicate the percentage of total incident power from the projector that eventually reaches the eyebox plane at the nominal distance of the eye from the waveguide on both sides of the eyepiece. The efficiency distribution is nonuniform because light rays corresponding to different angles of incidence spread inside the waveguide and interact with the gratings differently. The uniformity of the display can be represented by the 80-20 percentile score over the inner 80% of the field of view as indicated by Uᵢₙₙₑᵣ₈₀. Uᵢₙₙₑᵣ₈₀ is the ratio of the difference between the 80^{th} percentile and the 20^{th} percentile to 50th percentile (i.e., the median). A lower value of Uᵢₙₙₑᵣ₈₀ indicates better uniformity. FIG. 5B shows the UEBE and the WEBE for green wavelengths and FIG. 5C shows the UEBE and the WEBE for blue wavelengths. Uᵢₙₙₑᵣ₈₀ is equal to 1.868 for red wavelengths, 0.699 for green wavelengths, and 2.110 for blue wavelengths. Region R1 in FIG. 5A and regions R2 and R3 in FIG. 5C indicate cropped portions of the field of view where the light intensity is zero.

FIGS. 5D-5F illustrate normalized efficiency distributions for red, green, and blue wavelengths, respectively, for a multi-directional launch design according to embodiments of the present invention. In these figures, the optical performance of the waveguide architecture is characterized for an eyepiece waveguide similar to that illustrated in FIGS. 3A/3B. FIGS. 5A-5C show the efficiency distribution over the 30°×30° field of view for a multi-directional launch design for red, green, and blue wavelengths, respectively.

Comparing FIGS. 5D-5F to FIGS. 5A-5C, Uᵢₙₙₑᵣ₈₀ is equal to 1.184 for red wavelengths, 1.388 for green wavelengths, and 0.0892 for blue wavelengths. Importantly, the regions marked as R1, R2, R3 in FIGS. 5A-5C show clipping of 30°×30° field of view for the uni-directional launch design whereas no such clipping is present inf FIGS. 5D-5F, indicating that the field of view limitation is overcome by the multi-directional launch architecture.

Although the efficiency distribution is nonuniform, the color correction algorithm adjusts the weights corresponding to different angles of incidence within the FOV to obtain a good color (white) uniformity of the AR display. Additionally, the center to peak ratio (i.e., the efficiency at the center divided by the peak efficiency, with an ideal value=1) indicates the centeredness of the efficiency distribution across the FOV.

Yet another comparison between the uni-directional launch design and multi-directional launch design is presented in Table 1 in which the maximum FOV possible is calculated based on the k-space diagrams, thereby ensuring that the square-shaped FOV lies completely within the annulus for 2.0 index waveguide. For these calculations, we assume, for both uni-directional and multi-directional launch designs, that the ICG or the projector is situated above the center on the temple side to enable larger real world FOV, an equal horizontal (H) and vertical (V) extent of the FOV, and a constant value of the index of refraction for all wavelengths. As is evident in Table 1, the multi-directional launch designs have a distinct fundamental advantage in terms of the maximum digital FOV that can be realized.

TABLE 1

| | | | Maximum | Maximum |
|---|---|---|---|---|
| | | Maximum FOV | diagonal FOV | diagonal FOV |
| Refractive | Maximum FOV | (H/V) for the | (H/V) for the | (H/V) for the |
| index of the | (H/V) for the uni- | multi-directional | uni-directional | multi-directional |
| waveguide | directional launch | launch design | launch design | launch design |
| substrate | design (degrees) | (degrees) | (degrees) | (degrees) |
| 1.8 | 15.73 | 23.08 | 22.1 | 32.2 |
| 1.85 | 17.68 | 25.18 | 24.8 | 35.1 |
| 1.9 | 19.65 | 27.31 | 27.5 | 37.9 |
| 1.95 | 21.65 | 29.30 | 30.3 | 40.6 |
| 2.0 | 23.68 | 31.71 | 33.0 | 43.8 |
| 2.05 | 25.74 | 33.71 | 35.8 | 46.6 |
| 2.1 | 27.85 | 35.81 | 38.6 | 49.1 |
| 2.15 | 29.98 | 38.50 | 41.5 | 52.6 |
| 2.2 | 21.17 | 40.98 | 44.4 | 55.7 |
| 2.25 | 34.40 | 43.53 | 47.3 | 58.9 |
| 2.3 | 36.68 | 45.82 | 50.2 | 61.7 |

It should be noted that, for light launched into the waveguide via the projector utilizing a different ICG placement (i.e., a different launch angle), the maximum attainable diagonal FOV changes for both types of designs. However, it can be shown that the multi-directional launch design always leads to larger possible FOV than the uni-directional launch design.

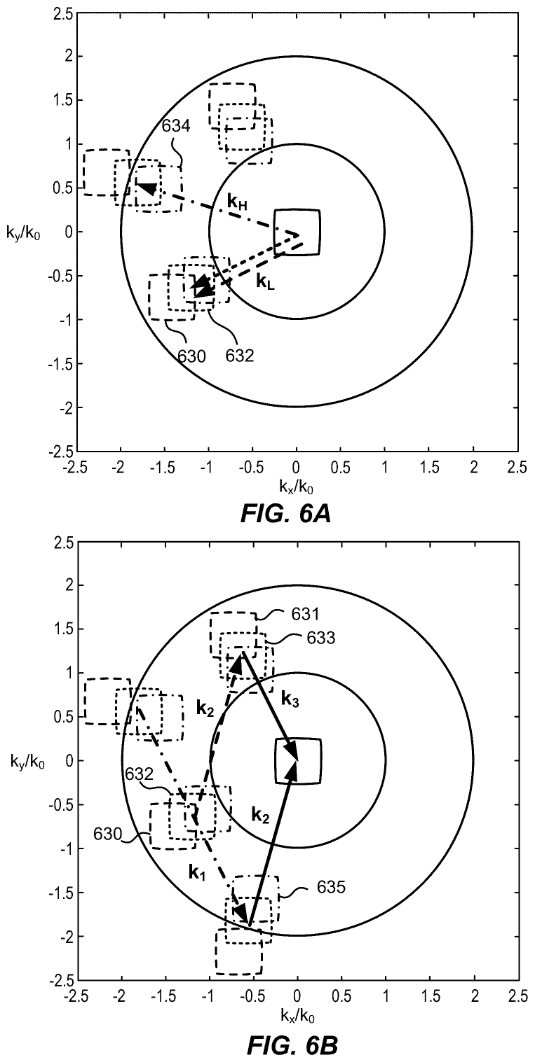

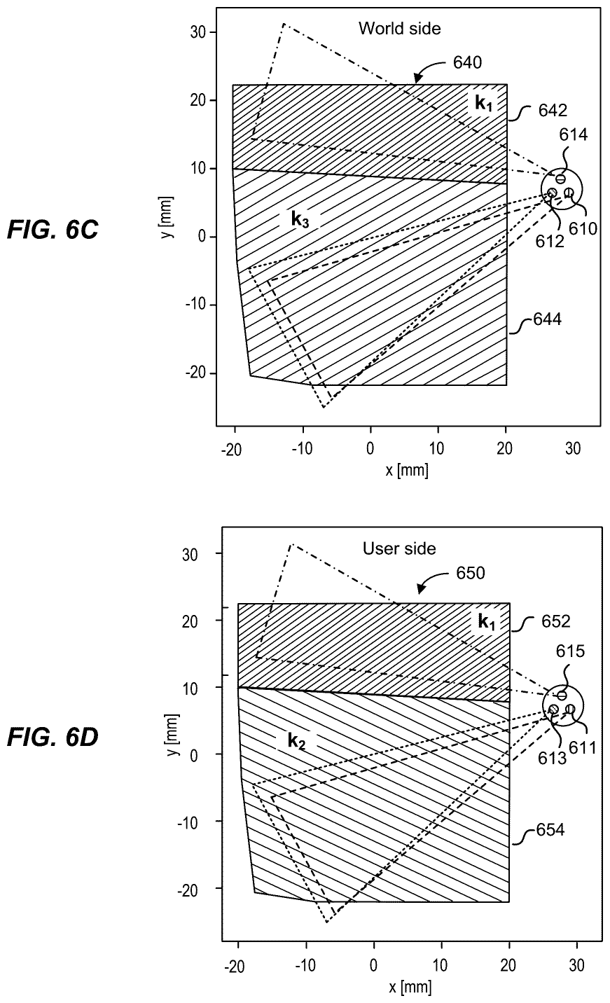

In relation to FIGS. 6A-16D, k-space representations of ICG gratings and CPE gratings, as well as CPE layouts showing the locations of respective gratings for several multi-directional launch waveguide architectures, are illustrated. Additionally, the minimal sequence of diffraction events that direct the projector light at red, green, or blue wavelength to the user's eye is discussed. The k-space representations are for a 30×30 FOV with an eyepiece waveguide with a refractive index of n=2.0 and three separate ICG pupils for red, green, and blue wavelengths. The grating vectors are normalized with respect to green free-space momentum.

FIG. 6A is a simplified k-space diagram illustrating the field of view and ICG grating vectors for a first eyepiece waveguide with multi-directional launch according to an embodiment of the present invention. FIG. 6B is a simplified k-space diagram illustrating the field of view and CPE grating vectors for the first eyepiece waveguide with multi-directional launch according to an embodiment of the present invention. FIG. 6C is a simplified plan view of the world side of the first eyepiece waveguide with multi-directional launch according to an embodiment of the present invention. FIG. 6D is a simplified plan view of the user side of the first eyepiece waveguide with multi-directional launch illustrated in FIG. 6C.

Referring first to FIGS. 6C and 6D, this first eyepiece waveguide utilizes a multi-directional launch eyepiece waveguide design in which separate ICG pupils coupled to the world side of the eyepiece waveguide, illustrated as red ICG 610, green ICG 612, and blue ICG 614 in FIG. 6C, are utilized in conjunction with red ICG 611, green ICG 613, and blue ICG 615 coupled to the user side of the eyepiece waveguide as shown in FIG. 6D. Thus, light from the projector is coupled into the eyepiece waveguide using these six ICGs. However, as discussed more fully below, the grating periodicity for the various ICGs and the corresponding grating vectors, which are designed with respect to a green wavelength, are different for blue light (and the blue ICGs) as compared to red and green light (and the red and green ICGs). Although the embodiment illustrated in FIG. 6D includes red ICG 611, green ICG 613, and blue ICG 615 coupled to the user side of the eyepiece waveguide, this is not required and, in some embodiments, red ICG 611, green ICG 613, and blue ICG 615 are optional.

Referring to FIG. 6A, grating vector k_{H} represents diffraction by a larger distance (High) in k-space and grating vector k_{L} represents diffraction by a smaller distance (Low) in k-space. Thus, the gratings corresponding to grating vector k_{L} are characterized by a same grating dimension (i.e., the same grating periodicity, for example 525 nm/˜1.5≈350 nm) while the gratings corresponding to grating vector k_{H} are characterized by a larger grating dimension (i.e., a smaller grating periodicity, for example 525 nm/˜1.9≈276 nm). Thus, for red ICG 610 and green ICG 612 coupled to the world side of the eyepiece waveguide or red ICG 611 and green ICG 613 coupled to the user side of the eyepiece waveguide, light at the center of the FOV is diffracted into the eyepiece waveguide as represented by grating vector k_{L} to produce red FOV 630 for red wavelengths and green FOV 632 for green wavelengths. Both of these FOVs are positioned within the annular region between r=n=1 and r=n=2. Light diffracted into the eyepiece waveguide using blue ICG 614 coupled to the world side of the eyepiece waveguide or blue ICG 615 coupled to the user side of the eyepiece waveguide diffracts as represented by k_{H}. Thus, for blue ICG 614 coupled to the world side and blue ICG 615 coupled to the user side of the eyepiece waveguide, light at the center of the FOV is diffracted into the eyepiece waveguide to produce blue FOV 634 for blue wavelengths. This FOV is positioned within the annular region between r=n=1 and r=n=2. Accordingly, this wavelength-specific, multi-directional launch architecture enables a full 30°×30° FOV because the respective barrel-shaped boxes corresponding to red FOV 630, green FOV 632, and blue FOV 634, which correspond to TIR light, lie entirely within the annular region.

Referring to FIG. 6C, the orientation of the gratings in red ICG 610 and green ICG 612, as well as red ICG 611 and green ICG 613, are oriented such that red and green light is launched into the eyepiece waveguide toward region 644 of the CPE 640 and toward region 654 of the CPE 650. The orientation of the gratings in blue ICG 614 and blue ICG 615 are oriented such that blue light is launched into the eyepiece waveguide toward region 642 of the CPE 640 on the world side and toward region 652 of the CPE 650 on the user side.

Referring to FIGS. 6B and 6D, red and green light that is launched toward region 654 of CPE 650 impinges on gratings corresponding to grating vector k₂, thereby diffracting in the plane of the eyepiece waveguide (i.e., laterally in the eyepiece waveguide). As a result, red FOV 630 shifts in k-space to red FOV 631 and green FOV 632 shifts in k-space to green FOV 633. Diffraction in region 644 from gratings corresponding to grating vector k₃ results in outcoupling from the eyepiece waveguide. Blue light that is launched toward region 642 in CPE 640 and region 652 in CPE 650 impinges on gratings corresponding to grating vector k₁ in region 642 and region 652, thereby diffracting in the plane of the eyepiece waveguide. As a result, blue FOV 634 shifts in k-space to blue FOV 635. Diffraction in region 654 from gratings corresponding to grating vector k₂ results in outcoupling from the eyepiece waveguide. Accordingly, the diffraction pathway for red and green wavelengths, which indicates the minimal sequence of the interaction with different grating types as the incident light propagates from the projector to the user's eye, is k_{L}→k₂→k₃. The diffraction pathway for blue wavelengths is k_{H}→k₁→k₂.

As illustrated in FIGS. 6A and 6B, red FOV 630/631, green FOV 632/633, and blue FOV 634/635 are all positioned within the annular region between r=n=1 and r=n=2. Accordingly, propagation in the plane of the eyepiece waveguide as well as outcoupling are performed without clipping of the FOVs.

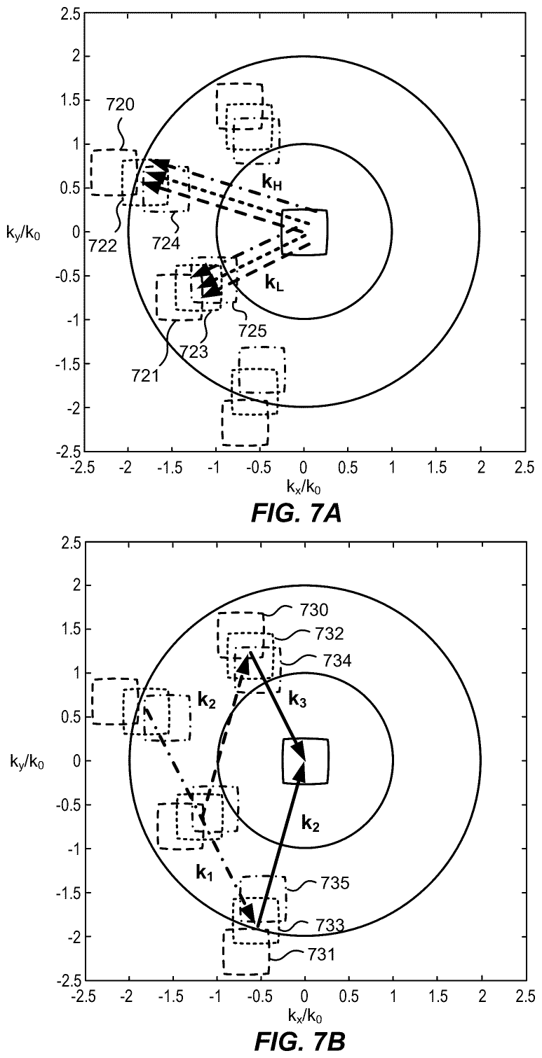

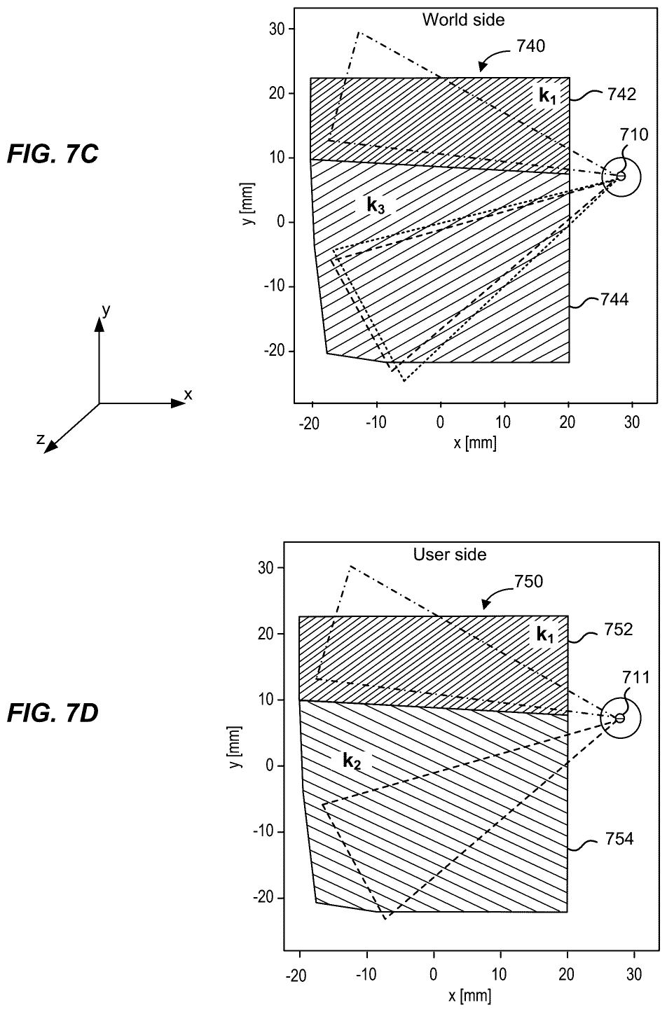

FIG. 7A is a simplified k-space diagram illustrating the field of view and ICG grating vectors for a second eyepiece waveguide with multi-directional launch according to an embodiment of the present invention. FIG. 7B is a simplified k-space diagram illustrating the field of view and CPE grating vectors for the second eyepiece waveguide with multi-directional launch according to an embodiment of the present invention. FIG. 7C is a simplified plan view of the world side of the second eyepiece waveguide with multi-directional launch according to an embodiment of the present invention. FIG. 7D is a simplified plan view of the user side of the second eyepiece waveguide with multi-directional launch illustrated in FIG. 7C.

Referring first to FIGS. 7C and 7D, this second eyepiece waveguide utilizes a multi-directional launch eyepiece waveguide design in which a single ICG pupil coupled to the world side of the eyepiece waveguide, illustrated as first ICG 710 in FIG. 7C, is utilized in conjunction with second ICG 711 coupled to the user side of the eyepiece waveguide as shown in FIG. 7D. Thus, light from the projector is coupled into the eyepiece waveguide using these two ICGs. In the illustrated embodiment, both ICGs are positioned at the same location in the x-y plane (also referred to as the lateral plane) and all wavelengths (e.g., red wavelengths, green wavelengths, and blue wavelengths) are launched from each ICG, with different wavelengths being launched in different directions.

In an embodiment, first ICG 710 and second ICG 711 are each implemented as a two-dimensional diffractive structure (e.g. a two-dimensional grating, nanostructure, etc.) that launches light in two directions represented by grating vectors k_{H} and k_{L}. In another embodiment, first ICG 710 launches light in a first direction (e.g., k_{H}) and second ICG 711 launches light in a second direction (e.g., k_{L}). Single ICG designs are particularly well suited to use with a micro-LED display in which the primary colors may not be easily separated spatially. Accordingly, light from a micro-LED display could be imaged into the single ICGs.

Referring to FIG. 7A, grating vector k_{H} represents diffraction by a larger distance (High) in k-space and grating vector k_{L} represents diffraction by a smaller distance (Low) in k-space. Thus, first ICG 710 coupled to the world side of the eyepiece waveguide and second ICG 711 coupled to the user side of the eyepiece waveguide will incouple light at multiple wavelengths and a first range of directions (corresponding to grating vector k_{H}) to produce red FOV 720, green FOV 722, and blue FOV 724 and at multiple wavelengths and a second range of directions (corresponding to grating vector k_{L}) to produce red FOV 721, green FOV 723, and blue FOV 725 (to the extent portions or all of these FOVs are supported by the eyepiece waveguide). Referring to FIG. 7A, blue FOV 724, green FOV 723, and red FOV 721 are positioned within the annular region between r=n=1 and r=n=2. Red FOV 720, green FOV 722, and blue FOV 725 include a portion positioned within the annular region between r=n=1 and r=n=2. It should be noted, that a change in the index of refraction of the eyepiece waveguide material (e.g., an index of refraction fraction of 2.5) will result in the amount of the FOV included in the annular region changing.

Referring to FIG. 7B, light present in red FOV 720, green FOV 722, and blue FOV 724 is diffracted in region 742 of CPE 740 coupled to the world side and region 752 of CPE 750 coupled to the use side and impinges on gratings corresponding to grating vector k₁, thereby diffracting in the plane of the eyepiece waveguide. As a result, red FOV 720 shifts in k-space to red FOV 731, green FOV 722 shifts in k-space to green FOV 733, and blue FOV 724 shifts in k-space to blue FOV 735. Diffraction in region 754 of CPE 750 from gratings corresponding to grating vector k₂ results in outcoupling from the eyepiece waveguide. Light present in red FOV 721, green FOV 723, and blue FOV 724 is diffracted in region 754 of CPE 750 coupled to the user side and impinges on gratings corresponding to grating vector k₂, thereby diffracting in the plane of the eyepiece waveguide. As a result, red FOV 721 shifts in k-space to red FOV 730, green FOV 723 shifts in k-space to green FOV 732, and blue FOV 725 shifts in k-space to blue FOV 734. Diffraction in region 744 of CPE 740 from gratings corresponding to grating vector k₃ results in outcoupling from the eyepiece waveguide.

Accordingly, the diffraction pathway for red, green, and blue wavelengths incoupled by first ICG 710 and second ICG 711 in the direction represented by grating vector k_{H}, which indicates the minimal sequence of the interaction with different grating types as the incident light propagates from the projector to the user's eye, is k_{H}→k₁→k₂. The diffraction pathway for red, green, and blue wavelengths incoupled by first ICG 710 and second ICG 711 in the direction represented by grating vector k_{L} is k_{L}→k₂→k₃.

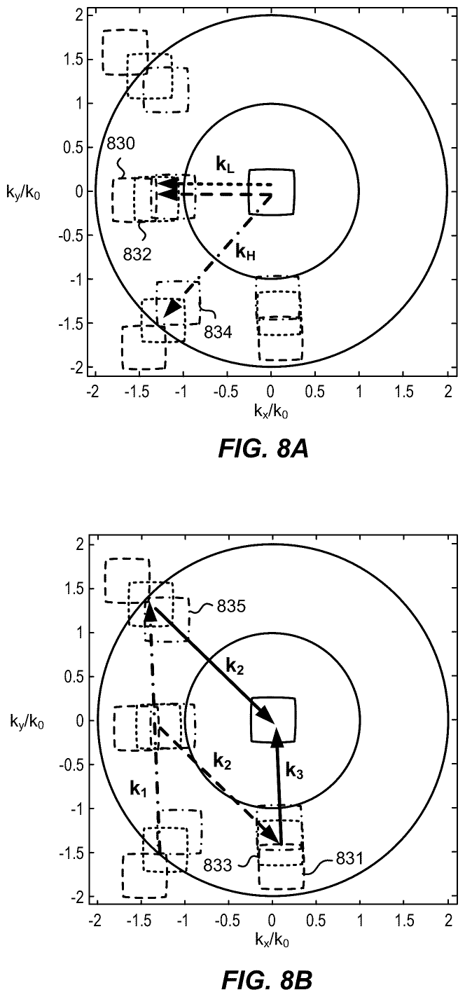

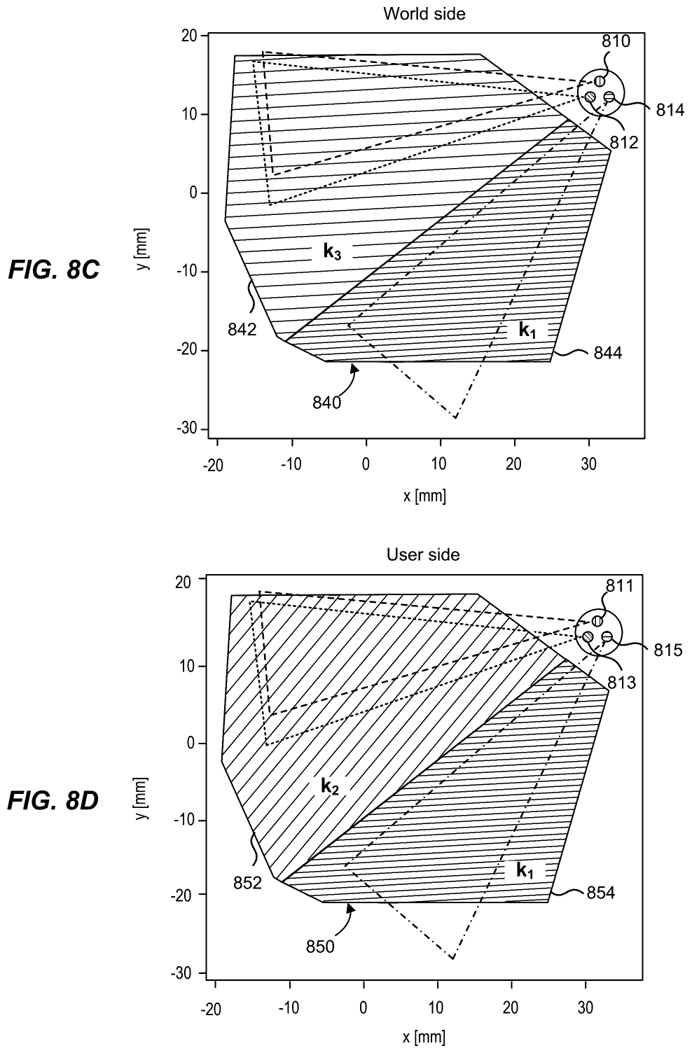

FIG. 8A is a simplified k-space diagram illustrating the field of view and ICG grating vectors for a third eyepiece waveguide with multi-directional launch according to an embodiment of the present invention. FIG. 8B is a simplified k-space diagram illustrating the field of view and CPE grating vectors for the third eyepiece waveguide with multi-directional launch according to an embodiment of the present invention. FIG. 8C is a simplified plan view of the world side of the third eyepiece waveguide with multi-directional launch according to an embodiment of the present invention. FIG. 8D is a simplified plan view of the user side of the third eyepiece waveguide with multi-directional launch illustrated in FIG. 8C.

Referring first to FIGS. 8C and 8D, this third eyepiece waveguide utilizes a multi-directional launch eyepiece waveguide design in which separate ICG pupils coupled to the world side of the eyepiece waveguide, illustrated as red ICG 810, green ICG 812, and blue ICG 814 in FIG. 8C, are utilized in conjunction with red ICG 811, green ICG 813, and blue ICG 815 coupled to the user side of the eyepiece waveguide as shown in FIG. 8D. Thus, light from the projector is coupled into the eyepiece waveguide using these six ICGs. However, as discussed more fully below, the grating periodicity for the various ICGs and the corresponding grating vectors, which are designed with respect to a green wavelength, are different for blue light (and the blue ICGs) as compared to red and green light (and the red and green ICGs). Although the embodiment illustrated in FIG. 8D includes red ICG 811, green ICG 813, and blue ICG 815 coupled to the user side of the eyepiece waveguide, this is not required and, in some embodiments, red ICG 811, green ICG 813, and blue ICG 815 are optional.

Referring to FIG. 8A, grating vector k_{H} represents diffraction by a larger distance (High) in k-space and grating vector k_{L} represents diffraction by a smaller distance (Low) in k-space. Thus, the gratings corresponding to grating vector k_{L} are characterized by a same grating dimension (i.e., the same grating periodicity, for example 525 nm/˜1.5≈350 nm) while the gratings corresponding to grating vector k are characterized by a larger grating dimension (i.e., a smaller grating periodicity, for example 525 nm/˜1.9≈276 nm). Thus, for red ICG 810 and green ICG 812 coupled to the world side of the eyepiece waveguide or red ICG 811 and green ICG 813 coupled to the user side of the eyepiece waveguide, light at the center of the FOV is diffracted into the eyepiece waveguide as represented by grating vector k_{L} to produce red FOV 830 for red wavelengths and green FOV 832 for green wavelengths. Both of these FOVs are positioned within the annular region between r=n=1 and r=n=2. Light diffracted into the eyepiece waveguide using blue ICG 814 coupled to the world side of the eyepiece waveguide or blue ICG 815 coupled to the user side of the eyepiece waveguide diffracts as represented by k_{H}. Thus, for blue ICG 814 coupled to the world side and blue ICG 815 coupled to the user side of the eyepiece waveguide, light at the center of the FOV is diffracted into the eyepiece waveguide to produce blue FOV 834 for blue wavelengths. This FOV is positioned within the annular region between r=n=1 and r=n=2. Accordingly, this wavelength-specific, multi-directional launch architecture enables a full 30°×30° FOV because the respective barrel-shaped boxes corresponding to red FOV 830, green FOV 832, and blue FOV 834, which correspond to TIR light, lie entirely within the annular region.

Referring to FIG. 8C, the orientation of the gratings in red ICG 810 and green ICG 812, as well as red ICG 811 and green ICG 813, are oriented such that red and green light is launched into the eyepiece waveguide toward region 842 of the CPE 840 on the world side and toward region 852 of the CPE 850 on the user side. The orientation of the gratings in blue ICG 814 and blue ICG 815 are oriented such that blue light is launched into the eyepiece waveguide toward region 844 of the CPE 840 on the world side and toward region 854 of the CPE 850 on the user side.

Referring to FIGS. 8B and 8D, red and green light that is launched toward region 852 of CPE 850 impinges on gratings corresponding to grating vector k₂, thereby diffracting in the plane of the eyepiece waveguide. As a result, red FOV 830 shifts in k-space to red FOV 831 and green FOV 832 shifts in k-space to green FOV 833. Diffraction in region 842 from gratings corresponding to grating vector k₃ results in outcoupling from the eyepiece waveguide. Blue light that is launched toward region 844 in CPE 840 and region 854 in CPE 850 impinges on gratings corresponding to grating vector k₁ in region 844 and region 854, thereby diffracting in the plane of the eyepiece waveguide. As a result, blue FOV 834 shifts in k-space to blue FOV 835. Diffraction in region 852 from gratings corresponding to grating vector k₂ results in outcoupling from the eyepiece waveguide. Accordingly, the diffraction pathway for red and green wavelengths, which indicates the minimal sequence of the interaction with different grating types as the incident light propagates from the projector to the user's eye, is k_{L}→k₂→k₃. The diffraction pathway for blue wavelengths is k_{H}→k₁→k₂. It should also be noted that region 844 and region 854 of the CPE have the same gratings and either one or both of them can be used in this multi-directional launch architecture. When only one of them is present, i.e., either 854 or 844, the CPE on the opposite side will have extended grating region 842 or 852 respectively.

As illustrated in FIGS. 8A and 8B, red FOV 830/831, green FOV 832/833, and blue FOV 834/835 are all positioned within the annular region between r=n=1 and r=n=2. Accordingly, propagation in the plane of the eyepiece waveguide as well as outcoupling are performed without clipping of the FOVs.

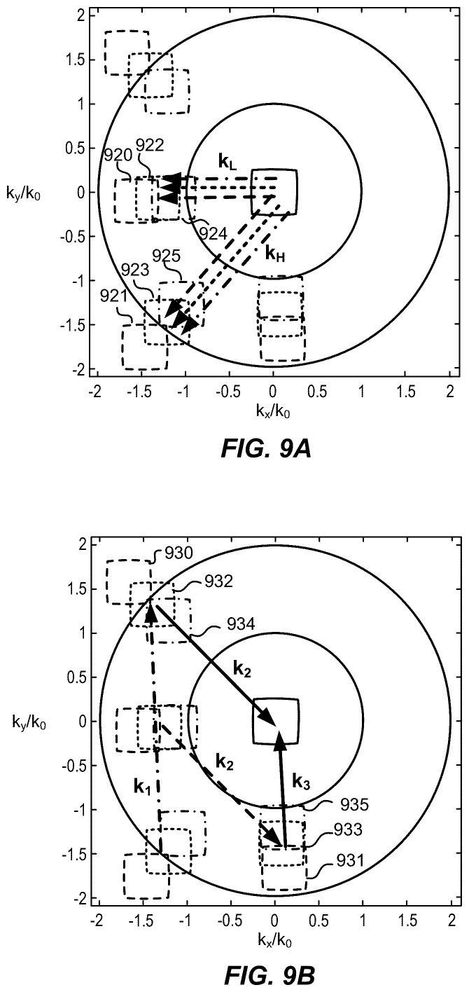

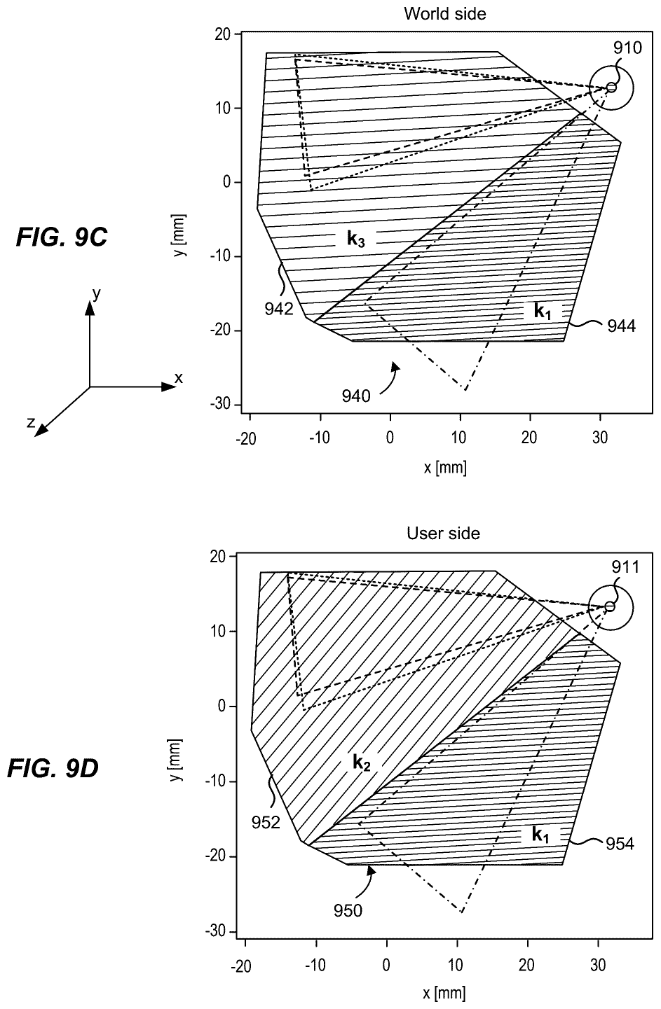

FIG. 9A is a simplified k-space diagram illustrating the field of view and ICG grating vectors for a fourth eyepiece waveguide with multi-directional launch according to an embodiment of the present invention. FIG. 9B is a simplified k-space diagram illustrating the field of view and CPE grating vectors for the fourth eyepiece waveguide with multi-directional launch according to an embodiment of the present invention. FIG. 9C is a simplified plan view of the world side of the fourth eyepiece waveguide with multi-directional launch according to an embodiment of the present invention. FIG. 9D is a simplified plan view of the user side of the fourth eyepiece waveguide with multi-directional launch illustrated in FIG. 9C.

Referring first to FIGS. 9C and 9D, this fourth eyepiece waveguide utilizes a multi-directional launch eyepiece waveguide design in which a single ICG pupil coupled to the world side of the eyepiece waveguide, illustrated as first ICG 910 in FIG. 9C, is utilized in conjunction with second ICG 911 coupled to the user side of the eyepiece waveguide as shown in FIG. 9D. Thus, light from the projector is coupled into the eyepiece waveguide using these two ICGs. In the illustrated embodiment, both ICGs are positioned at the same location in the x-y plane and all wavelengths (e.g., red wavelengths, green wavelengths, and blue wavelengths) are launched from each ICG, with different wavelengths being launched in different directions.

In an embodiment, first ICG 910 and second ICG 911 are each implemented as a two-dimensional diffractive structure (e.g. a two-dimensional grating, nanostructure, etc.) that launches light in two directions represented by grating vectors k_{H} and k_{L}. In another embodiment, first ICG 910 launches light in a first direction (e.g., k_{H}) and second ICG 911 launches light in a second direction (e.g., k_{L}). Single ICG designs are particularly well suited to use with a micro-LED display in which the primary colors may not be easily separated spatially. Accordingly, light from a micro-LED display could be imaged into the single ICGs.

Referring to FIG. 9A, grating vector k_{H} represents diffraction by a larger distance (High) in k-space and grating vector k_{L} represents diffraction by a smaller distance (Low) in k-space. Thus, first ICG 910 coupled to the world side of the eyepiece waveguide and second ICG 911 coupled to the user side of the eyepiece waveguide will incouple light at multiple wavelengths and a first range of directions (corresponding to grating vector k_{H}) to produce red FOV 920, green FOV 922, and blue FOV 924 and at multiple wavelengths and a second range of directions (corresponding to grating vector k_{L}) to produce red FOV 921, green FOV 923, and blue FOV 925 (to the extent portions or all of these FOVs are supported by the eyepiece waveguide). Referring to FIG. 9A, blue FOV 925, green FOV 922, and red FOV 920 are positioned within the annular region between r=n=1 and r=n=2. Red FOV 921, green FOV 923, and blue FOV 924 include a portion positioned within the annular region between r=n=1 and r=n=2. It should be noted, that a change in the index of refraction of the eyepiece waveguide material (e.g., an index of refraction fraction of 2.5) will result in the amount of the FOV included in the annular region changing.

Referring to FIG. 9B, light present in red FOV 920, green FOV 922, and blue FOV 924 is diffracted in region 952 of CPE 950 coupled to the user side and impinges on gratings corresponding to grating vector k₂, thereby diffracting in the plane of the eyepiece waveguide. As a result, red FOV 920 shifts in k-space to red FOV 931, green FOV 922 shifts in k-space to green FOV 933, and blue FOV 924 shifts in k-space to blue FOV 935. Diffraction in region 942 of CPE 940 from gratings corresponding to grating vector k₃ results in outcoupling from the eyepiece waveguide. Light present in red FOV 921, green FOV 923, and blue FOV 925 is diffracted in region 944 of CPE 940 coupled to the world side and region 954 of CPE 950 coupled to the user side and impinges on gratings corresponding to grating vector k₁, thereby diffracting in the plane of the eyepiece waveguide. As a result, red FOV 921 shifts in k-space to red FOV 930, green FOV 923 shifts in k-space to green FOV 932, and blue FOV 924 shifts in k-space to blue FOV 934. Diffraction in region 942 of CPE 940 from gratings corresponding to grating vector k₂ results in outcoupling from the eyepiece waveguide.

Accordingly, the diffraction pathway for red, green, and blue wavelengths incoupled by first ICG 910 and second ICG 911 in the direction represented by grating vector k_{L}, which indicates the minimal sequence of the interaction with different grating types as the incident light propagates from the projector to the user's eye, is k_{L}→k₁→k₂. The diffraction pathway for red, green, and blue wavelengths incoupled by first ICG 910 and second ICG 911 in the direction represented by grating vector k_{H} is k_{H}→k₂→k₃. Similar to the previous design, one of the grating regions, e.g., region 944 or region 954, can be considered optional and be replaced by the grating region on the respective world or user-side of the eyepiece waveguide.

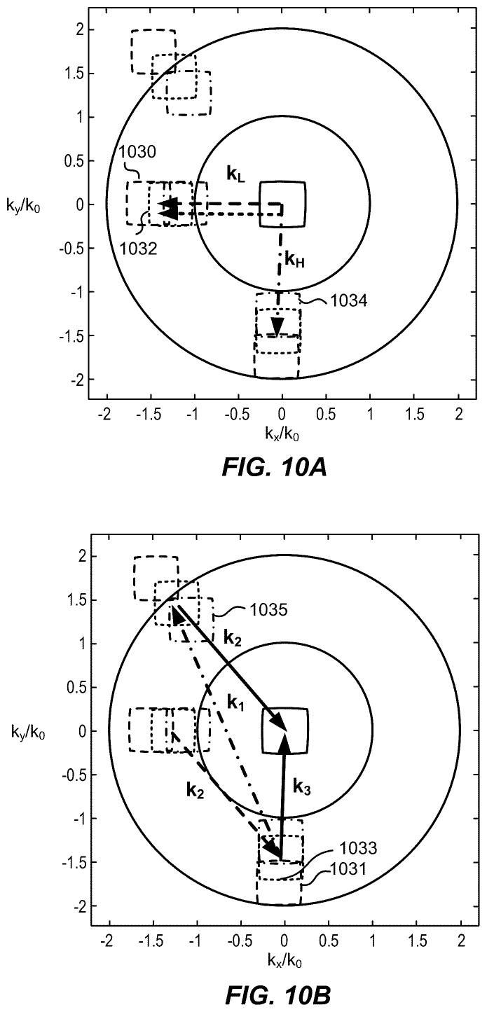

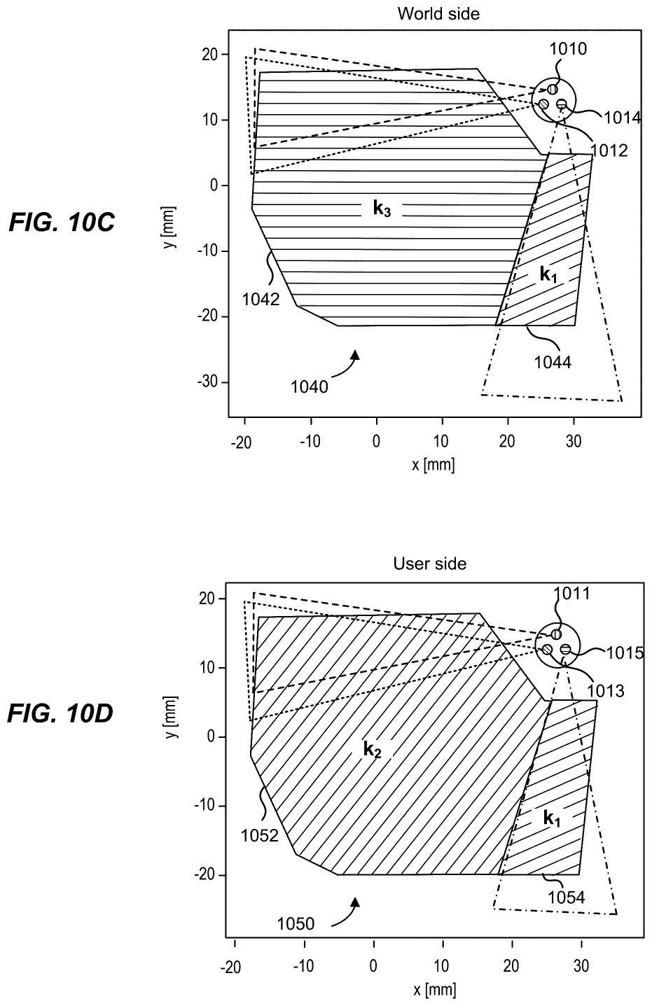

FIG. 10A is a simplified k-space diagram illustrating the field of view and ICG grating vectors for a fifth eyepiece waveguide with multi-directional launch according to an embodiment of the present invention. FIG. 10B is a simplified k-space diagram illustrating the field of view and CPE grating vectors for the fifth eyepiece waveguide with multi-directional launch according to an embodiment of the present invention. FIG. 10C is a simplified plan view of the world side of the fifth eyepiece waveguide with multi-directional launch according to an embodiment of the present invention. FIG. 10D is a simplified plan view of the user side of the fifth eyepiece waveguide with multi-directional launch illustrated in FIG. 10C.

Referring first to FIGS. 10C and 10D, this fifth eyepiece waveguide utilizes a multi-directional launch eyepiece waveguide design in which separate ICG pupils coupled to the world side of the eyepiece waveguide, illustrated as red ICG 1010, green ICG 1012, and blue ICG 1014 in FIG. 10C, are utilized in conjunction with red ICG 1011, green ICG 1013, and blue ICG 1015 coupled to the user side of the eyepiece waveguide as shown in FIG. 10D. Thus, light from the projector is coupled into the eyepiece waveguide using these six ICGs. However, as discussed more fully below, the grating periodicity for the various ICGs and the corresponding grating vectors, which are designed with respect to a green wavelength, are different for blue light (and the blue ICGs) as compared to red and green light (and the red and green ICGs). Although the embodiment illustrated in FIG. 10D includes red ICG 1011, green ICG 1013, and blue ICG 1015 coupled to the user side of the eyepiece waveguide, this is not required and, in some embodiments, red ICG 1011, green ICG 1013, and blue ICG 1015 are optional.

Referring to FIG. 10A, grating vector k_{H} represents diffraction by a larger distance (High) in k-space and grating vector k_{L} represents diffraction by a smaller distance (Low) in k-space. Thus, the gratings corresponding to grating vector k_{L} are characterized by a same grating dimension (i.e., the same grating periodicity, for example 525 nm/˜1.5≈350 nm) while the gratings corresponding to grating vector k_{H} are characterized by a larger grating dimension (i.e., a smaller grating periodicity, for example 525 nm/˜1.9≈276 nm). Thus, for red ICG 1010 and green ICG 1012 coupled to the world side of the eyepiece waveguide or red ICG 1011 and green ICG 1013 coupled to the user side of the eyepiece waveguide, light at the center of the FOV is diffracted into the eyepiece waveguide as represented by grating vector k_{L} to produce red FOV 1030 for red wavelengths and green FOV 1032 for green wavelengths. Both of these FOVs are positioned within the annular region between r=n=1 and r=n=2. Light diffracted into the eyepiece waveguide using blue ICG 1014 coupled to the world side of the eyepiece waveguide or blue ICG 1015 coupled to the user side of the eyepiece waveguide diffracts as represented by K_{H}. Thus, for blue ICG 1014 coupled to the world side and blue ICG 1015 coupled to the user side of the eyepiece waveguide, light at the center of the FOV is diffracted into the eyepiece waveguide to produce blue FOV 1034 for blue wavelengths. This FOV is positioned within the annular region between r=n=1 and r=n=2. Accordingly, this wavelength-specific, multi-directional launch architecture enables a full 30°×30° FOV because the respective barrel-shaped boxes corresponding to red FOV 1030, green FOV 1032, and blue FOV 1034, which correspond to TIR light, lie entirely within the annular region.

Referring to FIG. 10C, the orientation of the gratings in red ICG 1010 and green ICG 1012, as well as red ICG 1011 and green ICG 1013, are oriented such that red and green light is launched into the eyepiece waveguide toward region 1042 of the CPE 1040 on the world side and toward region 1052 of the CPE 1050 on the user side. The orientation of the gratings in blue ICG 1014 and blue ICG 1015 are oriented such that blue light is launched into the eyepiece waveguide toward region 1044 of the CPE 1040 on the world side and toward region 1054 of the CPE 1050 on the user side.

Referring to FIGS. 10B and 10D, red and green light that is launched toward region 1052 of CPE 1050 impinges on gratings corresponding to grating vector k₂, thereby diffracting in the plane of the eyepiece waveguide. As a result, red FOV 1030 shifts in k-space to red FOV 1031 and green FOV 1032 shifts in k-space to green FOV 1033. Diffraction in region 1042 from gratings corresponding to grating vector k₃ results in outcoupling from the eyepiece waveguide. Blue light that is launched toward region 1044 in CPE 1040 and region 1054 in CPE 1050 impinges on gratings corresponding to grating vector k₁ in region 1044 and region 1054, thereby diffracting in the plane of the eyepiece waveguide. As a result, blue FOV 1034 shifts in k-space to blue FOV 1035. Diffraction in region 1052 from gratings corresponding to grating vector k₂ results in outcoupling from the eyepiece waveguide. Accordingly, the diffraction pathway for red and green wavelengths, which indicates the minimal sequence of the interaction with different grating types as the incident light propagates from the projector to the user's eye, is k_{L}→k₂→k₃. The diffraction pathway for blue wavelengths is k_{H}→k₁→k₂.

As illustrated in FIGS. 10A and 10B, red FOV 1030/1031, green FOV 1032/1033, and blue FOV 1034/1035 are all positioned within the annular region between r=n=1 and r=n=2. Accordingly, propagation in the plane of the eyepiece waveguide as well as outcoupling are performed without clipping of the FOVs.

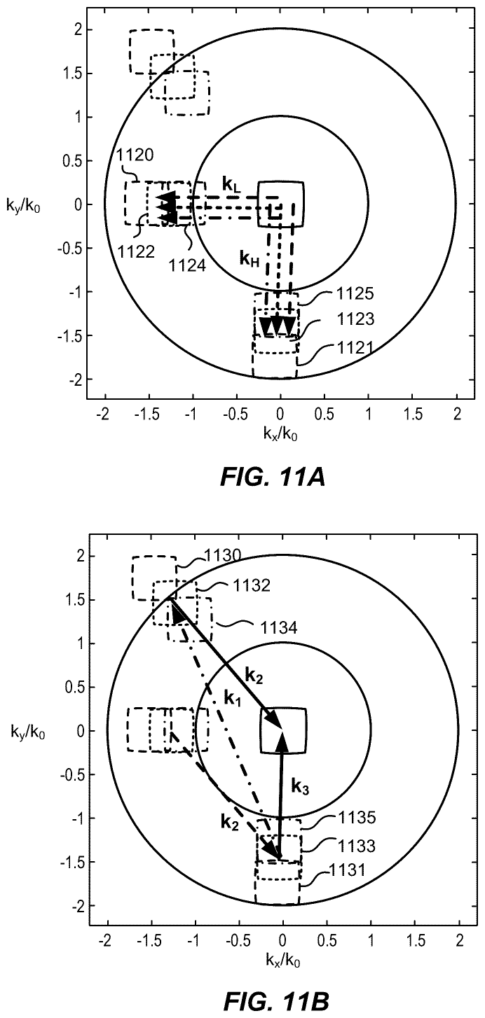

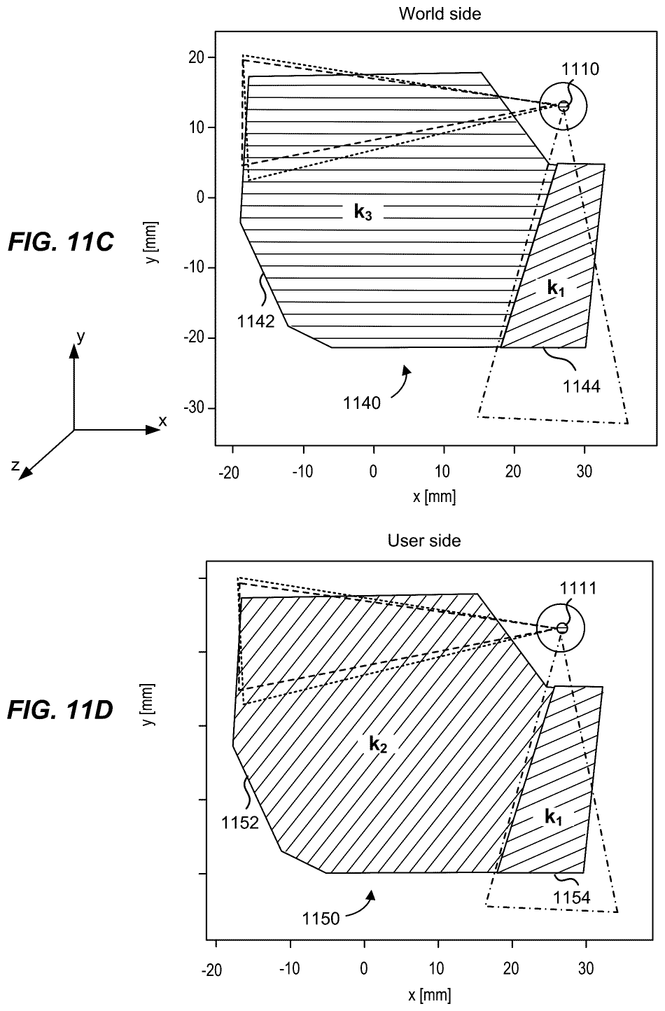

FIG. 11A is a simplified k-space diagram illustrating the field of view and ICG grating vectors for a sixth eyepiece waveguide with multi-directional launch according to an embodiment of the present invention. FIG. 11B is a simplified k-space diagram illustrating the field of view and CPE grating vectors for the sixth eyepiece waveguide with multi-directional launch according to an embodiment of the present invention. FIG. 11C is a simplified plan view of the world side of the sixth eyepiece waveguide with multi-directional launch according to an embodiment of the present invention. FIG. 11D is a simplified plan view of the user side of the sixth eyepiece waveguide with multi-directional launch illustrated in FIG. 11C.

Referring first to FIGS. 11C and 11D, this sixth eyepiece waveguide utilizes a multi-directional launch eyepiece waveguide design in which a single ICG pupil coupled to the world side of the eyepiece waveguide, illustrated as first ICG 1110 in FIG. 11C, is utilized in conjunction with second ICG 1111 coupled to the user side of the eyepiece waveguide as shown in FIG. 11D. Thus, light from the projector is coupled into the eyepiece waveguide using these two ICGs. In the illustrated embodiment, both ICGs are positioned at the same location in the x-y plane and all wavelengths (e.g., red wavelengths, green wavelengths, and blue wavelengths) are launched from each ICG, with different wavelengths being launched in different directions.

In an embodiment, first ICG 1110 and second ICG 1111 are each implemented as a two-dimensional diffractive structure (e.g. a two-dimensional grating, nanostructure, etc.) that launches light in two directions represented by grating vectors k_{H} and k_{L}. In another embodiment, first ICG 1110 launches light in a first direction (e.g., k_{H}) and second ICG 1111 launches light in a second direction (e.g., k_{L}). Single ICG designs are particularly well suited to use with a micro-LED display in which the primary colors may not be easily separated spatially. Accordingly, light from a micro-LED display could be imaged into the single ICGs.

Referring to FIG. 11A, grating vector k_{H} represents diffraction by a larger distance (High) in k-space and grating vector k represents diffraction by a smaller distance (Low) in k-space. Thus, first ICG 1110 coupled to the world side of the eyepiece waveguide and second ICG 1111 coupled to the user side of the eyepiece waveguide will incouple light at multiple wavelengths and a first range of directions (corresponding to grating vector k_{H}) to produce red FOV 1120, green FOV 1122, and blue FOV 1124 and at multiple wavelengths and a second range of directions (corresponding to grating vector k_{L}) to produce red FOV 1121, green FOV 1123, and blue FOV 1125 (to the extent portions or all of these FOVs are supported by the eyepiece waveguide). Referring to FIG. 11A, blue FOV 1125, green FOV 1123, green FOV 1122, and red FOV 1120 are positioned within the annular region between r=n=1 and r=n=2. Red FOV 1121 and blue FOV 1124 include a portion positioned within the annular region between r=n=1 and r=n=2. It should be noted, that a change in the index of refraction of the eyepiece waveguide material (e.g., an index of refraction fraction of 2.5) will result in the amount of the FOV included in the annular region changing.

Referring to FIG. 11B, light present in red FOV 1120, green FOV 1122, and blue FOV 1124 is diffracted in region 1152 of CPE 1150 coupled to the user side and impinges on gratings corresponding to grating vector k₂, thereby diffracting in the plane of the eyepiece waveguide. As a result, red FOV 1120 shifts in k-space to red FOV 1131, green FOV 1122 shifts in k-space to green FOV 1133, and blue FOV 1124 shifts in k-space to blue FOV 1135. Diffraction in region 1142 of CPE 1140 from gratings corresponding to grating vector k₃ results in outcoupling from the eyepiece waveguide. Light present in red FOV 1121, green FOV 1123, and blue FOV 1125 is diffracted in region 1144 of CPE 1140 coupled to the world side and region 1154 of CPE 1150 coupled to the user side and impinges on gratings corresponding to grating vector k₁, thereby diffracting in the plane of the eyepiece waveguide. As a result, red FOV 1121 shifts in k-space to red FOV 1130, green FOV 1123 shifts in k-space to green FOV 1132, and blue FOV 1125 shifts in k-space to blue FOV 1134. Diffraction in region 1152 of CPE 1150 from gratings corresponding to grating vector k₂ results in outcoupling from the eyepiece waveguide.

Accordingly, the diffraction pathway for red, green, and blue wavelengths incoupled by first ICG 1110 and second ICG 1111 in the direction represented by grating vector k_{L}, which indicates the minimal sequence of the interaction with different grating types as the incident light propagates from the projector to the user's eye, is k_{L}→k₁→k₂. The diffraction pathway for red, green, and blue wavelengths incoupled by first ICG 1110 and second ICG 1111 in the direction represented by grating vector k_{H} is k_{H}→k₂→k₃.

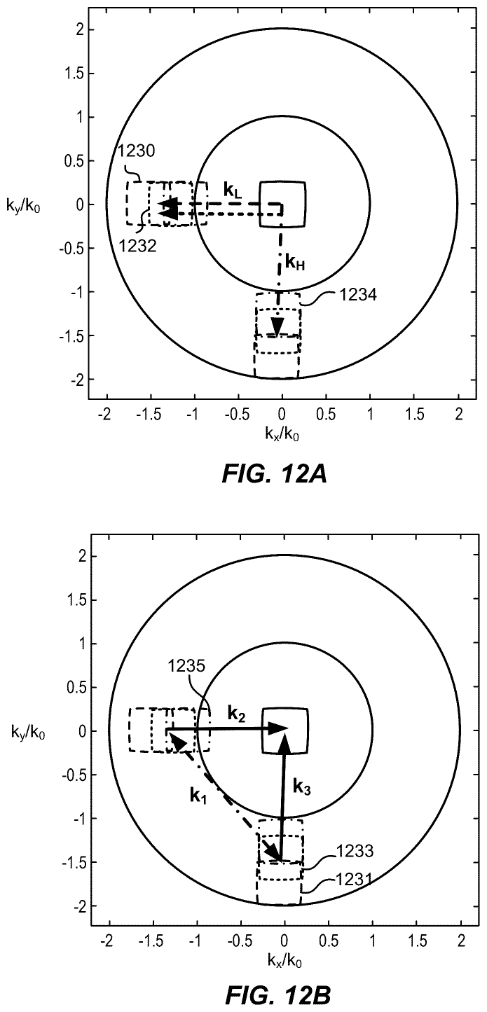

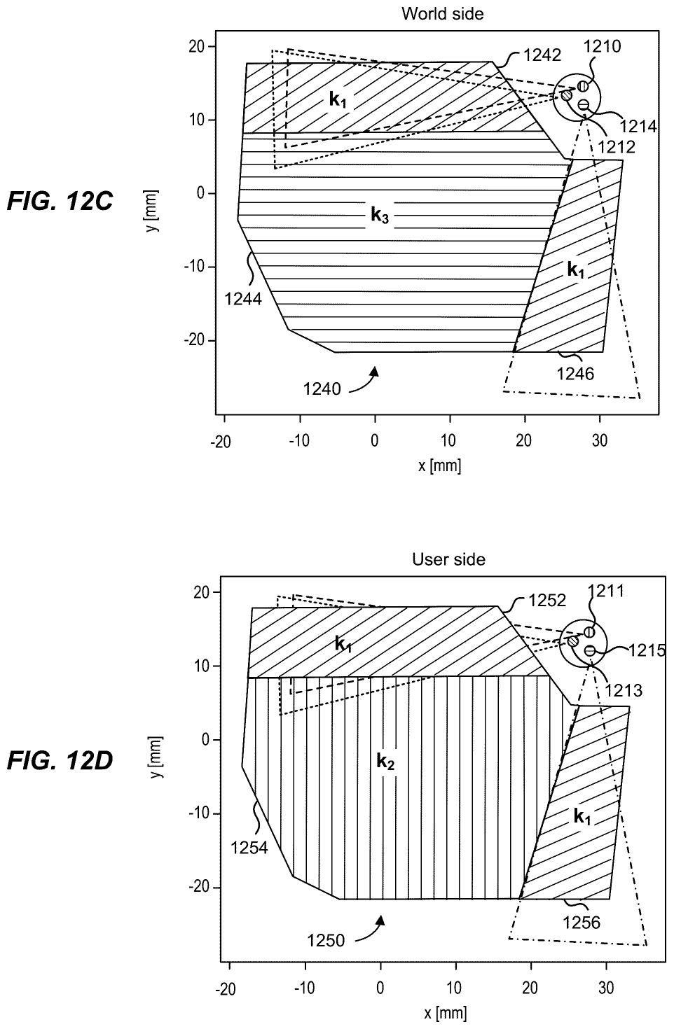

FIG. 12A is a simplified k-space diagram illustrating the field of view and ICG grating vectors for a seventh eyepiece waveguide with multi-directional launch according to an embodiment of the present invention. FIG. 12B is a simplified k-space diagram illustrating the field of view and CPE grating vectors for the seventh eyepiece waveguide with multi-directional launch according to an embodiment of the present invention. FIG. 12C is a simplified plan view of the world side of the seventh eyepiece waveguide with multi-directional launch according to an embodiment of the present invention. FIG. 12D is a simplified plan view of the user side of the seventh eyepiece waveguide with multi-directional launch illustrated in FIG. 12C.

Referring first to FIGS. 12C and 12D, this seventh eyepiece waveguide utilizes a multi-directional launch eyepiece waveguide design in which separate ICG pupils coupled to the world side of the eyepiece waveguide, illustrated as red ICG 1210, green ICG 1212, and blue ICG 1214 in FIG. 12C, are utilized in conjunction with red ICG 1211, green ICG 1213, and blue ICG 1215 coupled to the user side of the eyepiece waveguide as shown in FIG. 12D. Thus, light from the projector is coupled into the eyepiece waveguide using these six ICGs. However, as discussed more fully below, the grating periodicity for the various ICGs and the corresponding grating vectors, which are designed with respect to a green wavelength, are equal for blue light (and the blue ICGs) as compared to red and green light (and the red and green ICGs). Although the embodiment illustrated in FIG. 12D includes red ICG 1211, green ICG 1213, and blue ICG 1215 coupled to the user side of the eyepiece waveguide, this is not required and, in some embodiments, red ICG 1211, green ICG 1213, and blue ICG 1215 are optional.

Referring to FIG. 12A, grating vector k_{H} represents diffraction by a first distance in k-space and grating vector k_{L} represents diffraction by a second distance in k-space. Thus, for red ICG 1210 and green ICG 1212 coupled to the world side of the eyepiece waveguide or red ICG 1211 and green ICG 1213 coupled to the user side of the eyepiece waveguide, light at the center of the FOV is diffracted into the eyepiece waveguide as represented by grating vector k_{L} to produce red FOV 1230 for red wavelengths and green FOV 1232 for green wavelengths. Both of these FOVs are positioned within the annular region between r=n=1 and r=n=2. Light diffracted into the eyepiece waveguide using blue ICG 1214 coupled to the world side of the eyepiece waveguide or blue ICG 1215 coupled to the user side of the eyepiece waveguide diffracts as represented by k_{H}. Thus, for blue ICG 1214 coupled to the world side and blue ICG 1215 coupled to the user side of the eyepiece waveguide, light at the center of the FOV is diffracted into the eyepiece waveguide to produce blue FOV 1234 for blue wavelengths. This FOV is positioned within the annular region between r=n=1 and r=n=2. Accordingly, this wavelength-specific, multi-directional launch architecture enables a full 30°×30° FOV because the respective barrel-shaped boxes corresponding to red FOV 1230, green FOV 1232, and blue FOV 1234, which correspond to TIR light, lie entirely within the annular region.

Referring to FIG. 12C, the orientation of the gratings in red ICG 1210 and green ICG 1212, as well as red ICG 1211 and green ICG 1213, are oriented such that red and green light is launched into the eyepiece waveguide toward region 1242 of the CPE 1240 on the world side and toward region 1252 of the CPE 1250 on the user side. The orientation of the gratings in blue ICG 1214 and blue ICG 1215 are oriented such that blue light is launched into the eyepiece waveguide toward region 1246 of the CPE 1240 on the world side and toward region 1256 of the CPE 1250 on the user side. In comparison with the eyepiece waveguide layout illustrated in FIGS. 10C and 10D, region 1242, region 1246, region 1252, and region 1256 have gratings corresponding to grating vector k₁. Region 1244, which has gratings corresponding to grating vector k₃, is disposed between region 1242 and region 1246 and region 1254, which has gratings corresponding to grating vector k₂, is disposed between region 1252 and region 1256.

Referring to FIGS. 12B and 12D, red and green light that is launched toward region 1242 of CPE 1240 and region 1252 of CPE 1250 impinges on gratings corresponding to grating vector k₁, thereby diffracting in the plane of the eyepiece waveguide. As a result, red FOV 1230 shifts in k-space to red FOV 1231 and green FOV 1232 shifts in k-space to green FOV 1233. Diffraction in region 1244 of CPE 1240 from gratings corresponding to grating vector k₃ results in outcoupling from the eyepiece waveguide. Blue light that is launched toward region 1246 in CPE 1240 and region 1256 in CPE 1250 impinges on gratings corresponding to grating vector k₁ in region 1246 and region 1256, thereby diffracting in the plane of the eyepiece waveguide. As a result, blue FOV 1234 shifts in k-space to blue FOV 1235. Diffraction in region 1254 of CPE 1250 from gratings corresponding to grating vector k₂ results in outcoupling from the eyepiece waveguide. Accordingly, the diffraction pathway for red and green wavelengths, which indicates the minimal sequence of the interaction with different grating types as the incident light propagates from the projector to the user's eye, is k_{L}→k₁→k₃. The diffraction pathway for blue wavelengths is k_{H}→k₁→k₂.

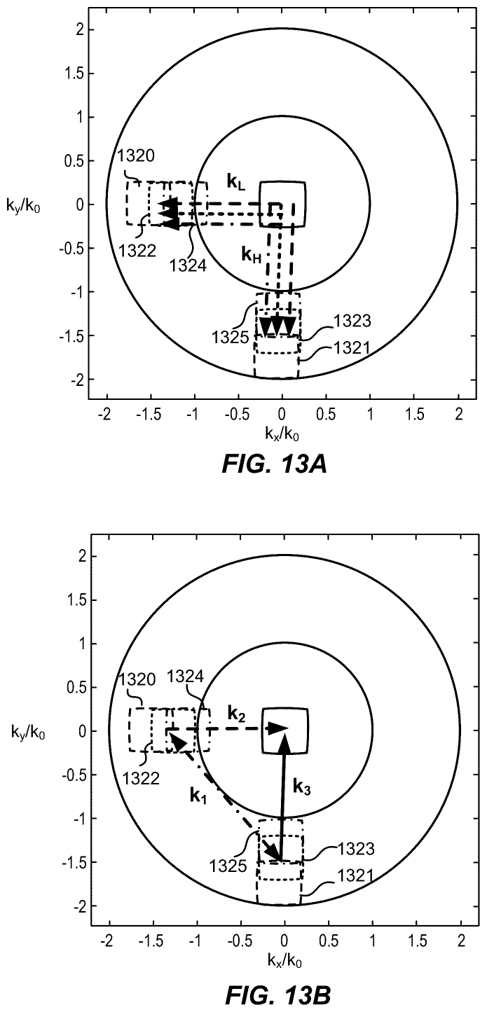

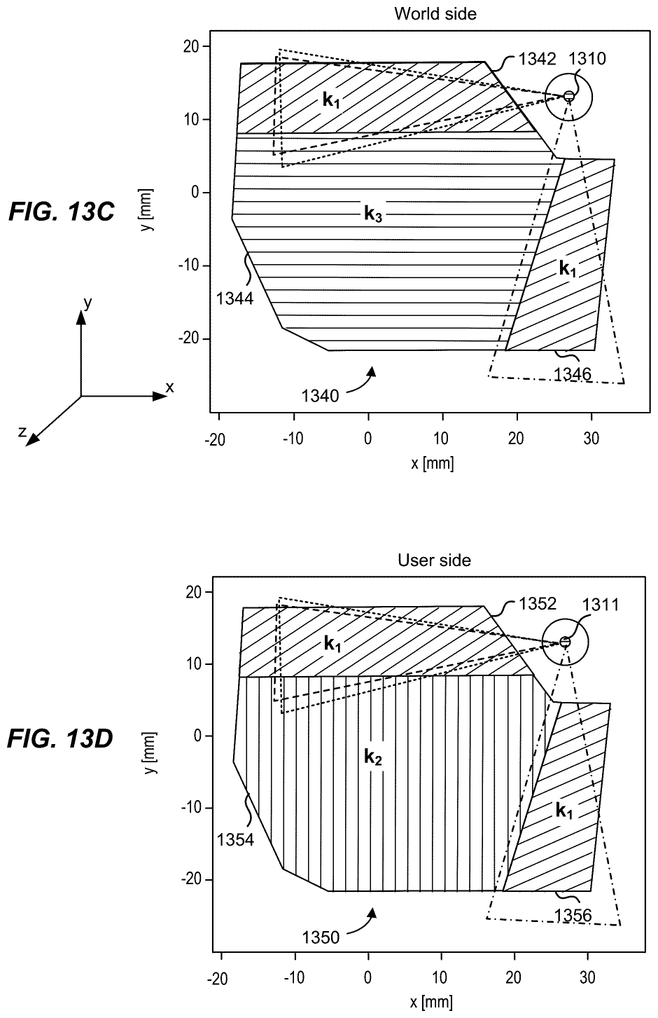

FIG. 13A is a simplified k-space diagram illustrating the field of view and ICG grating vectors for an eighth eyepiece waveguide with multi-directional launch according to an embodiment of the present invention. FIG. 13B is a simplified k-space diagram illustrating the field of view and CPE grating vectors for the eighth eyepiece waveguide with multi-directional launch according to an embodiment of the present invention. FIG. 13C is a simplified plan view of the world side of the eighth eyepiece waveguide with multi-directional launch according to an embodiment of the present invention. FIG. 13D is a simplified plan view of the user side of the eighth eyepiece waveguide with multi-directional launch illustrated in FIG. 13C.

Referring first to FIGS. 13C and 13D, this eighth eyepiece waveguide utilizes a multi-directional launch eyepiece waveguide design in which a single ICG pupil coupled to the world side of the eyepiece waveguide, illustrated as first ICG 1310 in FIG. 13C, is utilized in conjunction with second ICG 1311 coupled to the user side of the eyepiece waveguide as shown in FIG. 13D. Thus, light from the projector is coupled into the eyepiece waveguide using these two ICGs. In the illustrated embodiment, both ICGs are positioned at the same location in the x-y plane and all wavelengths (e.g., red wavelengths, green wavelengths, and blue wavelengths) are launched from each ICG, with different wavelengths being launched in different directions. Similar to the eyepiece waveguide layout illustrated in FIGS. 12C and 12D, region 1342, region 1346, region 1352, and region 1356 have gratings corresponding to grating vector k₁. Region 1344, which has gratings corresponding to grating vector k₃, is disposed between region 1342 and region 1346 and region 1354, which has gratings corresponding to grating vector k₂, is disposed between region 1352 and region 1356.

In an embodiment, first ICG 1310 and second ICG 1311 are each implemented as a two-dimensional diffractive structure (e.g. a two-dimensional grating, nanostructure, etc.) that launches light in two directions represented by grating vectors k_{H} and k_{L}. In another embodiment, first ICG 1310 launches light in a first direction (e.g., k_{H}) and second ICG 1311 launches light in a second direction (e.g., k_{L}). Single ICG designs are particularly well suited to use with a micro-LED display in which the primary colors may not be easily separated spatially. Accordingly, light from a micro-LED display could be imaged into the single ICGs.

Referring to FIG. 13A, grating vector k_{H} represents diffraction by a first distance in k-space and grating vector k_{L} represents diffraction by a second distance in k-space. Thus, first ICG 1310 coupled to the world side of the eyepiece waveguide and second ICG 1311 coupled to the user side of the eyepiece waveguide will incouple light at multiple wavelengths and a first range of directions (corresponding to grating vector k_{H}) to produce red FOV 1320, green FOV 1322, and blue FOV 1324 and at multiple wavelengths and a second range of directions (corresponding to grating vector k_{L}) to produce red FOV 1321, green FOV 1323, and blue FOV 1325 (to the extent portions or all of these FOVs are supported by the eyepiece waveguide). Referring to FIG. 13A, blue FOV 1325, green FOV 1323, green FOV 1322, and red FOV 1320 are positioned within the annular region between r=n=1 and r=n=2. Red FOV 1321 and blue FOV 1324 include a portion positioned within the annular region between r=n=1 and r=n=2. It should be noted, that a change in the index of refraction of the eyepiece waveguide material (e.g., an index of refraction fraction of 2.5) will result in the amount of the FOV included in the annular region changing.

Referring to FIG. 13B, light present in red FOV 1320, green FOV 1322, and blue FOV 1324 is diffracted in region 1342 of CPE 1340 coupled to the world side and region 1352 of CPE 1350 coupled to the user side and impinges on gratings corresponding to grating vector k₁, thereby diffracting in the plane of the eyepiece waveguide. As a result, red FOV 1320 shifts in k-space to red FOV 1321, green FOV 1322 shifts in k-space to green FOV 1323, and blue FOV 1324 shifts in k-space to blue FOV 1325. Diffraction in region 1344 of CPE 1340 from gratings corresponding to grating vector k₃ results in outcoupling from the eyepiece waveguide. Light present in red FOV 1321, green FOV 1323, and blue FOV 1325 is diffracted in region 1346 of CPE 1340 coupled to the world side and region 1356 of CPE 1350 coupled to the user side and impinges on gratings corresponding to grating vector k₁, thereby diffracting in the plane of the eyepiece waveguide. As a result, red FOV 1321 shifts in k-space to red FOV 1320, green FOV 1323 shifts in k-space to green FOV 1322, and blue FOV 1325 shifts in k-space to blue FOV 1324. Diffraction in region 1354 of CPE 1350 from gratings corresponding to grating vector k₂ results in outcoupling from the eyepiece waveguide.

Accordingly, the diffraction pathway for red, green, and blue wavelengths incoupled by first ICG 1310 and second ICG 1311 in the direction represented by grating vector k_{H}, which indicates the minimal sequence of the interaction with different grating types as the incident light propagates from the projector to the user's eye, is k_{H}→k₁→k₂. The diffraction pathway for red, green, and blue wavelengths incoupled by first ICG 1310 and second ICG 1311 in the direction represented by grating vector k_{L} is k_{L}→k₁→k₃.

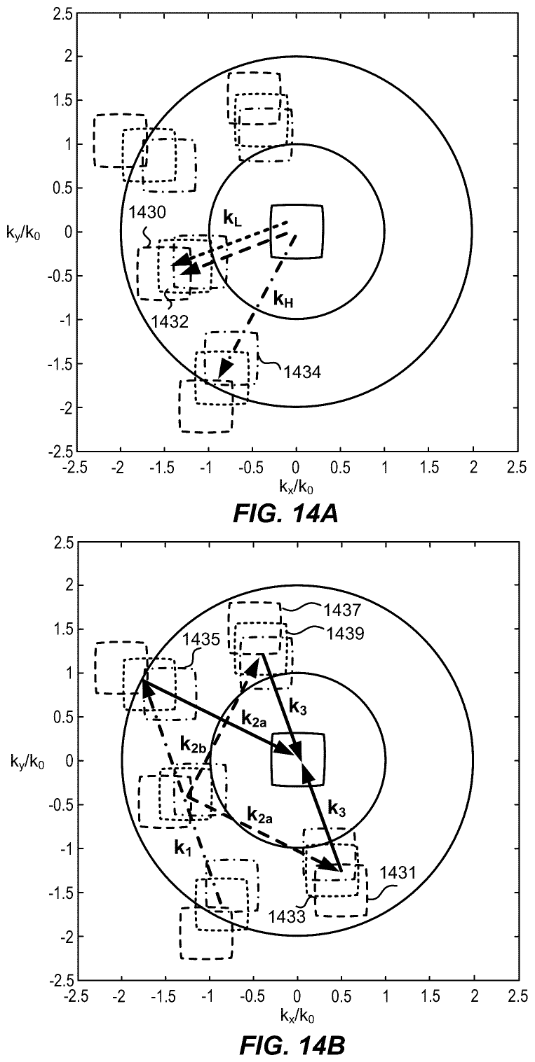

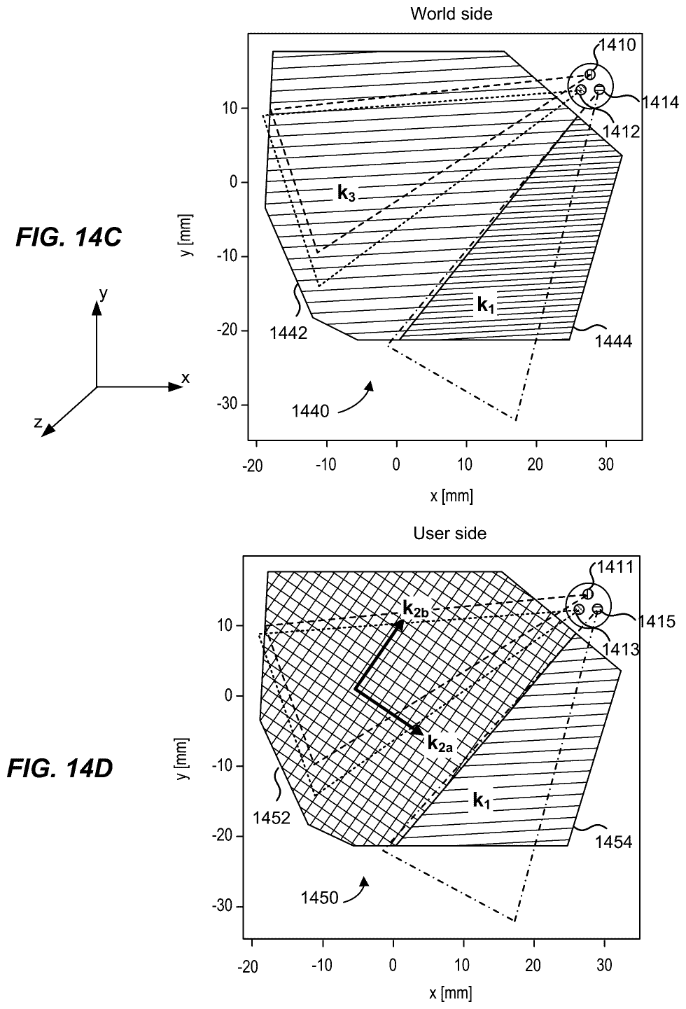

FIG. 14A is a simplified k-space diagram illustrating the field of view and ICG grating vectors for a first eyepiece waveguide including a two dimensional grating with multi-directional launch according to an embodiment of the present invention. FIG. 14B is a simplified k-space diagram illustrating the field of view and CPE grating vectors for the first eyepiece waveguide including a two dimensional grating with multi-directional launch according to an embodiment of the present invention. FIG. 14C is a simplified plan view of the world side of the first eyepiece waveguide including a two dimensional grating with multi-directional launch according to an embodiment of the present invention. FIG. 14D is a simplified plan view of the user side of the first eyepiece waveguide including a two dimensional grating with multi-directional launch illustrated in FIG. 14C.

Referring first to FIGS. 14C and 14D, this first eyepiece waveguide utilizes a multi-directional launch eyepiece waveguide design in which separate ICG pupils coupled to the world side of the eyepiece waveguide, illustrated as red ICG 1410, green ICG 1412, and blue ICG 1414 in FIG. 14C, are utilized in conjunction with red ICG 1411, green ICG 1413, and blue ICG 1415 coupled to the user side of the eyepiece waveguide as shown in FIG. 14D. Thus, light from the projector is coupled into the eyepiece waveguide using these six ICGs. However, as discussed more fully below, the grating periodicity for the various ICGs and the corresponding grating vectors, which are designed with respect to a green wavelength, are equal for blue light (and the blue ICGs) as compared to red and green light (and the red and green ICGs). Although the embodiment illustrated in FIG. 14D includes red ICG 1411, green ICG 1413, and blue ICG 1415 coupled to the user side of the eyepiece waveguide, this is not required and, in some embodiments, red ICG 1411, green ICG 1413, and blue ICG 1415 are optional.

Referring to FIG. 14A, grating vector k_{H} represents diffraction by a first distance in k-space and grating vector k_{L} represents diffraction by a second distance in k-space. Thus, for red ICG 1410 and green ICG 1412 coupled to the world side of the eyepiece waveguide or red ICG 1411 and green ICG 1413 coupled to the user side of the eyepiece waveguide, light at the center of the FOV is diffracted into the eyepiece waveguide as represented by grating vector k_{L} to produce red FOV 1430 for red wavelengths and green FOV 1432 for green wavelengths. Both of these FOVs are positioned within the annular region between r=n=1 and r=n=2. Light diffracted into the eyepiece waveguide using blue ICG 1414 coupled to the world side of the eyepiece waveguide or blue ICG 1415 coupled to the user side of the eyepiece waveguide diffracts as represented by k_{H}. Thus, for blue ICG 1414 coupled to the world side and blue ICG 1415 coupled to the user side of the eyepiece waveguide, light at the center of the FOV is diffracted into the eyepiece waveguide to produce blue FOV 1434 for blue wavelengths. This FOV is positioned within the annular region between r=n=1 and r=n=2. Accordingly, this wavelength-specific, multi-directional launch architecture enables a full 30°×30° FOV because the respective barrel-shaped boxes corresponding to red FOV 1430, green FOV 1432, and blue FOV 1434, which correspond to TIR light, lie entirely within the annular region.

Referring to FIG. 14C, the orientation of the gratings in red ICG 1410 and green ICG 1412, as well as red ICG 1411 and green ICG 1413, are oriented such that red and green light is launched into the eyepiece waveguide toward region 1442 of the CPE 1440 on the world side and toward region 1452 of the CPE 1450 on the user side. The orientation of the gratings in blue ICG 1414 and blue ICG 1415 are oriented such that blue light is launched into the eyepiece waveguide toward region 1444 of the CPE 1440 on the world side and toward region 1454 of the CPE 1450 on the user side. Region 1444 and region 1454 have gratings corresponding to grating vector k₁. Region 1442, which has gratings corresponding to grating vector k₃, is disposed adjacent to region 1444. Region 1452, which has two-dimensional gratings corresponding to grating vector k₂ₐ and k_{2b}, is disposed adjacent to region 1454.

Referring to FIGS. 14B and 14D, red and green light that is launched toward region 1442 of CPE 1440 impinges on gratings corresponding to grating vector k₃ and red and green light that is launched toward region 1452 of CPE 1450 impinges on two dimensional gratings characterized by grating vector k₂ₐ in a first direction and grating vector k_{2b} in a second, orthogonal direction. Diffraction corresponding to grating vectors k₃, k₂a, and k_{2b} results in diffraction in the plane of the eyepiece waveguide. As a result, red FOV 1430 shifts in k-space to red FOV 1431 and green FOV 1432 shifts in k-space to green FOV 1433 in response to diffraction corresponding to grating vector k₂ₐ and red FOV 1430 shifts in k-space to red FOV 1437 and green FOV 1432 shifts in k-space to green FOV 1439 in response to diffraction corresponding to grating vector k_{2b}. Diffraction in region 1444 of CPE 1440 from gratings corresponding to grating vector k₃ results in outcoupling from the eyepiece waveguide.

Blue light that is launched toward region 1444 in CPE 1440 and region 1454 in CPE 1450 impinges on gratings corresponding to grating vector k₁ in region 1444 and region 1454, thereby diffracting in the plane of the eyepiece waveguide. As a result, blue FOV 1434 shifts in k-space to blue FOV 1435. Diffraction in region 1444 of CPE 1440 from gratings corresponding to grating vector k₂ₐ results in outcoupling from the eyepiece waveguide. Accordingly, the diffraction pathway for red and green wavelengths, which indicates the minimal sequence of the interaction with different grating types as the incident light propagates from the projector to the user's eye, is k_{L}→k₂ₐ/k_{2b}→k₃. The diffraction pathway for blue wavelengths is k_{H}→k₁→k₂ₐ.

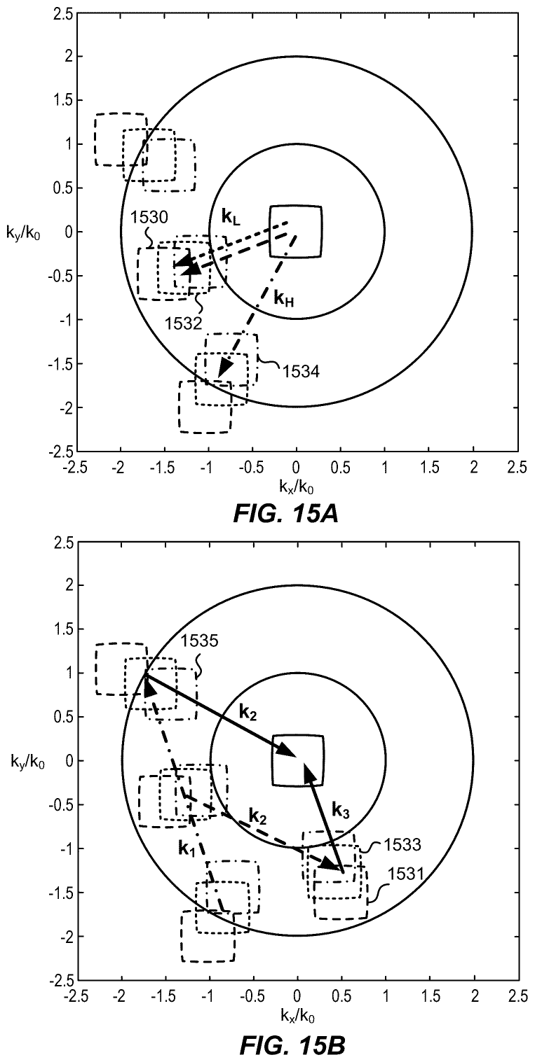

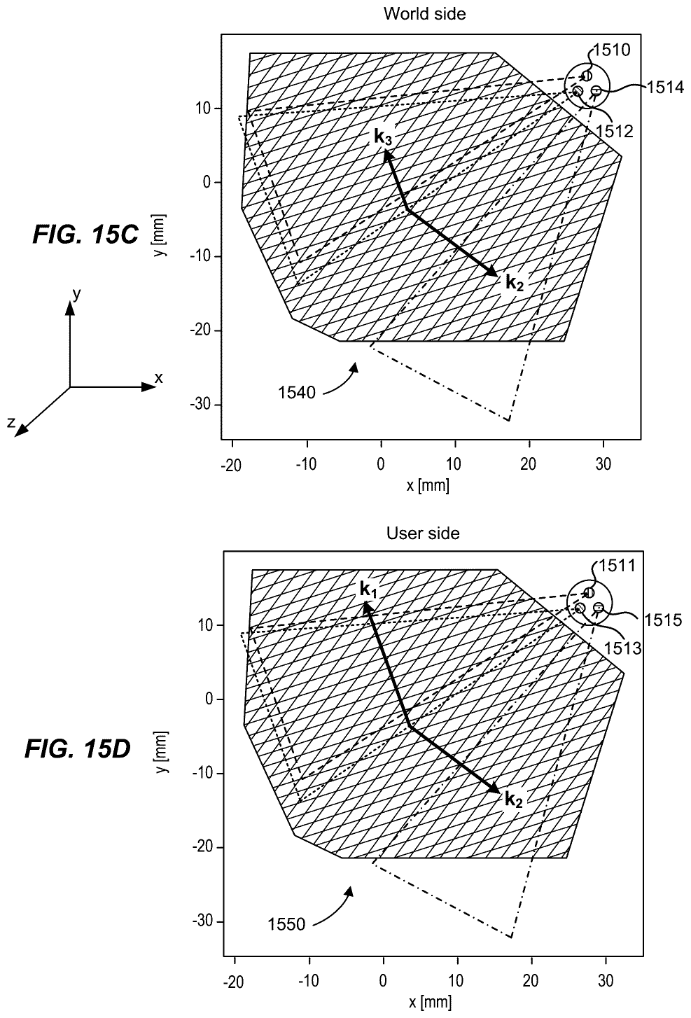

FIG. 15A is a simplified k-space diagram illustrating the field of view and ICG grating vectors for a first eyepiece waveguide including a two dimensional grating with multi-directional launch according to an embodiment of the present invention. FIG. 15B is a simplified k-space diagram illustrating the field of view and CPE grating vectors for the first eyepiece waveguide including a two dimensional grating with multi-directional launch according to an embodiment of the present invention. FIG. 15C is a simplified plan view of the world side of the first eyepiece waveguide including a two dimensional grating with multi-directional launch according to an embodiment of the present invention. FIG. 15D is a simplified plan view of the user side of the first eyepiece waveguide including a two dimensional grating with multi-directional launch illustrated in FIG. 15C.

Referring first to FIGS. 15C and 15D, this first eyepiece waveguide utilizes a multi-directional launch eyepiece waveguide design in which separate ICG pupils coupled to the world side of the eyepiece waveguide, illustrated as red ICG 1510, green ICG 1512, and blue ICG 1514 in FIG. 15C, are utilized in conjunction with red ICG 1511, green ICG 1513, and blue ICG 1515 coupled to the user side of the eyepiece waveguide as shown in FIG. 15D. Thus, light from the projector is coupled into the eyepiece waveguide using these six ICGs. However, as discussed more fully below, the grating periodicity for the various ICGs and the corresponding grating vectors, which are designed with respect to a green wavelength, are equal for blue light (and the blue ICGs) as compared to red and green light (and the red and green ICGs). Although the embodiment illustrated in FIG. 15D includes red ICG 1511, green ICG 1513, and blue ICG 1515 coupled to the user side of the eyepiece waveguide, this is not required and, in some embodiments, red ICG 1511, green ICG 1513, and blue ICG 1515 are optional.

Referring to FIG. 15A, grating vector k_{H} represents diffraction by a first distance in k-space and grating vector k_{L} represents diffraction by a second distance in k-space. Thus, for red ICG 1510 and green ICG 1512 coupled to the world side of the eyepiece waveguide or red ICG 1511 and green ICG 1513 coupled to the user side of the eyepiece waveguide, light at the center of the FOV is diffracted into the eyepiece waveguide as represented by grating vector k_{L} to produce red FOV 1530 for red wavelengths and green FOV 1532 for green wavelengths. Both of these FOVs are positioned within the annular region between r=n=1 and r=n=2. Light diffracted into the eyepiece waveguide using blue ICG 1514 coupled to the world side of the eyepiece waveguide or blue ICG 1515 coupled to the user side of the eyepiece waveguide diffracts as represented by k_{H}. Thus, for blue ICG 1514 coupled to the world side and blue ICG 1515 coupled to the user side of the eyepiece waveguide, light at the center of the FOV is diffracted into the eyepiece waveguide to produce blue FOV 1534 for blue wavelengths. This FOV is positioned within the annular region between r=n=1 and r=n=2. Accordingly, this wavelength-specific, multi-directional launch architecture enables a full 30°×30° FOV because the respective barrel-shaped boxes corresponding to red FOV 1530, green FOV 1532, and blue FOV 1534, which correspond to TIR light, lie entirely within the annular region.

Referring to FIG. 15C, the orientation of the gratings in red ICG 1510 and green ICG 1512, as well as red ICG 1511 and green ICG 1513, are oriented such that red and green light is launched into the eyepiece waveguide toward the upper left portion of CPE 1540 on the world side and toward the upper left portion of CPE 1550 on the user side. The orientation of the gratings in blue ICG 1514 and blue ICG 1515 is oriented such that blue light is launched into the eyepiece waveguide toward the lower right portion of CPE 1540 on the world side and toward the lower right portion of CPE 1550 on the user side. CPE 1540 has gratings corresponding to grating vector k₂ and grating vector k₃ across the entire CPE. CPE 1550 has gratings corresponding to grating vector k₁ and grating vector k₂ across the entire CPE.

Referring to FIGS. 15B and 15D, red and green light that is launched toward the upper left portion of CPE 1540 impinges on components of the two-dimensional grating corresponding to grating vector k₂ and red and green light that is launched toward the upper left portion of CPE 1550 impinges on components of the two dimensional grating corresponding to grating vector k₂. Diffraction corresponding to grating vector k₂ results in diffraction in the plane of the eyepiece waveguide. As a result, red FOV 1530 shifts in k-space to red FOV 1531 and green FOV 1532 shifts in k-space to green FOV 1533 in response to diffraction corresponding to grating vector k₂. Diffraction in CPE 1540 from gratings corresponding to grating vector k₃ results in outcoupling from the eyepiece waveguide.

Blue light that is launched toward the lower right portion of CPE 1550 impinges on components of the two-dimensional grating corresponding to grating vector k₁, thereby diffracting in the plane of the eyepiece waveguide. As a result, blue FOV 1534 shifts in k-space to blue FOV 1535. Diffraction in CPE 1540 and CPE 1550 from components of the two-dimensional grating corresponding to grating vector k₂ results in outcoupling from the eyepiece waveguide. Accordingly, the diffraction pathway for red and green wavelengths, which indicates the minimal sequence of the interaction with different grating types as the incident light propagates from the projector to the user's eye, is k_{L}→k₂→k₃. The diffraction pathway for blue wavelengths is k_{H}→k₁→k₂.

As discussed in relation to FIG. 3D, the diffractive structures illustrated in FIGS. 15C and 15D as being fabricated on the world side and the user side can be implemented on the opposing side or in a single-sided design. As an example, gratings corresponding to grating vector k₁, grating vector k₂, and grating vector k₃ illustrated in FIGS. 15C and 15D can be implemented as a single-sided design with all gratings coupled to a single side of the eyepiece waveguide. Accordingly, the functionality discussed in relation to FIGS. 15C and 15D can be implemented using a single-sided design.

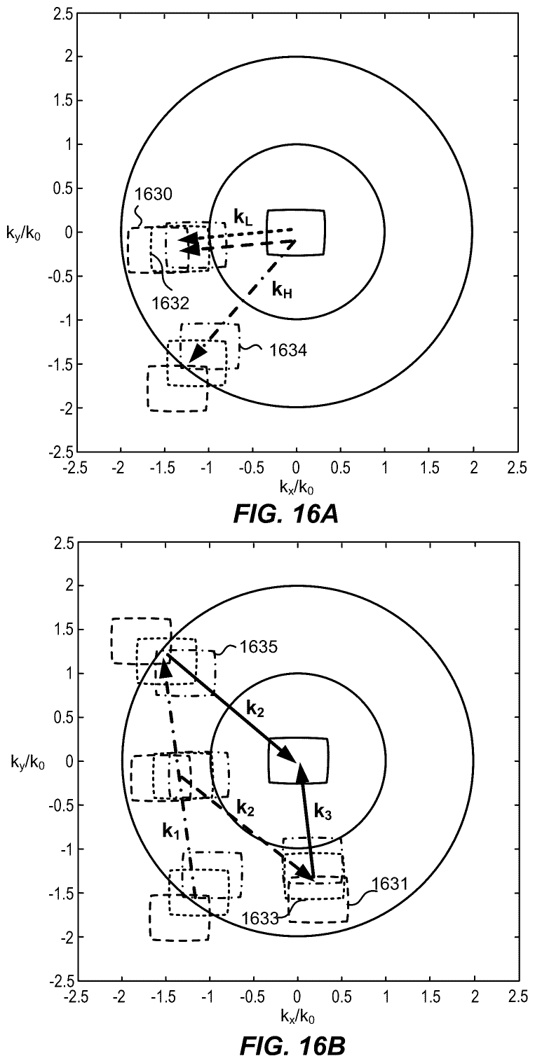

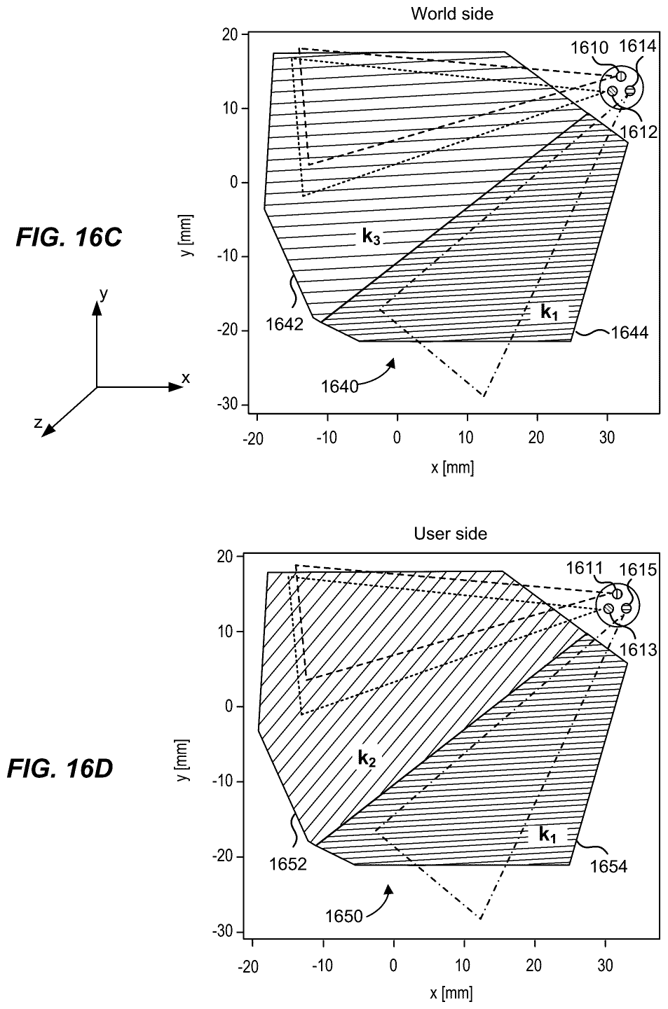

FIG. 16A is a simplified k-space diagram illustrating the field of view and ICG grating vectors for a wide field of view eyepiece waveguide with multi-directional launch according to an embodiment of the present invention. FIG. 16B is a simplified k-space diagram illustrating the field of view and CPE grating vectors for the wide field of view eyepiece waveguide with multi-directional launch according to an embodiment of the present invention. FIG. 16C is a simplified plan view of the world side of the wide field of view eyepiece waveguide with multi-directional launch according to an embodiment of the present invention. FIG. 16D is a simplified plan view of the user side of the wide field of view eyepiece waveguide with multi-directional launch illustrated in FIG. 16C.

The design illustrated in FIGS. 16A-16D corresponds to that shown in FIGS. 8A-8D, with the modification that the field of view illustrated in FIGS. 16A and 16B is wider in the horizontal direction than that shown in FIGS. 8A and 8B.

Referring first to FIGS. 16C and 16D, this wide field of view eyepiece waveguide utilizes a multi-directional launch eyepiece waveguide design in which separate ICG pupils coupled to the world side of the eyepiece waveguide, illustrated as red ICG 1610, green ICG 1612, and blue ICG 1614 in FIG. 16C, are utilized in conjunction with red ICG 1611, green ICG 1613, and blue ICG 1615 coupled to the user side of the eyepiece waveguide as shown in FIG. 16D. Thus, light from the projector is coupled into the eyepiece waveguide using these six ICGs. However, as discussed more fully below, the grating periodicity for the various ICGs and the corresponding grating vectors, which are designed with respect to a green wavelength, are different for blue light (and the blue ICGs) as compared to red and green light (and the red and green ICGs). Although the embodiment illustrated in FIG. 16D includes red ICG 1611, green ICG 1613, and blue ICG 1615 coupled to the user side of the eyepiece waveguide, this is not required and, in some embodiments, red ICG 1611, green ICG 1613, and blue ICG 1615 are optional.

Referring to FIG. 16A, grating vector k_{H} represents diffraction by a larger distance (High) in k-space and grating vector k_{L} represents diffraction by a smaller distance (Low) in k-space. Thus, the gratings corresponding to grating vector k_{L} are characterized by a same grating dimension (i.e., the same grating periodicity, for example 525 nm/˜1.5≈350 nm) while the gratings corresponding to grating vector k_{H} are characterized by a larger grating dimension (i.e., a smaller grating periodicity, for example 525 nm/˜1.9≈276 nm). Thus, for red ICG 1610 and green ICG 1612 coupled to the world side of the eyepiece waveguide or red ICG 1611 and green ICG 1613 coupled to the user side of the eyepiece waveguide, light at the center of the FOV is diffracted into the eyepiece waveguide as represented by grating vector k_{L} to produce red FOV 1630 for red wavelengths and green FOV 1632 for green wavelengths. Both of these FOVs, despite their larger horizontal width, are positioned within the annular region between r=n=1 and r=n=2. Light diffracted into the eyepiece waveguide using blue ICG 1614 coupled to the world side of the eyepiece waveguide or blue ICG 1615 coupled to the user side of the eyepiece waveguide diffracts as represented by k_{H}. Thus, for blue ICG 1614 coupled to the world side and blue ICG 1615 coupled to the user side of the eyepiece waveguide, light at the center of the FOV is diffracted into the eyepiece waveguide to produce blue FOV 1634 for blue wavelengths. This FOV, despite its larger horizontal width, is positioned within the annular region between r=n=1 and r=n=2. Accordingly, this wavelength-specific, multi-directional launch architecture enables a full 40°×30° FOV because the respective wide fields of view corresponding to red FOV 1630, green FOV 1632, and blue FOV 1634, which correspond to TIR light, lie entirely within the annular region.

Referring to FIG. 16C, the orientation of the gratings in red ICG 1610 and green ICG 1612, as well as red ICG 1611 and green ICG 1613, is oriented such that red and green light is launched into the eyepiece waveguide toward region 1642 of the CPE 1640 on the world side and toward region 1652 of the CPE 1650 on the user side. The orientation of the gratings in blue ICG 1614 and blue ICG 1615 are oriented such that blue light is launched into the eyepiece waveguide toward region 1644 of the CPE 1640 on the world side and toward region 1654 of the CPE 1650 on the user side.

Referring to FIGS. 16B and 16D, red and green light that is launched toward region 1652 of CPE 1650 impinges on gratings corresponding to grating vector k₂, thereby diffracting in the plane of the eyepiece waveguide. As a result, red FOV 1630 shifts in k-space to red FOV 1631 and green FOV 1632 shifts in k-space to green FOV 1633. Diffraction in region 1642 from gratings corresponding to grating vector k₃ results in outcoupling from the eyepiece waveguide. Blue light that is launched toward region 1644 in CPE 1640 and region 1654 in CPE 1650 impinges on gratings corresponding to grating vector k₁ in region 1644 and region 1654, thereby diffracting in the plane of the eyepiece waveguide. As a result, blue FOV 1634 shifts in k-space to blue FOV 1635. Diffraction in region 1652 from gratings corresponding to grating vector k₂ results in outcoupling from the eyepiece waveguide. Accordingly, the diffraction pathway for red and green wavelengths, which indicates the minimal sequence of the interaction with different grating types as the incident light propagates from the projector to the user's eye, is k_{L}→k₂→k₃. The diffraction pathway for blue wavelengths is k_{H}→k₁→k₂.

As illustrated in FIGS. 16A and 16B, red FOV 1630/1631, green FOV 1632/1633, and blue FOV 1634/1635, despite their wider horizontal width, are all positioned within the annular region between r=n=1 and r=n=2. Accordingly, propagation in the plane of the eyepiece waveguide as well as outcoupling are performed without clipping of the FOVs.

The inventors have determined that the multi-directional launch waveguide designs discussed herein are particularly useful for AR display designs in which the projector is situated near the top-right corner of the eyepiece. The geometric arrangement of different grating regions, gradation zones, grating parameters, materials, ICG and projector placements, and the like can be varied according to embodiments of the present invention and are parameters that impact the display performance of the eyepiece. These parameters can be tuned in order to achieve desired uniformity and efficiency of the AR display.

Note that, in the embodiments illustrated in FIGS. 7C/7D, 9C/9D, 11C/11D, and 13C/13D, multi-directional launch waveguide designs are illustrated that utilize a single ICG pupil to launch light of all three primary colors (i.e., red, green and blue wavelength light) into the eyepiece waveguide. Several designs that can be used to achieve this multi-directional launch are described below.

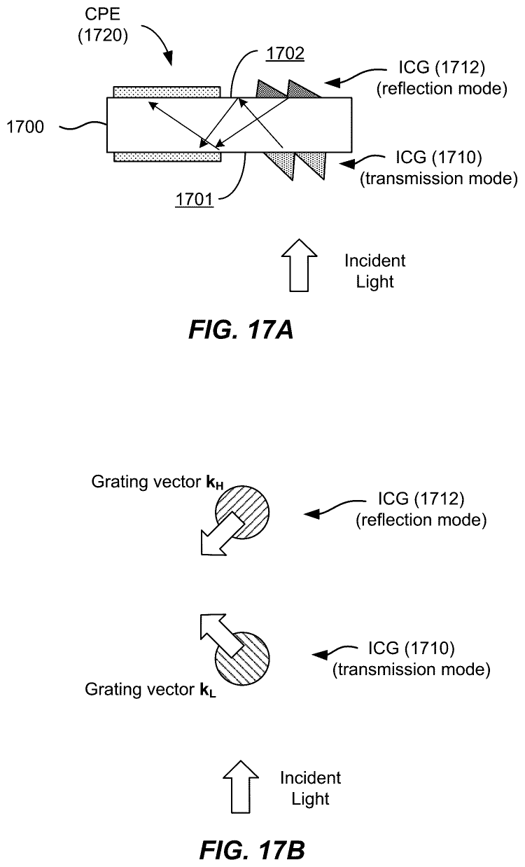

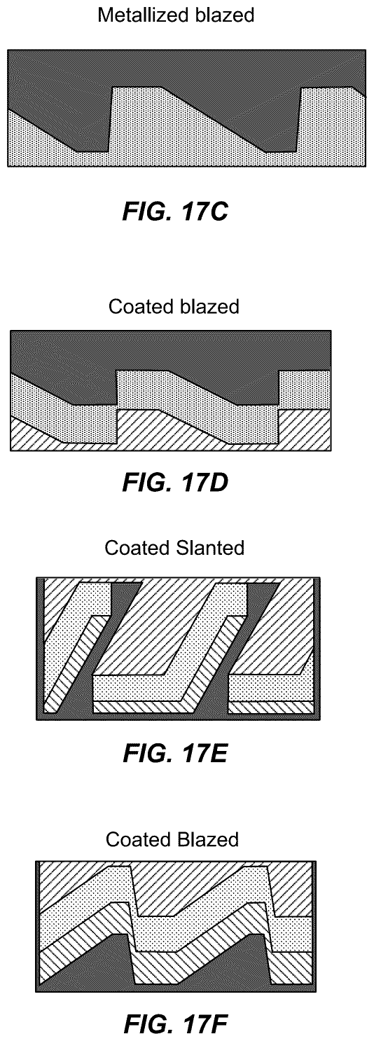

FIG. 17A is a simplified cross-sectional diagram illustrating an eyepiece waveguide with double-sided ICGs according to an embodiment of the present invention. Referring to FIG. 17A, eyepiece waveguide 1700 receives incident light from a projector (not shown). First ICG 1710, which operates in transmission mode, is coupled to first side 1701 of eyepiece waveguide 1700. Second ICG 1712, which operates in reflection mode, is coupled to second side 1702 of eyepiece waveguide 1700. Light diffracted from first ICG 1710 and second ICG 1712 propagates in eyepiece waveguide 1700 toward CPE 1720, which diffracts light in the plane of the eyepiece waveguide, as well as outcouples light from the eyepiece waveguide toward the user.

FIG. 17B is an exploded plan view diagram illustrating the double-sided ICGs shown in FIG. 17A. As illustrated in FIG. 17A, incident light is diffracted by ICG 1710, operating in transmission mode. The gratings of ICG 1710 are defined by grating vector k_{L} as discussed above. Incident light passing through eyepiece waveguide 1700 is diffracted by ICG 1712, operating in reflection mode. The gratings of ICG 1712 are defined by grating vector k_{H} as discussed above. Thus, in this embodiment, one-dimensional ICG gratings coupled to both sides of the eyepiece, each having different grating vectors (i.e., grating periodicities), are utilized to achieve a combined, two dimensional diffractive structure.

FIG. 17C is a simplified cross-sectional diagram illustrating a metallized blazed grating according to an embodiment of the present invention. FIG. 17D is a simplified cross-sectional diagram illustrating a coated blazed grating according to an embodiment of the present invention. FIG. 17E is a simplified cross-sectional diagram illustrating a coated slanted grating according to an embodiment of the present invention. FIG. 17F is a simplified cross-sectional diagram illustrating a coated blazed grating according to an embodiment of the present invention.

As illustrated in FIGS. 17B-17F, the 1D ICGs can have different coatings deposited on top of the grating structure and can have different shapes, including slanted and blazed type gratings along with one or more coating layers as appropriate. Additionally, meta structures including holes/pillars, multi-step structures, and discontinuous structures can be used. ICGs that function in the reflection mode can be covered with a highly reflective metal, for example, aluminum or silver, which enhances the overall efficiency with which light is launched into the eyepiece waveguide. Thus, embodiments of the present invention can utilize gratings that include slanted, sawtooth, and/or multi-step structures, or the like in order to improve the directionality towards users. Moreover, the gratings discussed herein can be biased with an overcoat, for example, TiO₂, that is formed over the grating structures in the ICGs or the CPE.

In addition to imprinting of the diffractive structures into polymer resins, which can have an index of refraction ranging, for example, from 1.5 to 2.0 as described more fully below, embodiments of the present invention can utilize diffractive structures that are etched into high index materials, including Si₃N₄, ZrO₂, TiO₂, LiNbO3, LiTaO₃, SiC (e.g., SiC with an index of refraction of 2.7), and the like, which can be deposited as a film on the substrate, which can be referred to as a support structure, or be used as the eyepiece waveguide substrate. Dry etch processes such as reactive ion etching (RIE), Inductively Coupled Plasma-Reactive Ion Etching (ICP-RIE), ion beam etching (IBE), or the like, can be used to etch the diffractive structures and can utilize a variety of gases including CF₄, C₂F₈, CHF₃, SF₆, O₂, Ar, He, BCl₃, Cl₂, or the like. Diffractive structures can also be formed in one or more overcoat films (e.g. MgF₂, SiO₂, Si₃N₄, ZrO₂, TiO₂, SiC, or the like, which can have an index of refraction in the range of 1.3 to 2.6) that are deposited over imprinted polymers (e.g., a polymer resin with an index of refraction of 1.5 to 2.0 and an imprinted diffraction pattern). In addition to imprinting and etching, diffraction patterns can be formed by molding a substrate, for example, a polymer with an index of refraction of 1.5 to 1.75. These molded substrates can then be overcoated with high index films. These designs can enhance the diffraction efficiency for TIR light, reduce outside light reflection, or both.

In relation to the imprinting of the diffractive structures into polymer resins, the imprintable prepolymer material can include a resin material, such as an epoxy vinyl ester. The resin can include a vinyl monomer (e.g., methyl metacrylate) and/or difunctional or trifunctional vinyl monomers (e.g., diacrylates, triacrylates, dimethacrylates, etc.), with or without aromatic molecules in the monomer. The prepolymer material can include a monomer having one or more functional groups such as alkyl, carboxyl, carbonyl, hydroxyl, and/or alkoxy. Sulfur atoms and aromatic groups, which both have a higher polarizability, can be incorporated into these acrylate components to boost the refractive index of the formulation and generally provide an index ranging from 1.5 to 1.75. In some implementations, the prepolymer material can include a cyclic aliphatic epoxy containing a resin that can be cured using ultraviolet light and/or heat. In addition, the prepolymer material can include an ultraviolet cationic photoinitiator and a co-reactant to facilitate efficient ultraviolet curing in ambient conditions.

Incorporating inorganic nanoparticles (NP) as ZrO₂ and TiO₂ into such imprintable resin polymers can boost refractive index significantly, for example, up to n=2.1. Additionally, the use of pure ZrO₂ and TiO₂ crystals can result in an index of refraction of n=2.2 and n=2.4-2.6 at 532 nm, respectively. For the preparation of optical nanocomposites of acrylate monomer and inorganic nanoparticle, the particle size is generally smaller than 10 nm to avoid excessive Rayleigh scattering. Due to its high specific surface area, high polarity, and incompatibility with the cross-linked polymer matrix, a ZrO₂ NP has a tendency to agglomerate in the polymer matrix. Surface modification of NPs can be used to overcome this problem. In this technique, the hydrophilic surface of ZrO₂ is modified to be compatible with organics, thus enabling the NP to be uniformly mixed with the polymer. Such modification can be done with silane and carboxylic acid containing capping agents. One end of the capping agent is bonded to ZrO₂ surface while the other end of capping agent either contains a functional group that can participate in acrylate crosslinking or a non-functional organic moiety. Examples of surface modified sub-10 nm ZrO₂ particles are those supplied by Pixelligent Technologies™ and Cerion Advanced Materials™. These functionalized nanoparticles are typically sold uniformly suspended in solvent as uniform blends, which can be combined with other base materials to yield resist formulations with jettable viscosity and increased refractive index.

Crosslinking and patterning with diffractive patterns can be accomplished by placing the prepolymer in contact with a template (for example, in the case of Imprint Lithography e.g., J-FIL™ in which prepolymer material is dispensed using an inkjet) and exposing the prepolymer to actinic radiation having a wavelength between 310 nm and 410 nm and an intensity between 0.1 J/cm² and 100 J/cm². The method can further include, while exposing the prepolymer to actinic radiation, applying heat so that the temperature of the prepolymer is between 40° C. and 120° C.

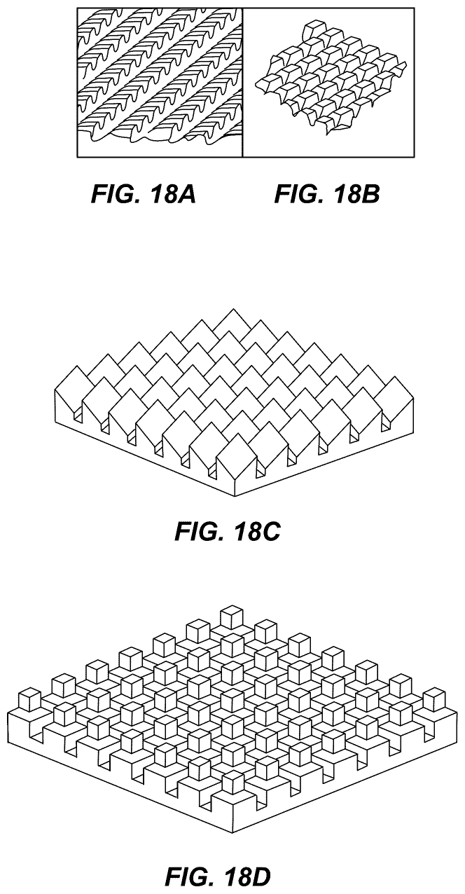

FIGS. 18A-18D illustrate two dimensional ICGs coupled to a single side of the eyepiece waveguide. Each of these two dimensional ICGs has grating vectors that diffract light in two dimensions in order to implement multi-directional launch designs.

FIG. 18A is a perspective view of a two dimensional ICG according to an embodiment of the present invention. In FIG. 18A, rows of blazed grating structures are illustrated. Each row, in the column direction, is also blazed as illustrated by the height variation of each row in the column direction. Thus, a two dimensional grating structure is provided that is suitable for use in the embodiments described herein.

FIG. 18B is a perspective view of a two dimensional ICG according to another embodiment of the present invention. In FIG. 18B, pillars arrayed in rows and columns are illustrated. In the illustrated embodiment, one or more sides of the pillars are sloped, but this is not required.

FIG. 18C is a perspective view of a two dimensional ICG according to a third embodiment of the present invention. In FIG. 18C, pyramid-shaped elements arrayed in rows and columns are illustrated. In the illustrated embodiment, the pyramid-shaped elements are joined at the base of each element, but this is not required and, in other embodiments, the pyramid shaped elements are separated from each other by a gap.

FIG. 18D is a perspective view of a two dimensional ICG according to a fourth embodiment of the present invention. In FIG. 18D, pillars arrayed in rows and columns are illustrated. In the illustrated embodiment, the pillars are stepped structures with a base and a protrusion extending from the base. Although the stepped structures illustrated in FIG. 18D utilize two steps, i.e., the base and the protrusion, embodiments of the present invention are not limited to this two-step structure and stepped structures with additional steps are included within the scope of the embodiments described herein. Additionally, although the sides of the structures are parallel to each other in this embodiment, the sides can also be sloped as appropriate to the particular application. One of ordinary skill in the art would recognize many variations, modifications, and alternatives.

The multi-directional launch designs discussed herein launch blue light in a different direction than the direction that is used to launch red light and green light. Other embodiments can launch blue light and green light along the same direction and red light along a separate, different direction. These other embodiments, although not illustrated herein, are included within the scope of the present invention.

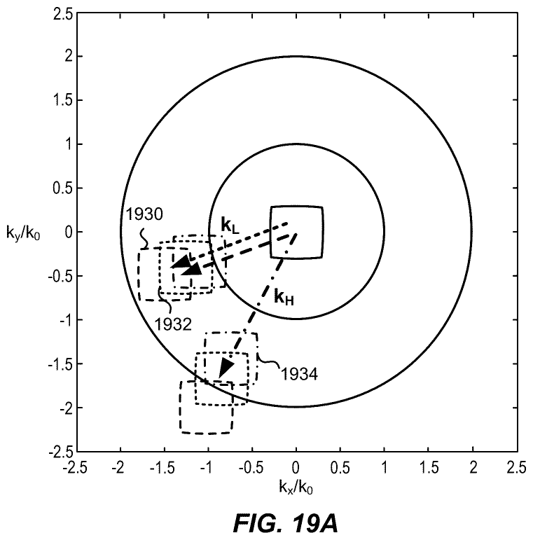

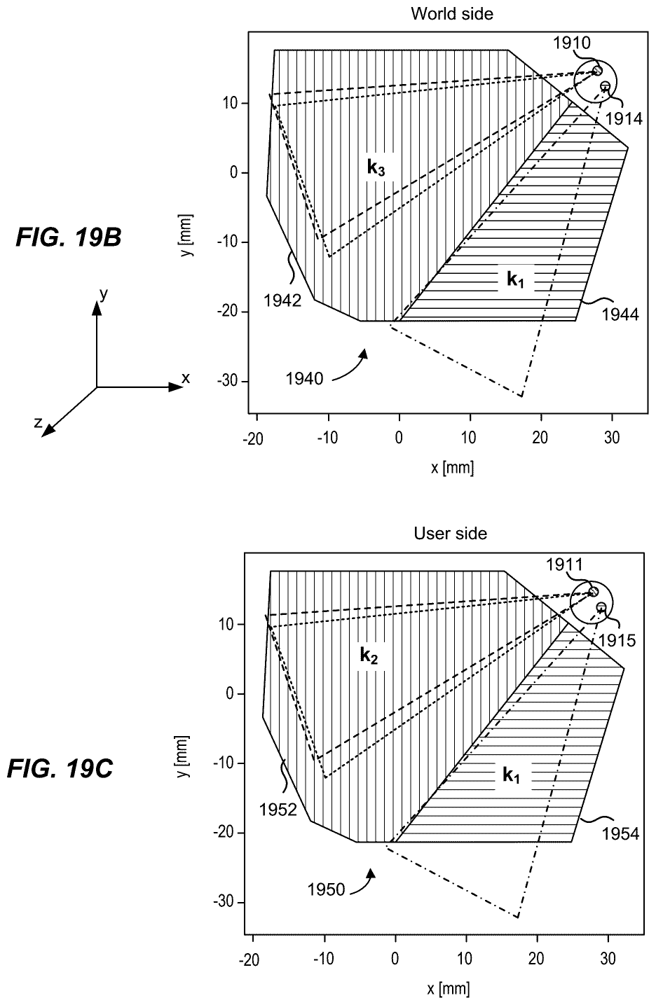

For the multi-directional launch designs in which red light and green light are launched along the same direction, the same ICG design (e.g., pitch and grating orientations) may be utilized. Thus, although a number of the multi-directional launch designs discussed herein utilize three separate ICGs for red light, green light, and blue light, it is possible to use the same ICG for red light and green light. Such an implementation is illustrated in FIGS. 19A-19C.

FIG. 19A is a simplified k-space diagram illustrating the field of view and ICG grating vectors for a third eyepiece waveguide with multi-directional launch according to an embodiment of the present invention. FIG. 19B is a simplified plan view of the world side of the third eyepiece waveguide with multi-directional launch according to an embodiment of the present invention. FIG. 19C is a simplified plan view of the user side of the third eyepiece waveguide with multi-directional launch illustrated in FIG. 19B.

Referring first to FIGS. 19B and 19C, this eyepiece waveguide utilizes a multi-directional launch eyepiece waveguide design in which separate ICG pupils coupled to the world side of the eyepiece waveguide, illustrated as red/green ICG 1910 and blue ICG 1914 in FIG. 19B, are utilized in conjunction with red/green 1911 and blue ICG 1915 coupled to the user side of the eyepiece waveguide as shown in FIG. 19C. Thus, light from the projector is coupled into the eyepiece waveguide using these four ICGs. However, as discussed more fully below, the grating periodicity for the various ICGs and the corresponding grating vectors, which are designed with respect to a green wavelength, are equal for blue light (and the blue ICGs) as compared to red and green light (and the red/green ICGs). Although the embodiment illustrated in FIG. 19C includes red/green ICG 1911 and blue ICG 1915 coupled to the user side of the eyepiece waveguide, this is not required and, in some embodiments, red/green ICG 1911 and blue ICG 1915 are optional.

Referring to FIG. 19A, grating vector k_{H} represents diffraction by a first distance in k-space and grating vector k_{L} represents diffraction by a second distance in k-space. Thus, for red/green ICG 1910 coupled to the world side of the eyepiece waveguide or red/green ICG 1911 coupled to the user side of the eyepiece waveguide, light at the center of the FOV is diffracted into the eyepiece waveguide as represented by grating vector k_{L} to produce red FOV 1930 for red wavelengths and green FOV 1932 for green wavelengths. Both of these FOVs are positioned within the annular region between r=n=1 and r=n=2. Light diffracted into the eyepiece waveguide using blue ICG 1914 coupled to the world side of the eyepiece waveguide or blue ICG 1915 coupled to the user side of the eyepiece waveguide diffracts as represented by k_{H}. Thus, for blue ICG 1914 coupled to the world side and blue ICG 1915 coupled to the user side of the eyepiece waveguide, light at the center of the FOV is diffracted into the eyepiece waveguide to produce blue FOV 1934 for blue wavelengths. This FOV is positioned within the annular region between r=n=1 and r=n=2. Accordingly, this wavelength-specific, multi-directional launch architecture enables a full 30°×30° FOV because the respective barrel-shaped boxes corresponding to red FOV 1930, green FOV 1932, and blue FOV 1934, which correspond to TIR light, lie entirely within the annular region.

Referring to FIG. 19B, the orientation of the gratings in red/green ICG 1910, as well as red/green ICG 1911, are oriented such that red and green light is launched into the eyepiece waveguide toward region 1942 of the CPE 1940 on the world side and toward region 1952 of the CPE 1950 on the user side. The orientation of the gratings in blue ICG 1914 and blue ICG 1915 are oriented such that blue light is launched into the eyepiece waveguide toward region 1944 of the CPE 1940 on the world side and toward region 1954 of the CPE 1950 on the user side. Region 1944 and region 1954 have gratings corresponding to grating vector k₁. Region 1942, which has gratings corresponding to grating vector k₃, is disposed adjacent to region 1944. Region 1952, which has gratings corresponding to grating vector k₂, is disposed adjacent to region 1954.

Referring to FIGS. 19A and 19C, red and green light that is launched toward region 1952 of CPE 1950 impinges on gratings corresponding to grating vector k₂, which results in diffraction in the plane of the eyepiece waveguide. Diffraction in region 1942 of CPE 1940 from gratings corresponding to grating vector k₃ results in outcoupling from the eyepiece waveguide.

Blue light that is launched toward region 1944 in CPE 1940 and region 1954 in CPE 1950 impinges on gratings corresponding to grating vector k₁ in region 1944 and region 1954, thereby diffracting in the plane of the eyepiece waveguide. Diffraction in region 1952 of CPE 1950 from gratings corresponding to grating vector k₂ results in outcoupling from the eyepiece waveguide. Accordingly, the diffraction pathway for red and green wavelengths, which indicates the minimal sequence of the interaction with different grating types as the incident light propagates from the projector to the user's eye, is k_{L}→k₂→k₃. The diffraction pathway for blue wavelengths is k_{H}→k₁→k₂.

Thus, in the embodiment illustrated in FIGS. 19A-19C, two ICGs coupled to the world and/or user side are utilized. This embodiment, along with other benefits, enables the overall projector volume to be reduced, which is an important consideration in the design of AR headset.

Table 2 lists the approximate maximum (i.e., rounded) values of field of view possible with different material options according to embodiments of the present invention. In Table 2, the materials are listed in the first column in order of increasing values of refractive index for uni-directional launch as well as one of the multi-directional launch architectures. The second column represents the best case scenario for a uni-directional launch architecture in which the projector is horizontally aligned with the CPE center (i.e., the nominal eye position). The third and fourth columns indicate the scenarios where the projector is located in the 2 o'clock and the 1 o'clock directions, respectively, with respect to the CPE center. As illustrated in Table 2, for a given material option, the multi-directional launch architectures discussed herein provide a larger field of view than is possible with uni-directional launch architectures.

TABLE 2

| | Uni- | Uni- | Multi- |
|---|---|---|---|
| Waveguide/ | directional | directional | directional |
| Refractive | launch - | launch - | launch - |
| Index | 3 o'clock | 2 o'clock | 1 o'clock |
| Polymer, | 16 (H) × 16 (V), | 13 (H) × 13 (V), | 24 (H) × 24 (V), |
| n = 1.72 | diagonal 22.5 | diagonal 18.3 | diagonal 33.5 |
| TAFD55W | 30 (H) × 30 (V), | 24 (H) × 24 (V), | 38 (H) × 38 (V), |
| glass, | diagonal 41.5 | diagonal 33.5 | diagonal 51.9 |
| n = 2.0 | | | |
| TAFD65W | 32 (H) × 32 (V), | 26 (H) × 26 (V), | 41 (H) × 41 (V), |
| glass, | diagonal 44.1 | diagonal 36.2 | diagonal 55.7 |
| n = 20.5 | | | |
| Glass, | 35 (H) × 35 (V), | 29 (H) × 29 (V), | 41 (H) × 41 (V), |
| n = 2.1 | diagonal 48.1 | diagonal 40.2 | diagonal 55.7 |
| Glass, | 37 (H) × 37 (V), | 30 (H) × 30 (V), | 43 (H) × 43 (V), |
| n - 2.136 | diagonal 50.6 | diagonal 41.5 | diagonal 58.2 |
| LiNbO3, | 43 (H) × 43 (V), | 35 (H) × 35 (V), | 47 (H) × 47 (V), |
| n = 2.25 | diagonal 58.2 | diagonal 48.1 | diagonal 63.2 |
| SiC, | 65 (H) × 75 (V), | 56 (H) × 37 (V), | 65 (H) × 80 (V), |
| n = 2.65 | diagonal 89.8 | diagonal 80.7 | diagonal 93.0 |

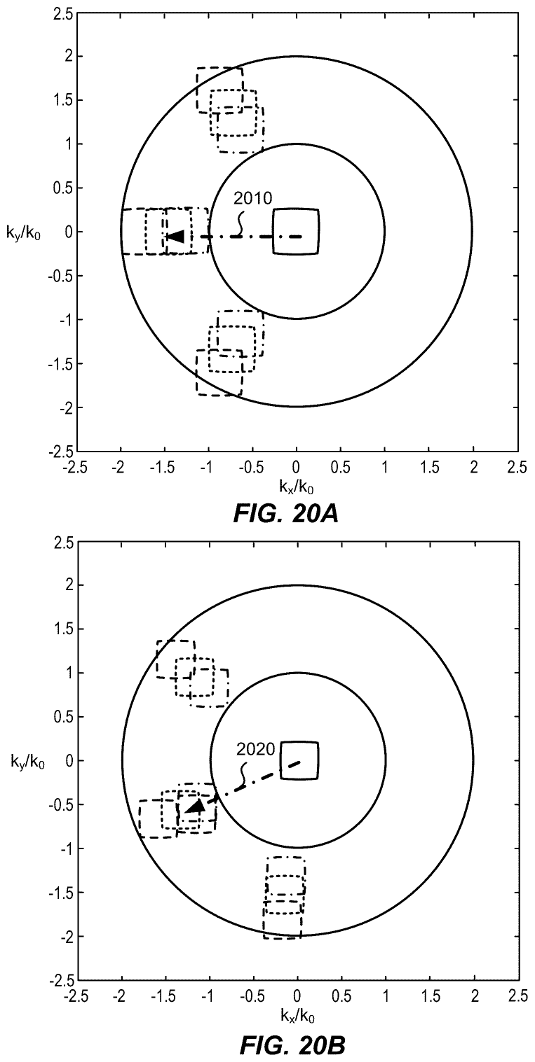

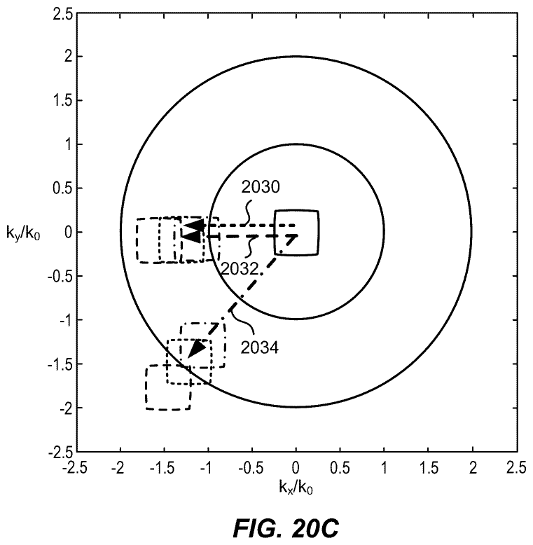

FIG. 20A is a simplified k-space diagram illustrating the field of view and an ICG grating vector for an eyepiece waveguide according to an embodiment of the present invention. In FIG. 20A, grating vector 2010 is illustrated in conjunction with the projector being horizontally aligned with the CPE center, resulting in injection of light from the 3 o'clock position. The data in the second column of Table 2 corresponds to this k-space diagram.

FIG. 20B is a simplified k-space diagram illustrating the field of view and an ICG grating vector for another eyepiece waveguide according to an embodiment of the present invention. In FIG. 20B, grating vector 2020 is illustrated in conjunction with the projector being located in the 2 o'clock direction with respect to the CPE center. The data in the third column of Table 2 corresponds to this k-space diagram.

FIG. 20C is a simplified k-space diagram illustrating the field of view and ICG grating vectors for an eyepiece waveguide with multi-directional launch according to an embodiment of the present invention. In FIG. 20C, grating vectors 2030 and 2032 correspond to injection of red and green light, respectively, from the 3 o'clock position with respect to the CPE center. Grating vector 2034 is illustrated in conjunction with injection of blue light with the projector being located in the 1 o'clock direction with respect to the CPE center. The data in the fourth column of Table 2 corresponds to this k-space diagram.

These k-space diagrams and Table 2 illustrate the maximum field of view possible for increasing values of index of refraction for the waveguide substrate using different material options. For these k-space diagrams and Table 2, the center illumination wavelengths are 455 nm (blue), 525 nm (green), and 628 nm (red).

The inventors have determined that the materials used for waveguides are comparatively lossy or absorptive at shorter wavelengths, i.e., blue wavelengths in comparison with red and green wavelengths. This poses an efficiency issue for blue light as the light that is supposed to spread over the large area of the eyepiece waveguide can be absorbed before being emitted or outcoupled towards the user. Due to this higher absorption, not only the efficiency for blue light is reduced, but, additionally, the nasal portion of the eyepiece (i.e., the portion farthest from the ICG/projector) can emit a reduced amount of blue light. This can pose challenges in realizing good color uniformity of the AR display over all angles of incidence and for people with a smaller interpupillary distance (IPD).

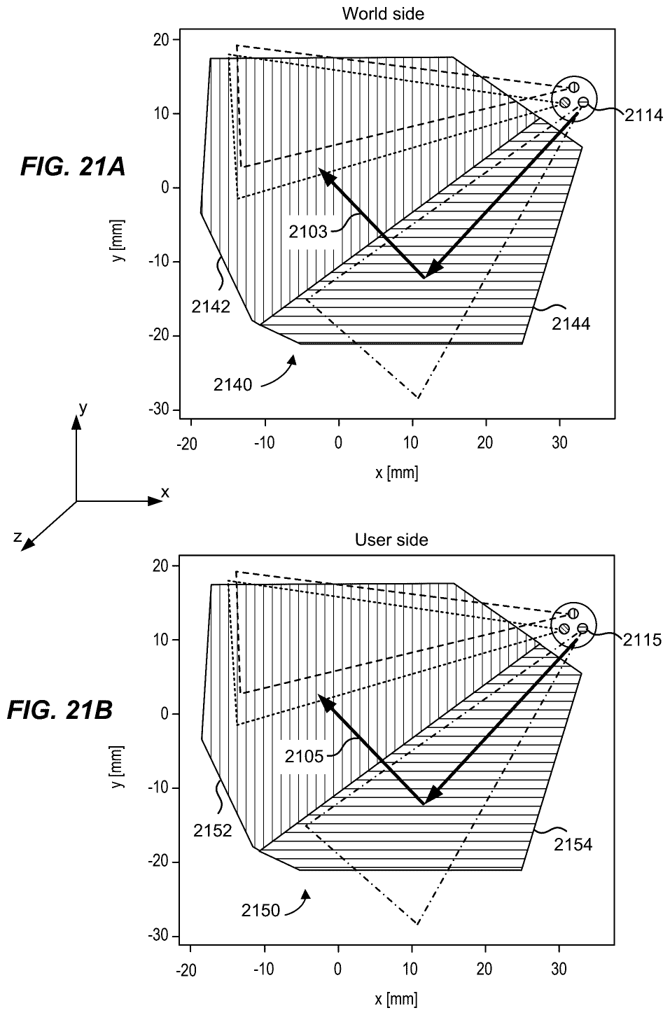

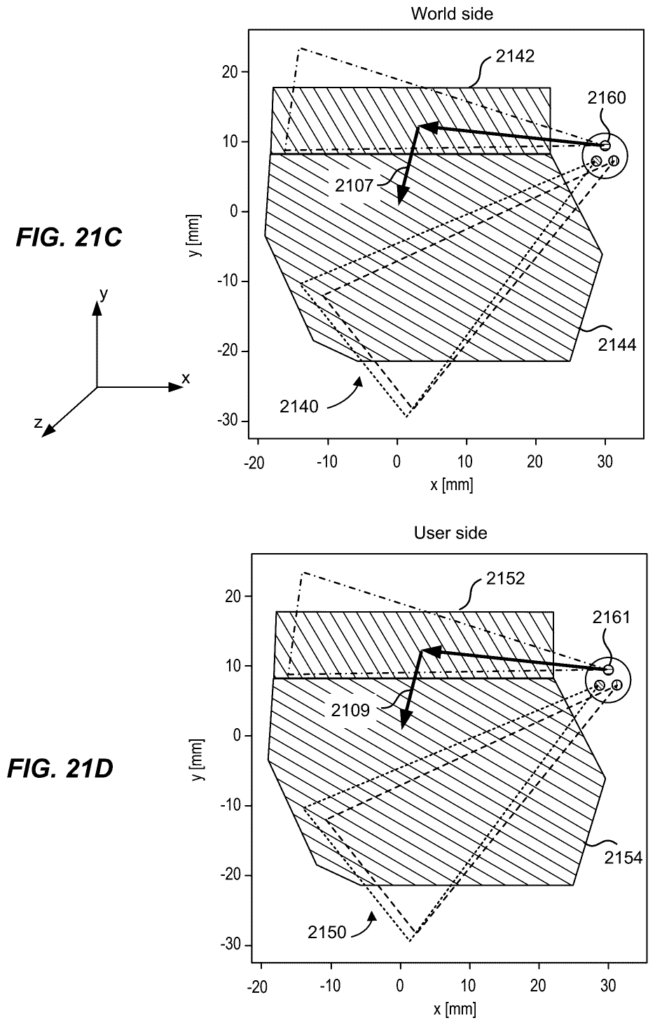

Thus, in the context of multi-directional launch architectures, it is possible to make a choice made between different designs depending on the overall path-length of blue light as it spreads and outcouples from the eyepiece. This process can be illustrated by comparing two different multi-directional launch architectures as illustrated in FIGS. 21A/21B and 21C/21D, respectively.

FIG. 21A is a simplified plan view of the world side of an eyepiece waveguide with multi-directional launch with blue light launched in a first direction according to an embodiment of the present invention. FIG. 21B is a simplified plan view of the user side of the eyepiece waveguide with multi-directional launch with blue light launched in the first direction illustrated in FIG. 21A. Referring to FIGS. 21A and 21B, blue light is launched in the 7 o'clock direction from blue ICG 2114 and blue ICG 2115, impinging on region 2144 of CPE 2140 coupled to the world side and region 2154 of CPE 2150 coupled to the user side. The overall path length to the center of CPE 2140 and CPE 2150 from blue ICG 2114 and blue ICG 2115, respectively, is shown by arrows 2103 and 2105 indicating (approximately) how far the blue light travels within the eyepiece waveguide before outcoupling in region 2142 of CPE 2140 and region 2152 of CPE 2150.

FIG. 21C is a simplified plan view of the world side of an eyepiece waveguide with multi-directional launch with blue light launched in a second direction according to an embodiment of the present invention. FIG. 21D is a simplified plan view of the user side of the eyepiece waveguide with multi-directional launch with blue light launched in the second direction illustrated in FIG. 21C. Referring to FIGS. 21C and 21D, blue light is launched in the 10 o'clock direction from blue ICG 2160 and blue ICG 2161, impinging on region 2142 of CPE 2140 and region 2152 of CPE 2150. The overall path length to the center of CPE 2140 and CPE 2150 from blue ICG 2160 and blue ICG 2161, respectively, is shown by arrows 2107 and 2109 indicating (approximately) how far the blue light travels within the eyepiece waveguide before outcoupling in region 2142 of CPE 2140 and region 2152 of CPE 2150. Based on the comparison of path lengths illustrated in FIGS. 21A/21B and 21C/21D, the design shown in FIG. 21C/21D outperforms the design shown in FIGS. 21A/21B in terms of efficiency of blue light. This result has been verified by simulations based on full ray-tracing.

The inventors have determined that the issue of blue light absorption becomes more severe for materials (particularly glass) with higher values of refractive index, e.g., n>2.0, including those listed in Table 2. Therefore, for such high index material choices, multi-directional launch design offers freedom of choice to optimize the design with higher blue efficiency in mind. However, such a choice usually comes at the cost of lower value for the maximum field of view enabled by that multi-directional launch design.

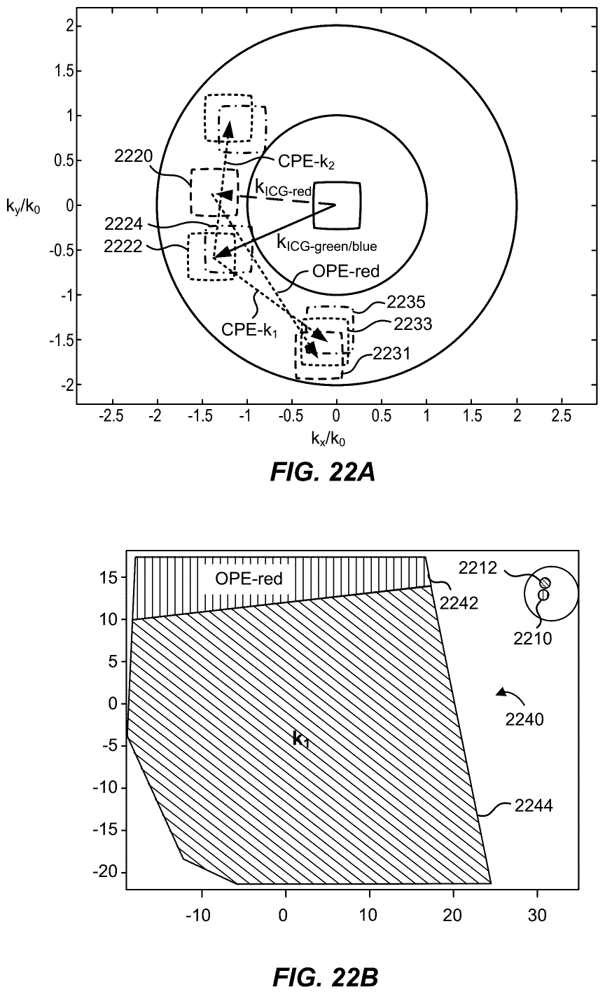

FIG. 22A is a simplified k-space diagram illustrating the field of view, ICG grating vectors, an OPE grating vector, and CPE grating vectors for an eyepiece waveguide with multi-directional launch according to another embodiment of the present invention. FIG. 22B is a simplified plan view of the world side of the eyepiece waveguide with multi-directional launch according to another embodiment of the present invention.

The architecture illustrated in FIG. 22B differs from the other architectures discussed herein. Red light incident on red ICG 2210 is launched into the eyepiece waveguide in a region closer to the center of the annulus and then interacts with an orthogonal pupil expander (OPE-red) that redirects the red light into the k-space location that red light would normally occupy. Subsequently, the red light, along with the green and blue light is outcoupled from the CPE. This architecture provides a red bounce density that is comparable to the green and blue bounce density.

Referring to FIG. 22A, grating vector k_{ICG-red} represents diffraction by red ICG 2210 by a first distance and direction in k-space and grating vector k_{ICG-green-blue} represents diffraction by green/blue ICG 2212 by a second distance and direction in k-space. In this embodiment, the first distance and the second distance differ and the first direction and second direction also differ. Thus, red ICG 2210 and green/blue ICG 2212 will incouple light (corresponding to grating vector k_{ICG-red} and grating vector k_{ICG-green-blue}) to produce red FOV 2220, green FOV 2222, and blue FOV 2224, respectively. Region 2242 of CPE 2240 has gratings corresponding to grating vector OPE-red, which shifts red FOV 2220 in k-space to red FOV 2231. Diffraction in region 2244 of CPE 2240 shifts green FOV 2222 and blue FOV 2224 in k-space to green FOV 2233 and blue FOV 2235 in k-space to blue FOV 2235. Diffraction from the CPE (not shown) coupled to the opposing side of the eyepiece waveguide results, which corresponds to grating vector CPE-k₂ shown in FIG. 22B, results in outcoupling from the eyepiece waveguide.

Thus, the launched red light interacts with the grating corresponding to grating vector OPE-red in region 2242 and is diffracted towards the center of CPE 2240 where it is outcoupled. Other implementations of this design are included within the scope of the present invention and, similar to other architectures discussed herein, the embodiment illustrated in FIG. 22B provides an expansion of the horizontal FOV beyond that available using designs based on uni-directional launch.

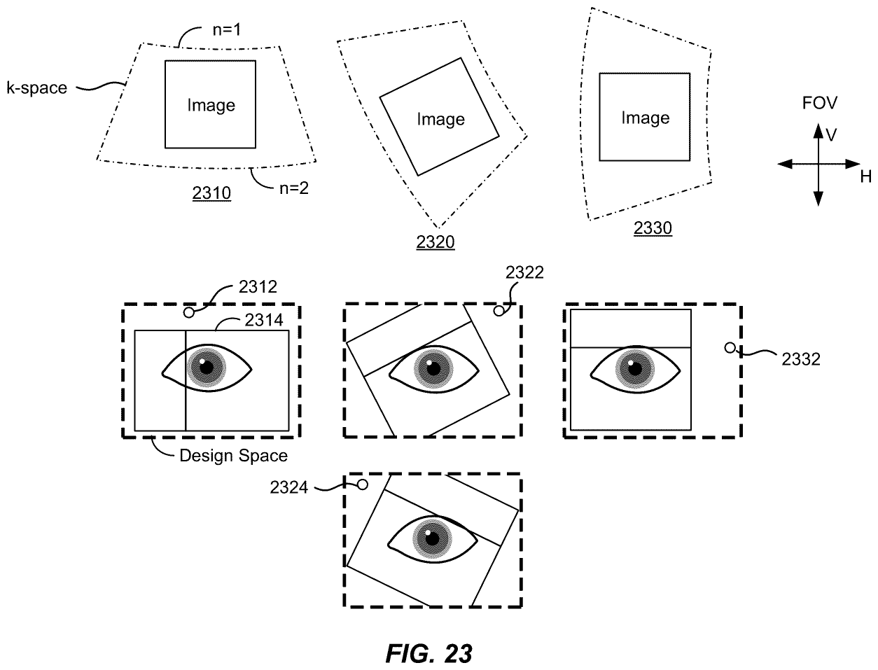

FIG. 23 illustrates overlap of images in k-space and corresponding eyepiece designs according to various embodiments of the present invention. In FIG. 23, schematic diagrams 2310, 2320, and 2330 illustrate how an image overlaps with a portion of the corresponding k-space for various embodiments. For ease of illustration, only a portion of the annular region between r=n=1 and r=n=2 is shown.

ICG 2312 is illustrated in relation to the FOV 2314 corresponding to schematic diagram 2310. The physical location of the projector for the AR wearable can impact the ICG location and the form factor of the AR wearable. Accordingly, the placement of the ICG in relation to the user's eye is illustrated by the line extending across FOV 2314 aligned with the ICG. Thus, different designs, including designs in which the projector/ICG are positioned adjacent the temple or adjacent the nose, are enabled by embodiments of the present invention. In particular, the multi-directional launch (i.e., ICG functionality) capabilities discussed herein, in combination with the multi-combiner (CPE, EPE, OPE) elements discussed herein, can be utilized to combine and outcouple light with an increased FOV in a variety of projector orientations for the user's AR virtual image.

As illustrated in FIG. 23, the ICG can be placed above the user's eye as illustrated by ICG 2312, which corresponds to a case in which the image is present in the lower center portion of the k-space annulus, above and to the side of the user's eye as illustrated by ICG 2322, which corresponds to a case in which the image is present in the lower left portion of the k-space annulus, above and to the side of the user's eye as illustrated by ICG 2324, which corresponds to a case in which the image is present in the lower left portion of the k-space annulus, or to the side of the user's eye as illustrated by ICG 2332, which corresponds to a case in which the image is present in the left portion of the k-space annulus. Thus, the shape of the wearable can vary in conjunction with the different shapes of the eyepiece waveguides discussed herein. One of ordinary skill in the art would recognize many variations, modifications, and alternatives.

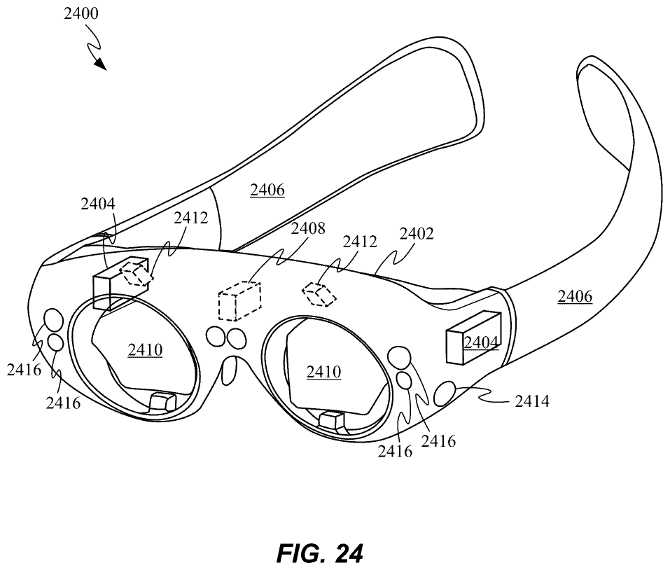

FIG. 24 shows a perspective view of a wearable device 2400 according to an embodiment of the present invention. Wearable device 2400 includes a frame 2402 configured to support one or more projectors 2404 at various positions along an interior-facing surface of frame 2402, as illustrated. In some embodiments, projectors 2404 can be attached at positions near temples 2406. Alternatively, or in addition, another projector could be placed in position 2408. Such projectors may, for instance, include or operate in conjunction with one or more liquid crystal on silicon (LCoS) modules, micro-LED displays, or fiber scanning devices. In some embodiments, light from projectors 2404 or projectors disposed in positions 2408 could be guided into eyepiece waveguides 2410 for display to eyes of a user. Projectors placed at positions 2412 can be somewhat smaller on account of the close proximity this gives the projectors to the waveguide system. The closer proximity can reduce the amount of light lost as the waveguide system guides light from the projectors to eyepiece waveguides 2410. In some embodiments, the projectors at positions 2412 can be utilized in conjunction with projectors 2404 or projectors disposed in positions 2408. While not depicted, in some embodiments, projectors could also be located at positions beneath eyepiece waveguides 2410. Wearable device 2400 is also depicted including sensors 2414 and 2416. Sensors 2414 and 2416 can take the form of forward-facing and lateral-facing optical sensors configured to characterize the real-world environment surrounding wearable device 2400.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. An AR headset comprising:
a projector;
an eyepiece waveguide supporting multi-directional launch, the eyepiece waveguide having a world side and a user side and comprising:
a first set of one or more incoupling diffractive optical elements coupled to the world side of the eyepiece waveguide; wherein:
a first subset of the first set of one or more incoupling diffractive optical elements is operable to diffract first light into the eyepiece waveguide, wherein the diffracted first light is characterized by a first angular range; and
a second subset of the first set of one or more incoupling diffractive optical elements is operable to diffract second light into the eyepiece waveguide, wherein the diffracted second light is characterized by a second angular range different than the first angular range; and
a second set of one or more incoupling diffractive optical elements coupled to the user side of the eyepiece waveguide, wherein:
a third subset of the second set of one or more incoupling diffractive optical elements is operable to diffract light in the first angular range; and
a combined pupil expander.

2. The AR headset of claim 1 wherein a fourth subset of the second set of one or more incoupling diffractive optical elements is operable to diffract light in the second angular range.

3. The AR headset of claim 1 wherein the AR headset includes a single waveguide.

4. The AR headset of claim 1 wherein the eyepiece waveguide supports propagation of multiple wavelengths of light.

5. The AR headset of claim 1 wherein the combined pupil expander is operable to spread light laterally in the eyepiece waveguide and outcouple light through the user side of the eyepiece waveguide.

6. The AR headset of claim 1 wherein at least one of the first set of one or more incoupling diffractive optical elements or the second set of one or more incoupling diffractive optical elements overlap.

7. An eyepiece waveguide for augmented reality applications, the eyepiece waveguide including:
a substrate;
a set of incoupling diffractive optical elements coupled to the substrate, wherein:
a first subset of the set of incoupling diffractive optical elements is operable to diffract light into the substrate along a first range of propagation angles; and
a second subset of the set of incoupling diffractive optical elements is operable to diffract light into the substrate along a second range of propagation angles; and
a combined pupil expander diffractive optical element coupled to the substrate.

8. The eyepiece waveguide of claim 7 wherein the first subset of the set of incoupling diffractive optical elements is characterized by a first grating periodicity and the second subset of the set of incoupling diffractive optical elements is characterized by a second grating periodicity greater than the first grating periodicity.

9. The eyepiece waveguide of claim 7 wherein the combined pupil expander diffractive optical element includes a first region characterized by a first grating orientation and a second region characterized by a second grating orientation different from the first grating orientation.

10. The eyepiece waveguide of claim 7 wherein the eyepiece waveguide further comprises a second set of incoupling diffractive optical elements coupled to the substrate, wherein a first subset of the second set of incoupling diffractive optical elements is operable to diffract light into the substrate along the first range of propagation angles.

11. The eyepiece waveguide of claim 10 wherein:
the set of incoupling diffractive optical elements are coupled to the substrate on a world side surface; and
the second set of incoupling diffractive optical elements are coupled to the substrate on a user side surface opposing the world side surface.

12. The eyepiece waveguide of claim 7 wherein the eyepiece waveguide further comprises a second combined pupil expander diffractive optical element coupled to the substrate.

13. The eyepiece waveguide of claim 12 wherein:
the combined pupil expander diffractive optical element is coupled to the substrate on a world side surface; and
the second combined pupil expander diffractive optical element is coupled to the substrate on a user side surface opposing the world side surface.

14. The eyepiece waveguide of claim 7 wherein the eyepiece waveguide is optically coupled to a projector operable to output red wavelengths, green wavelengths, and blue wavelengths, wherein the eyepiece waveguide is operable to support light propagation at the red wavelengths, the green wavelengths, and the blue wavelengths.

15. The eyepiece waveguide of claim 7 wherein the substrate has an index of refraction between 1.8 and 2.3.

16. The eyepiece waveguide of claim 7 wherein the substrate comprises silicon carbide with an index of refraction of 2.7 or a polymer resin with an index of refraction between 1.3 and 2.6.

17. The eyepiece waveguide of claim 7 wherein the substrate has an index of refraction between 1.8 and 2.7 and the set of incoupling diffractive optical elements comprise structures etched into the substrate.

18. The eyepiece waveguide of claim 7 wherein the substrate comprises a support structure and a layer with an index of refraction between 1.8 and 2.7 coupled to the support structure, wherein the set of incoupling diffractive optical elements comprise structures etched into the layer.

19. The eyepiece waveguide of claim 7 wherein the set of incoupling diffractive optical elements comprise structures etched into the substrate.

20. The eyepiece waveguide of claim 19 further comprising a layer with an index of refraction between 1.8 and 2.7 coupled to the substrate.
